(19) United States
(12) Patent Application Publication
(10) Pub. No.: US 2004/0260576 A1
(43) Pub. Date: Dec. 23, 2004

(54) Guideline execution task ontology (GETO)

(76) Inventors: Dongwen Wang, New York, NY (US); Edward H. Shortliffe, New York, NY (US)

Correspondence Address: Leslie Gladstone Restaino, 163 Madison Avenue, P.O. Box 1989, Morristown, NJ, 07962-1989, US

(21) Appl. No.: 10/600,269

(22) Filed: Jun. 20, 2003

(51) Int. Cl. G06F 17/60

(52) U.S. Cl. 705/2

(57) ABSTRACT

The present invention provides methods for extracting generalized guideline execution tasks from a guideline representation model. The present invention further provides methods for integrating generalized guideline execution tasks into a generic guideline representation model. The present invention also provides methods and systems for providing a generic guideline representation model for use by a guideline execution engine. Finally, the present invention provides methods and systems for enabling a user to map between a guideline representation model and a generic guideline representation model.

### BACKGROUND OF THE INVENTION

The present invention relates to computer-based clinical practice guideline systems. In recent years, clinical practice guidelines have been developed in an effort to reduce unjustified variations in clinical practice, with the goal of improving health-care quality and containing health-care costs. Clinical practice guidelines are generally defined as directions or principles developed in order to assist the health care practitioner with patient care decisions regarding appropriate health care (e.g., diagnostic, therapeutic, or other clinical procedures) for specific clinical circumstances. A great deal of attention has been given to the development of the guidelines, as evidenced by the estimated 2000+ clinical practice guidelines in existence. However, as a result, it is becoming increasingly difficult for clinicians to familiarize themselves with, and remember, the growing number of clinical practice guidelines. Accordingly, development of strategies to implement clinical practice guidelines has become a critical issue.

Computer-based clinical decision support systems have been adopted as a means to improve clinician compliance with clinical practice guidelines. However, several obstacles exist that have, thus far, limited the extent to which such computer-based systems have been developed. It is particularly difficult, for example, to translate clinical practice guidelines from their published formats into computer algorithms. To address this issue, a few computer-based guideline models—such as the GLIF developed by the InterMed Collaboratory, the Arden Syntax developed at Columbia University, the PROforma, the DILEMMA/PRESTIGE, the EON/DHARMA, the Siegfried, the Asbru, the GUIDE/PatMan, the PRODIGY, the GASTON, and the Torino models—have been developed to represent clinical practice guidelines in computer-interpretable form. Once clinical practice guidelines have been represented in a specific format, such as GLIF, which can be interpreted by computers, the clinical knowledge embedded within the guidelines may be shared across different healthcare institutions; thus, the costs of guideline development will be leveraged.

Unfortunately, the computer-based clinical decision support systems developed from these guideline models are rather inflexible with respect to a clinician's ability to depart from the guidelines. For example, some decision support systems do not allow a clinician to reject an irrelevant or inappropriate suggestion, generated by the system, without abandoning the entire clinical practice guideline. One suggested method of adding flexibility in this respect is to use patient states and patient scenarios as entry/exit points. However, doing so requires guideline encoders to enumerate all possible entry/exit points. Moreover, the guidelines encoded on the basis of the various guideline models vary in form, and, therefore, are not consistent; this limits guideline sharing.

An intuitive approach to guideline sharing is to develop a universal standard for guideline representation, to encode all of the clinical practice guidelines. Considering that no existing guideline representation model is dominant over the others, this approach is impractical at present. Thus, sharing of the clinical knowledge embedded within clinical practice guidelines, when encoded in different formats, is a critical issue. Accordingly, there is a need for clinical decision support systems that provide greater flexibility with regard to departures from practice guidelines and/or do not impose the guideline sharing constraints that the various guideline models entail.

### SUMMARY OF THE INVENTION

In one aspect, the present invention provides methods for extracting generalized guideline execution tasks from a guideline representation model, wherein the method includes abstracting a process structure and primary tasks from the guideline representation model; specifying auxiliary tasks embedded within the primary tasks; extracting structural elements representing participants of guideline execution tasks, and elements referenced by the structural elements; and defining execution constraints for use in task scheduling.

In one embodiment, the process structure and primary tasks are abstracted from the guideline representation model based on an analysis of representation elements that represent the process structure and the primary tasks in the guideline representation model, and the relationships among the representation elements.

In another embodiment, the primary tasks are abstracted directly from the guideline representation model.

In another embodiment, the structural elements representing participants of guideline execution tasks include structure elements that are direct participants of the guideline execution tasks.

In another embodiment, the execution constraints correspond to representation elements in the guideline representation model.

In another aspect, the present invention provides methods for integrating generalized guideline execution tasks into a generic guideline representation model, wherein the method includes extracting generalized guideline execution tasks from a guideline representation model; representing the guideline execution tasks as execution task classes; arranging the execution task classes in a hierarchy, to form an execution task subontology; specifying basic structure elements of the guideline execution tasks; representing the basic structure elements as structure element classes; arranging the structure element classes in a hierarchy, to form a structure element subontology; specifying execution constraints for use in task scheduling; representing the execution constraints as execution constraint classes; and arranging the execution constraint classes in a hierarchy, to form a structure element subontology.

In one embodiment, the method further includes the step of creating at least one slot in at least one of the execution task classes, the structure element classes, and the execution constraint classes.

In another embodiment, the execution task classes, structure element classes, and execution constraint classes, and their slots, correspond to representation elements or primitives in the guideline representation model.

In another embodiment, the generalized guideline execution tasks comprise a process structure and primary guideline execution tasks.

In another embodiment, the primary guideline execution tasks comprise auxiliary tasks.

In another embodiment, the method further includes the step of presetting slots in the execution task classes, to define participating structure elements and execution constraints.

In another embodiment, the basic structure elements comprise a guideline, a process structure, and primary tasks.

In another embodiment, the structure element classes comprise the basic structure elements and additional structure elements referenced by the basic structure elements.

In another embodiment, the method further includes the step of specifying slots in the structure element classes, to define references to other classes in the structure element subontology.

In another embodiment, each of the execution constraint classes contains at least one slot for use in specifying execution constraints.

In another embodiment, the method further includes the step of including additional classes and slots corresponding to representation elements in one or more additional guideline execution tasks.

In another aspect, the present invention provides methods and systems for providing a generic guideline representation model for use by a guideline execution engine, wherein the method includes extracting generalized guideline execution tasks from a guideline representation model having representation elements; and integrating the generalized guideline execution tasks to form a generic guideline representation model.

In one embodiment, the method further includes integrating representation elements not found in the guideline representation model into the generic representation model.

In another embodiment, the generalized guideline execution tasks are common to at least two guideline representation models.

In another embodiment, the generalized guideline execution tasks comprise at least one of: input elements, output elements, subtasks, and execution constraints.

In another embodiment, the input elements and output elements are static structure elements derived from the representation elements.

In another embodiment, the input elements define participants for a guideline execution task.

In another embodiment, the output elements comprise execution results.

In another embodiment, the subtasks define relationships between current guideline execution tasks and other tasks.

In another embodiment, if the guideline execution task includes subtasks, the method further includes decomposing each of the subtasks to an atomic task that can be performed directly.

In another embodiment, the execution constraints provide dynamic association among primary guideline execution tasks.

In another embodiment, the primary guideline executions tasks comprise preconditions, postconditions, and events.

In another embodiment, the representation elements of the guideline representation model comprise structural specifications that define static structure elements and execution constraints.

In another embodiment, the method further includes mapping the static structure elements and the execution constraints to corresponding static structure elements and execution constraints of the generic guideline representation model, to provide a mapping relationship for use by a guideline execution engine.

In another aspect, the present invention provides methods and systems for enabling a user to map between a guideline representation model and a generic guideline representation model, wherein the method includes presenting a user interface that allows a user to select a project file of the guideline representation model and a project file of the generalized representation model; loading the selected files; and presenting a user interface including therein class structures of the selected files and slots of the class structures, the user therewith capable of generate a mapping relationship.

In one embodiment, the user is capable of generating a mapping relationship by selecting a set of anchoring class pairs.

In another embodiment, each anchoring class pair comprises a class from the guideline representation model, a class from the generic guideline representation model, the user interface enabling a user to specify at least one of the type of class mapping, one or more conditions for class mapping, and a set of slot mapping.

In another embodiment, the method further includes saving the mapping relationship as an XML file.

### BRIEF DESCRIPTION OF THE FIGURES

FIG. 1 is a block diagram of the GLEE system architecture, according to one embodiment of the invention.

FIG. 2 is a block diagram of the GLEE internal structure, according to one embodiment of the invention.

FIG. 3 is a flow diagram illustrating the execution states of a guideline step and transitions between these execution states, according to one embodiment of the invention.

FIG. 4 is a flow diagram of a method for flexibly executing a guideline encoded in a format based on a guideline representation model, according to one embodiment of the invention.

FIGS. 5-27 illustrate application of the GLEE to a hypothetical patient case, according to one embodiment of the invention.

FIG. 28 is a block diagram of the structure of the logic-based medical decision-making task of the GETO, according to one embodiment of the invention.

FIG. 29 is a block diagram of the relationship among the guideline execution tasks, the structure elements, and the execution constraints of the GETO, according to one embodiment of the invention.

FIG. 30 depicts a flow diagram showing a method for providing a generic guideline representation model for use by a guideline execution engine, according to one embodiment of the invention.

FIGS. 31-38 illustrate class mapping and slot mapping for the GETO, according to one embodiment of the invention.

FIG. 39 depicts the GESDOR Ontology Mapping Editor, according to one embodiment of the invention.

FIG. 40 is a block diagram of an overview of the GESDOR guideline execution model, according to one embodiment of the invention.

FIG. 41 is a flow diagram showing a method for executing a guideline encoded in a format based on one of a plurality of guideline representation models, according to one embodiment of the invention.

FIGS. 42-45 illustrate slot value translations for slot mapping, according to one embodiment of the invention.

FIG. 46 is a block diagram showing creation of a primary task by the GESDOR, according to one embodiment of the invention.

FIG. 47 is a block diagram showing chaining of primary tasks and the start, finish, and abort criteria of a process structure in the GESDOR, according to one embodiment of the invention.

FIG. 48 illustrates a system involving GLEE and GESDOR, according to one embodiment of the invention.

### DETAILED DESCRIPTION OF THE INVENTION

The GLIF guideline representation model was developed by the InterMed Collaboratory, a medical informatics research consortium created by researchers from Columbia University, Harvard University, and Stanford University. Thereafter, the GLIF2 model, which provided reasonably comprehensive conceptual structures for guideline representation, was released. However, GLIF2 did not explicitly define some of the important computational level structures, such as the expression language that is used for decision making. Thus, the GLIF3 model was eventually released, and it includes a complete computational model to support patient-specific clinical decision making.

In the GLIF3 model, clinical practice guidelines are instantiated as specific guidelines. For each guideline, documentation on the clinical evidence, from which the guideline is developed, is encoded as supplemental materials, and information about the guideline and its maintenance is represented as maintenance info. The various clinical data that are encoded as data items (e.g., the process of clinical care) are encoded as an algorithm of a guideline. Within an algorithm, five types of task instances, which are called guideline steps, can be encoded and chained together to specify their scheduling and coordination during guideline application. Specifically, action steps are used to record clinical or computational actions; decision steps are used to encode decision points; patient state steps are used to specify a patient's pathophysiological or management states in the specific contexts of a guideline's application; and branch steps and synchronization steps are used to schedule and to coordinate concurrent tasks or tasks with undefined temporal ordering.

For each type of guideline step, specific elements are defined to support its representation. For an action step, these elements include: (1) tasks that are used to specify the clinical or computational actions in the step; (2) triggering events that are used to encode the clinical events, which act as triggers for the action; and (3) the next step that is used to schedule the subsequent guideline step once the current step is finished. An action step can have multiple tasks. Each of the tasks can be: (1) a medically-oriented action that is used to represent a clinical intervention; (2) an assignment action that is used to assign a value to specific clinical data; (3) a get-data action that is used to collect patient information; or (4) a subguideline action that is used to encode a nested guideline.

Decision steps in GLIF3 can be further classified into case steps and choice steps. Case steps are used to encode those decisions that can be automatically processed by the underlying guideline execution engine, while choice steps are used to encode decisions that require interaction with clinicians before the decisions can be made. A decision step usually consists of: (1) a set of options that define the candidates from which selections can be made during the process of decision-making; and (2) triggering events that are used to trigger the decision. Corresponding to each type of decision step, two different types of decision conditions are provided to support the decision-making process. Specifically, a case condition uses a single criterion to specify the condition that should be satisfied in order for an option in a case step to be selected, while a rule in choice uses a set of rule-in criteria and a set of rule-out criteria to define the pros and cons of an option in a choice step. In addition to these decision conditions, a destination is defined in a decision option to schedule the subsequent task once that option is selected.

In GLIF3, patient state steps are defined to label a patient's clinical or management states in specific contexts of a guideline's application. Within each patient state step, the patient state description is used to record the criterion that should be satisfied by a patient in that context, while the next step is used to define the subsequent step once the current patient state step is finished. Patient state steps can be used to represent specific clinical scenarios, which are especially useful when modeling chronic disease management where these clinical scenarios can be used as entry points to a guideline.

Branch steps and synchronization steps are two types of guideline step in GLIF3 that can be used together to represent complex task scheduling. Specifically, a branch step defines a point from which multiple paths diverge, representing the case when several types of care can be provided to a patient concurrently or in an order that should be decided by clinicians when a guideline is applied. This set of diverging paths, represented by the first step of each path, is defined through the branches attribute of a branch step. A synchronization step, on the other hand, defines a point where the diverged paths converge back, representing the case when coordination is necessary among different clinical care tasks. The criterion that is used to coordinate different tasks is encoded in the continuation attribute of a synchronization step; meanwhile, the next step attribute is used to specify the subsequent task that should be performed. The clinical care process represented in the GLIF3 model can be nested; thus, multiple views with different granularities to the care process can be defined. This nesting of guidelines can be encoded using a subguideline action in the task of an action step, or using a guideline in the decision detail of a decision step.

Clinical data in GLIF3 are encoded as data items, each consisting of: (1) a concept id that is used to specify the concept of that data; (2) a concept source ID that is used to identify the controlled medical terminology within which the concept in (1) is defined; (3) a data model class ID that is used to reference the data; (4) a data model source ID that is used to identify the data model within which the data model class in (3) is defined; and (5) a data value that is used to store the value of the data when they are retrieved from a clinical database. GLIF3 can support different types of guideline expression languages, such as the Guideline Expression Language (GEL). Table A below provides the list of representations, and corresponding functions of the representations, in the GLIF3 model.

TABLE A

| Representation | Element Primary Function |
|---|---|
| guideline | encoding of a guideline or a |
| | subguideline |
| supplemental material | documentation of the clinical evidences |
| | of a guideline |
| maintenance info | record of the maintenance information |
| | of a guideline |
| data item | specification of clinical data and actions |
| algorithm | representation of the clinical care process |
| | of a guideline |
| guideline step | a primitive task in the clinical care process |
| action step | a type of guideline step that defines clinical |
| | actions |
| decision step | a type of guideline step that defines |
| | decision-making points |
| patient state | step a type of guideline step that defines |
| | labels of patient state |
| branch step | a type of guideline step that defines |
| | branching points |
| synchronization step | a type of guideline step that defines |
| | synchronization points |
| case step | a type of decision step that can be |
| | automatically finished |
| choice step | a type of decision step that needs |
| | interventions from users |
| decision option | definition of the candidates for |
| | decision-making |
| triggering event | definition of clinical events that trigger |
| | actions or decisions |
| assignment action | a type of task in action steps to assign a |
| | value to a variable |
| get data action | a type of task in action steps to retrieve the |
| | values of data |
| subguideline action | a type of task in action steps to define |
| | nested guidelines |
| medically oriented | a type of task in action steps to define |
| action | medical actions |
| decision condition | definition of the conditions for |
| | decision-making |
| case condition | a type of decision condition with a single |
| | criterion |
| ruleinchoice | a type of decision condition with a set of |
| | rule-in and ruleout |
| criteria | criterion specification of an expression for |
| | decision making |

The PROforma model was built within a framework that allows human and machine cognition to support the interactions between PROforma tools and users. In PROforma, a guideline consists of a set of tasks which are used to represent specific work that needs to be performed by clinicians during patient care. Tasks can be classified into actions, inquiries, decisions, and plans, each representing a specific type of clinical-related task. Within these four types of task, actions specify the clinical interventions that should be provided to a patient; enquiries define the process of data collection; decisions are used to represent clinical decision making; and plans are specials tasks that consist of other lower-level tasks.

As PROforma is built on logic, its decision-making ability is based on logical inference. Specifically, a decision task in PROforma consists of a set of candidates, each of which contains a set of arguments and a recommendation. Each argument defines a logic criterion, which is encoded as a proforma condition, and a specific way this criterion is used to support decision making. If the arguments for a candidate are strong enough that the candidate is selected during the decision-making process, the recommended action encoded in the recommendation attribute of that candidate will be performed. PROforma uses the precondition and postcondition of a specific task to chain the tasks together in a plan. In contrast to these preconditions and postconditions, which are typically used to define the logical characteristics of a patient or a guideline implementation system in a specific context, scheduling constraints are used for task scheduling that is based solely on the completion of other tasks. Similar to the case with GLIF3, a task in PROforma may need a trigger, which is represented by a proforma function term. Data in PROforma are referenced through sources, which can be found in an enquiry task and a decision task. Table B below provides the list of representations, and corresponding functions of the representations, in the PROforma model.

TABLE B

| Representation | Element Primary Function |
|---|---|
| task | a primitive task in the clinical care process |
| action | a type of task that defines a clinical |
| | intervention |
| enquiry | a type of task that defines a process of |
| | data collection |
| decision | a type of task that defines a process of |
| | decision-making |
| plan | a type of task that consists of a set of |
| | other tasks |
| candidate | definition of the candidates for |
| | decision-making |
| argument | definition of the arguments for a |
| | candidate |
| recommendation | recommendation of action when a candidate |
| | is selected |
| proforma | definition of the conditions for arguments |
| condition | or preconditions |
| proforma data | definition of the data assignments for |
| assignment | postconditions |
| scheduling | definition of the constraints for task |
| constraint | scheduling |
| proforma functor | term definition of the trigger for a task |
| data | specification of clinical data and actions |
| source | reference to specific sources such as |
| | patient data |

In general, GLIF and PROforma, as well as other guideline models shown in Table C, contain primitives (e.g., representations elements) that are used to represent specific clinical tasks. The common primitives may generally be classified into two categories: actions and decisions. Most of the models also contain primitives that may be used to represent intermediate states of a specific context during the application of clinical practice guidelines. These intermediate states may be either patient states that describe the clinical status of a patient, or execution states that describe the situation of a guideline implementation system. Some guideline representation models do not directly represent a patient's clinical state during guideline application; instead, these models represent the execution state, which is closely related to the clinical state of a patient.

An action is a clinical or administrative task that is recommended to be performed, maintained, or avoided during the process of guideline application, e.g., recommendation of a medication or invocation of another guideline. A decision is a selection from a set of alternatives based on predefined criteria in a guideline, e.g., selection of a lab test from a set of potentials. A patient state in the context of a guideline is a reification of a treated individual's clinical status based on the actions that have been performed and the decisions that have been made. For example, the description of a patient who has already received the first dose of the influenza vaccine, and is eligible for the second dose, as in the state of eligible-for-the-second-dose-of-influenza-vaccine, is a patient state. An execution state is a description of a guideline implementation system based on the stage of a task, such as the action and decision defined previously, during the process of guideline execution. By way of example, the description of a guideline system as ready for execution of the task recommend-the-second-dose-of-influenza-vaccine, when a patient has already received the first dose of the influenza vaccine and is eligible for the second dose, is an execution state. The primitives for the various guideline representation models are summarized in Table C.

TABLE C

| Guideline Model | Actions | Decisions | Patient States | Execution States |
|---|---|---|---|---|
| Arden Syntax | Action slot | Logic slot | No | No |
| DILEMMA/ | Protocol | State transition | — | Procedure state |
| PRESTIGE | | | | |
| EON/DHARMA | Action, activity | Decision | Scenario, | No* |
| | | | activity state | |
| PROforma | Action, enquiry | Decision | — | Task state |
| Siegfried | Recommendation | Logic | No | No |
| GLIF | Action step | Decision step | Patient state | No* |
| | | | step | |
| Asbru | Plan | Condition, | Temporal | Plan state |
| | | preference | patterns | |
| GUIDE/PatMan | Task, wait, | Decision | Implicit in | — |
| | monitor | | Petri Net | |
| PRODIGY | Action, activity | Decision | Scenario | — |
| GASTON | Action | Decision | — | — |
| Torino | Work action, | Decision action | Conclusion | — |
| | query action | | | |

*EON/DHARMA and GLIF have execution states, but the execution states are not in the guideline representation model.

The process structure of a guideline defines a framework for guideline execution, within which the scheduling constraints of guideline execution tasks and the nesting of guidelines are specified. The scheduling constraints specify the temporal order in which the primary tasks can be executed. The nesting of guidelines defines the hierarchical relationship among tasks. The approaches taken by the various guideline models, with regard to the representation of scheduling constraints and nesting of guidelines, are summarized in Table D.

TABLE D

| | | Nesting of |
|---|---|---|
| Guideline Model | Scheduling Constraint | Guideline |
| Arden Syntax | module invocation | |
| DILEMMA/PRESTIGE | protocol composition, | protocol |
| EON/DHARMA | state transition diagram | subguideline |
| PROforma | flowchart | plan |
| Siegfried | constraint satisfaction | subguideline |
| | graph | |
| GLIF | unidirectional graph | |
| Asbru | flowchart | plan |
| GUIDE/PatMan | plan-body | task |
| PRODIGY | flowchart | subguideline |
| GASTON | state transition diagram | subguideline |
| Torino | flowchart | composite action |

Scheduling constraints are typically defined as a sequence or concurrence of the primary tasks. Primary tasks in a sequence should be executed one by one, according to a particular schedule. Primary tasks in a concurrence should be executed in parallel. The representation of a simple sequence is straightforward, usually defined by a relation that specifies the scheduling order of two consecutive primary tasks, as in GLIF and PROforma. In Asbru, concurrence and sequence, including complex sequences such as those with unknown order, can be specified in two dimensions: ordering constraint and continuation condition. Ordering constraint can take on the value, parallel, any order, or total order, while continuation condition can take on the value, all completed or some completed. A combination of these two dimensions results in five scheduling constraints: do all together, do some together, do all in any order, do some in any order, and do all sequentially. A similar approach is taken by EON/DHARMA. GLIF uses a branch step and a synchronization step to represent concurrence and complex sequences with partial scheduling order.

In terms of the overall structure, most of the models described herein, including EON/DHARMA, Siegfried, GLIF, GUIDE/Patman, GASTON, and Torino, represent scheduling constraints as flowchart-like algorithms. The PROforma model represents its process structure as constraint satisfaction graphs. PRODIGY, on the other hand, models a guideline as a diagram of state transitions between patient scenarios.

Nesting of guidelines enables multiple levels of abstraction in guideline representation, and provides views to a guideline with different granularities. All of the models, except the Arden Syntax and the Siegfried models, support guideline nesting. Nesting is realized through recursive decomposition of protocols in DILEMMA/PRESTIGE; inclusion of subguidelines in EON/DHARMA, GLIF, and PRODIGY; classification of tasks in GUIDE/Patman; definition of composite actions in Torino; and specification of plans in PROforma and Asbru.

Primary tasks are the guideline execution tasks that constitute the basic unit of a guideline's process structure. Primary tasks can be further classified into clinical tasks and scheduling tasks, according to their functions in guideline execution. Clinical tasks represent clinical interventions, data collection, decisions, and patient state identifications, which are recommended to clinicians during guideline application. Scheduling tasks are those with internalized specifications of scheduling constraints and guideline nesting, which are used solely for computation purposes.

Clinical tasks can further be classified into three categories: clinical action, medical decision making, and patient state verification. A clinical action is a task that is recommended to be performed, maintained, or avoided during the process of guideline application, e.g., recommendation of a medication. Medical decision making is a task that involves selection from a set of alternatives, based on predefined criteria in a guideline, e.g., choosing a lab test from a set of possibilities. Patient state verification is a process to identify and to validate a treated individual's clinical status in a specific context of a guideline, based on the actions that have been performed and the decisions that have been made.

Clinical actions can be further classified into clinical interventions and data collections. Clinical interventions are the actions that deal directly with the management and treatment of patients, such as prescriptions and operations. Data collections, on the other hand, do not deal with the treatment of patients directly. Instead, they are only used to obtain the information about patients, such as observations and examinations. PROforma distinguishes clinical interventions from data collections by using two different types of task—actions and enquiries—with the former corresponding to clinical interventions, and the latter corresponding to data collections with values that can be retrieved immediately. Similar representation elements that are used to encode data collections can be found elsewhere, such as the temporal query in EON/DHARMA, get-data action in GLIF, and query action in Torino.

Medical decision-making is used to simulate the process of a clinical decision, during which a specific option should be selected from a set of alternatives. All of the guideline models discussed herein support the representation of medical decision making. For example, in Arden Syntax, medical decision making is encoded as the logic slot of an MLM, while in GLIF and EON/DHARMA, it is represented using decision steps. In Asbru, medical decision making is not represented explicitly as an independent element; instead, it is encoded within the conditions and preferences of a plan that define the criteria of transition from one plan state to another. Most models support the representation of decision making that is based on logical criteria. Some of the models described herein support more complex modes of decision making, e.g., the decision task in the GUIDE/PatMan model is based on decision analyses. GLIF moves a step further, to distinguish decisions that can be made automatically by a guideline implementation system, from those that need manual judgment by clinicians. For this purpose, GLIF has two types of decision steps, case steps and choice steps, which are used separately to represent automatic decisions and user-assisted decisions. Considering that there exist very different approaches to medical decision making, extensibility of the decision mode is an important feature for a guideline representation model.

Patient states are used to represent specific scenarios of a patient's clinical or management state in the context of a guideline's application. Patient states can act as enter/exit points of a guideline, when applied to a specific patient. For example, PRODIGY supports the representation of patient states using patient scenarios, which are used to encode specific encounters when modeling guidelines for the management of chronic diseases. Similar approaches can be found in other models, such as scenarios in EON/DHARMA and patient state steps in GLIF.

In contrast to primary tasks, auxiliary tasks are computation tasks that are used to support the execution of the primary tasks. Typical auxiliary tasks in a guideline representation model include decision criterion evaluation, scheduling constraint criterion evaluation, clinical event registration, clinical event triggering, and the execution tasks that are used to support the communication between a guideline implementation system and a hosting clinical information system, such as those used for data retrieval and clinical intervention. These auxiliary tasks are usually embedded implicitly within a guideline model, and are supposed to be implemented by a guideline execution system that is based on that model.

Although the present invention may be explained, by way of example, in relation to clinical practice guidelines and the particular representation models, such as the GLIF3 model, it is understood that the present invention or inventions may be adopted or applied to provide the inventive functionality described herein with respect to guideline execution systems in various institutions, and to various types of guideline representation models, and, therefore, is not limited thereto.

### GLEE

The present invention, a guideline execution engine (“GLEE”), may be provided as middleware which interfaces with an institution's medical records systems and clinical applications to provide flexible guideline execution. In one embodiment, the GLEE is an engine adapted to execute instances of a guideline that are encoded in one or more formats (selected from a plurality of guideline representation models available, including the GLIF format or any derivation thereof, such as the GLIF3 format). GLEE may therefore take several forms. For instance, GLEE may be a component of an executable program providing the functionality described herein, or a program module or modules designed to interface with applications or program modules that provide some of the functionality described herein. In one embodiment, GLEE acts as middleware that can be integrated with a clinical information system at a local institution, such as a hospital, through interfaces to the institution's clinical applications (physician order entry, clinical event monitors, notification system, etc.) so that guideline implementation can integrate seamlessly with a local environment. Moreover, since GLEE can be hooked up with electronic medical records system, it may be used to apply guidelines to specific patients. In addition to providing clinical decision support, GLEE may be used for quality assurance, guideline development, and medical education.

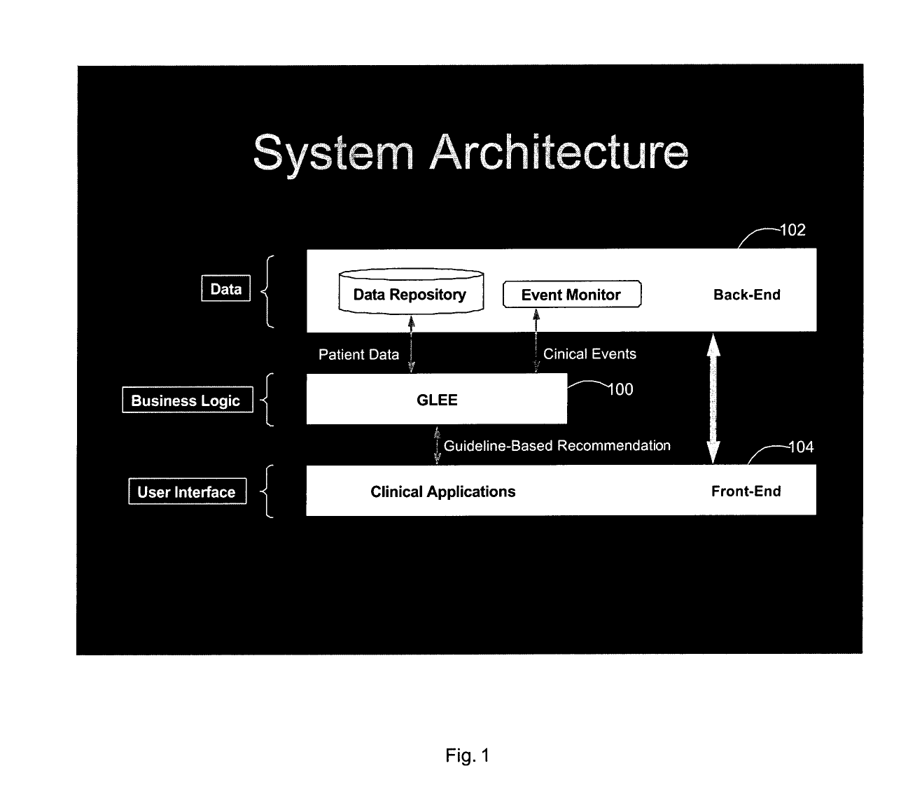

Referring to FIG. 1, in one embodiment, GLEE 100 interfaces to the hosting clinical information systems at a local institution. This may be accomplished with standard interfaces that interface, for example, with a local electronic medical record system back-end 102, and associated clinical applications (e.g., a physician order entry system) at the front-end. The communication between GLEE 100 and the electronic medical record system back-end 102 enables access to various resources in the local environment, such as retrieval of patient data and monitoring of clinical events. The communication between GLEE 100 and associated clinical applications at the front-end 104 enables smooth integration of the decision support services provided by GLEE 100, such as alerts and reminders, within a clinician's workflow. In other words, GLEE 100 provides the business logic of guideline application; the local electronic medical records system provides data for guideline application; and the associated clinical applications support the interactions between users and a guideline implementation system.

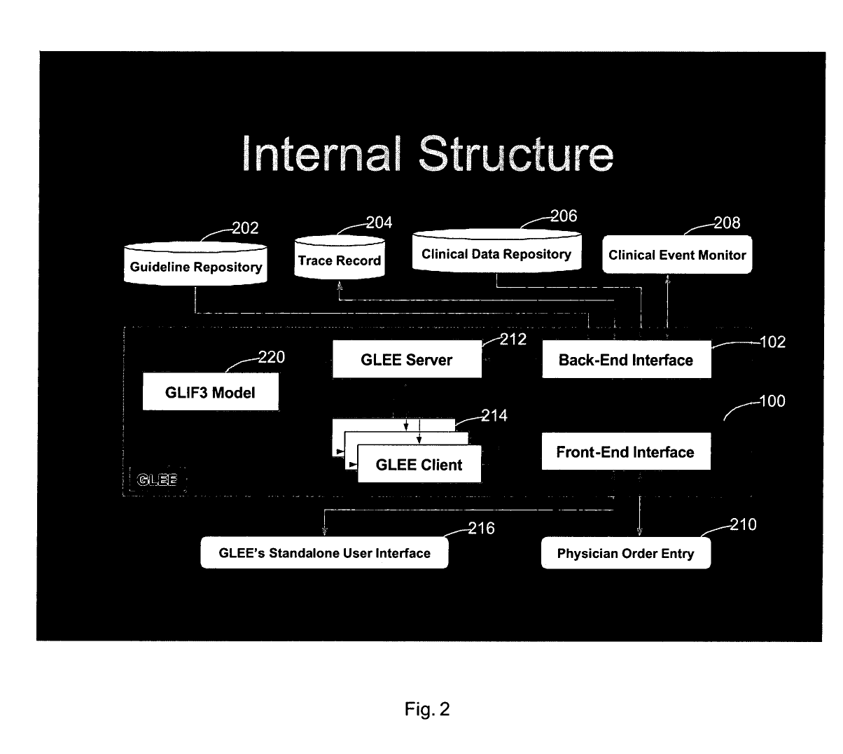

Referring to FIG. 2, in one embodiment, GLEE 100 comprises at least one or a plurality of software components that, when executed, provide the functionality of the engine. GLEE 100, for instance, may be designed as a client-server system, in order to obtain maximum flexibility in its integration with hosting systems. GLEE's components can generally be classified into conceptual layers: (1) the guideline representation model 220, such as the GLIF3 model; (2) the core components of GLEE, e.g., the GLEE server and the GLEE client or clients; and (3) the standard interfaces to a hosting clinical information system. The guideline representation model 220 provides a set of generic functions, such as recommendations of specific clinical actions and assistance in medical decision-making. The core components of GLEE define an execution model to realize or use the generic functions that are required by the guideline representation model. The standard interfaces to a hosting clinical information system provide the interaction between GLEE 100 and its hosting environment. In addition to the standard interfaces to a local clinical information system, GLEE 100 may also provide a standalone user interface 216 to facilitate development and demonstration, and may be used as a tool to assist in medical education and guideline development.

A GLEE server 212 may: (1) interface with the particular guideline representation model 220 or models, so as to obtain correct interpretation of the guidelines, e.g., the GLIF3 guidelines, and parse a coded guideline; (2) communicate with a local environment at the back-end, including retrieval of guideline from a guideline repository 202, reading and writing of execution traces when a guideline is applied to a specific patient to a trace record repository 204, accessing patient data from a clinical data repository 206, and monitoring registration and triggering clinical events, e.g., with a clinical event monitor 208; (3) manage GLEE clients 214, including bookkeeping of the guideline and patient for a client, selection of the primary client for a specific guideline-patient pair, and recording the information for client-server communication; and/or (4) provide computation support for task scheduling, task execution, and state transition for a specific client, e.g., with a GLEE task scheduler.

A GLEE client 214 may: (1) support the interactions between a clinical applications and a user, such as providing recommendations of clinical actions, and generally assisting with medical decision-making as defined in the particular guidelines; and (2) record the execution state in a specific round of a guideline's application for a particular patient. In one embodiment, each GLEE client 214 corresponds to an application of a specific guideline to a particular patient. If there exist multiple GLEE clients 214 with the same guideline-patient pair, as may be the case when several clinicians are providing care to a patient concurrently, only one of the clients 214 is selected as the primary client within which the execution can actually be performed, while the remaining clients 214 run in watching mode, where the execution results of the primary client are presented, but the support for a user's subjective decision on execution is disabled.

Guidelines encoded in a particular format, such as the GLIF3 model format, are stored in a guideline repository 202, from which they can be retrieved to the GLEE server 212. The GLEE server 212 and/or a user may identify a guideline for execution with a unique identifier assigned to each guideline, patient, patient data, etc. Alternatively, GLEE may include a guideline server component, which allows a user to browse and execute specific guidelines in the guideline repository 202, and access patient data in a clinical data repository 206.

The back-end interface generally facilitates the communication between the GLEE server and the applicable applications and/or databases, to retrieve guidelines, patient records, communicate trace records to and from a trace record repository, register clinical events with the local clinical event monitor, trigger clinical events and notifications with a local clinical event monitor' 208, generic messaging to a host system, etc. A trace record is generally used to record the history of the application of a specific guideline to a particular patient, such as to record the execution state of each guideline step, the change of a guideline step from one execution state to another, the result of a decision step, the indication when entering and leaving a guideline or subguideline, etc. The trace record or records may be in an XML format, and the communication between the GLEE server and the trace records, therefore, becomes the sending and receiving of XML file streams.

The front-end interface similarly facilitates the communication and interaction between the GLEE client and the clinical applications. The interactions include the different types of guideline steps and the characteristics defined by the particular guideline representation model 220, e.g., the GLIF3 guideline representation model, as well as other types of interactions not provided by the particular guideline representation model, such as those provided by the GLEE's guideline execution model. For example, the decomposition of a problem goal through a subguideline, the recommendation of clinical action, and the assistance for medical decision-making, may be defined by the GLIF3 model, whereas other types of interactions, such as a user's decision during guideline execution to continue to pursue the original goal, to revise the original goal, or to formulate a new goal based on the observed patient state, may be defined by GLEE's guideline execution model. In one embodiment, the interaction between the GLEE client and the clinical applications, such as the start or stop of a specific guideline step, are specified by GLEE itself. The front-end interface between the GLEE client and the clinical applications may also be used: (1) to select a particular guideline and a specific patient for execution; (2) to provide recommendations for clinical actions; (3) to assist medical decision making; (4) to verify a patient's clinical or management state; (5) to decompose the imputed problem goals; and (6) to support a user's subjective decision on guideline execution. The front-end interface between the GLEE client and the clinical applications may also be used by GLEE's client-side standalone user interface 216 to support the interactions between a user and GLEE through the standalone user interface 216.

A discrepancy may arise between a patient's expected state, as encoded in a specific context of a guideline, and his or her actual state during guideline execution. Accordingly, GLEE's allows a user to override a system's recommendation during guideline execution. In order to provide this flexibility in guideline execution, a GLEE execution model that supports user-controlled task scheduling, and a tracing system to record the guideline execution process, may be used. The tracing system, along with GLEE's guideline execution model, can be used to recover the execution history of a guideline's application to a specific patient.

The traditional approach to task scheduling during guideline execution is to determine mechanically the executable tasks defined by an encoded guideline, in a specific context, when the guideline is applied to a patient. With this approach, the whole process of task scheduling is completely controlled by the execution engine. A major drawback of this approach is that an encoded guideline generally cannot address every possible clinical scenario, and, thus, may lead to a discrepancy between what the guideline system suggests and what the clinician correctly determines should be done actually for a patient. Several guideline representation models, including GLIF3, have addressed this issue by providing representation primitives, such as patient scenarios or patient states, that can be used to record a patient's clinical status in a specific context of a guideline. These patient scenarios, or patient states, can then be used as entry/exit points to a guideline, when applied to a patient.

Although this solution can provide some flexibility in execution, it still depends, to a large extent, on the guideline encoders' enumeration of all possible entry/exit points for a guideline. There is, therefore, a need to allow a user to override the system's recommendation on task scheduling; this is important for the successful application of a guideline in a clinical environment. Accordingly, GLEE provides an extra level of execution flexibility at the representation level, through patient state steps, and also flexibility at the execution level, which allows the user to be the final decision maker in task scheduling. In other words, at any time during the execution of a guideline, users can follow the task schedule suggested by the system, or they can start or stop the execution of any step based on their own judgment.

To distinguish the scheduled steps suggested by GLEE from those actually executed by the users' decisions, four execution states may be used to represent the status of a guideline step during execution. The execution states of a guideline step may include: (1) a prepared state, which means a step is suggested as executable by the execution engine; (2) a started state, which means a step has actually been started by a user; (3) a stopped state, which means a step has been intentionally stopped by a user before it starts or completes its execution; and (4) a finished state, which means a step has normally completed its execution. The prepared state and the started state are jointly called active state. The finished state and the stopped state are jointly called inactive state.

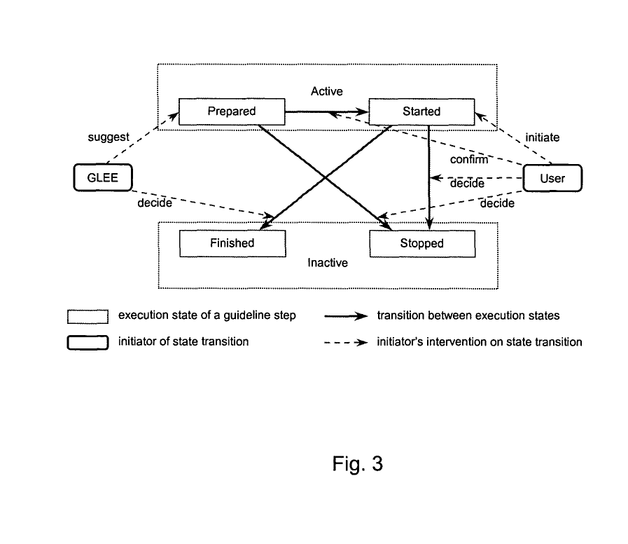

Typically, the GLEE task scheduler suggests executable steps based on the scheduling information encoded in specific guideline steps, or, in the case of a new encounter, when applying a specific guideline to a particular patient, based on the trace record of previous encounters with the guideline by the current patient. These executable steps are then put into prepared states. Users can either confirm GLEE's suggestion on the execution schedule, or they can decide to override it by stopping a prepared step and starting another step they think to be appropriate. Users can also stop a started step to avoid unnecessary waiting for completion of an execution that is no longer relevant. If there is no manual interference from users, GLEE will decide when a started step should finish its execution. Usually, this will trigger the execution of other steps that will be put into prepared states by the GLEE task scheduler. It is important to note that this change of a guideline step, from an inactive state to an active state and then back to inactive, may happen for multiple rounds. The execution states of a guideline step and transitions between these states are shown in FIG. 3.

To support the application of a specific guideline to multiple patients, a batch execution mode may be provided by GLEE. In contrast to the individual execution mode, where GLEE supports the execution of a guideline only to a specific patient, and a clinician needs to confirm the task schedule suggested by GLEE, the GLEE system running in the batch execution mode automatically accepts all executable steps recommended by its task scheduler, and randomly selects a prepared step to execute each time a user selection is needed.

A guideline execution trace or trace record of a patient to record may be created by one or more of the following steps: (1) an activation step, in which an inactive guideline step becomes active, either recommended by GLEE to be in the prepared state, or assigned by a user to be in the started state; (2) a start step, in which a guideline step changes from the prepared state to the started state, as decided by a user; (3) a finish step, which is a process in which a guideline step has normally finished its execution as scheduled by GLEE; (4) a stop step, in which a guideline step is stopped by a user before finishing its execution; and (5) a chaining step, in which the connection between the completion of one step and the start of another step is defined.

Step activation can be further classified into two categories, including: (1) step activation as prepared, which is a process in which an inactive step is scheduled by GLEE to be in the prepared state; and (2) step activation as started, which is a process in which an inactive step is assigned by a user to be in the started state. Step chaining can be further classified into three categories, including: (1) flat step chaining between two guideline steps in the same algorithm, where the two steps are at the same level of the guideline hierarchy; (2) expanding step chaining, from a step of an upper level guideline in the guideline hierarchy to a guideline step of a lower level guideline in the guideline hierarchy; and (3) collapsing step chaining from a guideline step of a lower level guideline in the guideline hierarchy to a guideline step of an upper level guideline in the guideline hierarchy. As the same guideline step may be nested in different places of the guideline hierarchy, the name of the step, the algorithm in which the step is encoded, and the path in the guideline hierarchy, starting from the root guideline and ending at the guideline of the current guideline step, may be used together to identify a specific guideline step in the trace. The different types of components that may be identified in a trace record, and their primary documentation functions in GLEE, are summarized in Table E.

TABLE E

| Trace Record | |
|---|---|
| Component | Primary Documentation Function |
| step activation as | activation of a guideline step as a prepared |
| prepared | step by GLEE |
| step activation as | activation of a guideline step as a started |
| started | step by a user |
| step start | change of a guideline step from a prepared |
| | step to a started step |
| step finish | finish of a guideline step |
| step stop | stop of a guideline step |
| flat step chaining | step chaining between two guideline steps at |
| | the same level of the guideline hierarchy |
| expanding step | step chaining from an upper level guideline |
| chaining | step to a lower level guideline step in the |
| | guideline hierarchy |
| collapsing step | step chaining from a lower level guideline |
| chaining | step to an upper level guideline step in the |
| | guideline hierarchy |

The trace that records the execution history, when applying a specific guideline to a patient, can be used for task scheduling in future encounters of the patient, when the same guideline is reapplied. Specifically, if the trace of a patient has shown that the execution of specific guideline steps had not been finished in previous applications of the guideline to the current patient, those unfinished guideline steps will be recommended by GLEE as the potential starting points when the same guideline is reapplied to that patient. This feature is especially important for implementation of guidelines that are used for chronic disease management, where the application of a guideline to a particular patient usually involves multiple encounters. With GLEE's ability to parse the execution trace that records previous encounters, application of a guideline to a specific patient can start from a particular point in the guideline that corresponds to the patient's current management state, instead of from the start of the guideline in each encounter.

In addition to its use as a hint for task scheduling, the trace record may also be used in guideline execution to decide whether the continuation criterion of a synchronization step is satisfied. Specifically, the completion of the last step in each incoming path of a synchronization step, within a guideline's algorithm, is recorded in the trace. This information may be used later in the evaluation of the continuation criterion of the synchronization step—when that synchronization step is started, or, in the case when the synchronization step has already been started, but has not finished because it is waiting on the completion of specific incoming steps, each time an incoming step is finished.

The execution trace can also provide a complete record of a guideline's execution, for quality assurance purposes, to determine whether the care provided to a specific patient is in compliance with guideline recommendations. The trace record used for such purposes may simply be extracted from a patient's medical record. Some of the execution history that is recorded in the trace (e.g., the start of an action step that corresponds to a specific type of clinical intervention, such as the prescription of a medicine) can be found in a typical medical record; however, many other elements in GLEE's trace records may not have been documented in the medical records, but may be useful for the proper execution of a guideline. Accordingly, a trace record system that independently traces certain elements of a guideline execution may be desired.

Most guideline representation models, including GLIF3, support an event-based execution model by defining triggering events for a specific guideline step. Where GLEE is integrated with the clinical information system at a local institution as middleware, the event monitor, which is inherently embedded within a local system, will sit outside of GLEE. Alternatively, GLEE may include the functional aspects of an event monitor, as discussed herein.

The event-based execution model generally defines two types of events in GLEE: clinical events and system events. Clinical events are those with clinical significance, such as newly-arrived lab test results or physician orders. The system events are those used for guideline execution purposes. An example of a system event is the completion of a step preceding a synchronization step, which is used to decide whether the latter's continuation criterion can be satisfied.

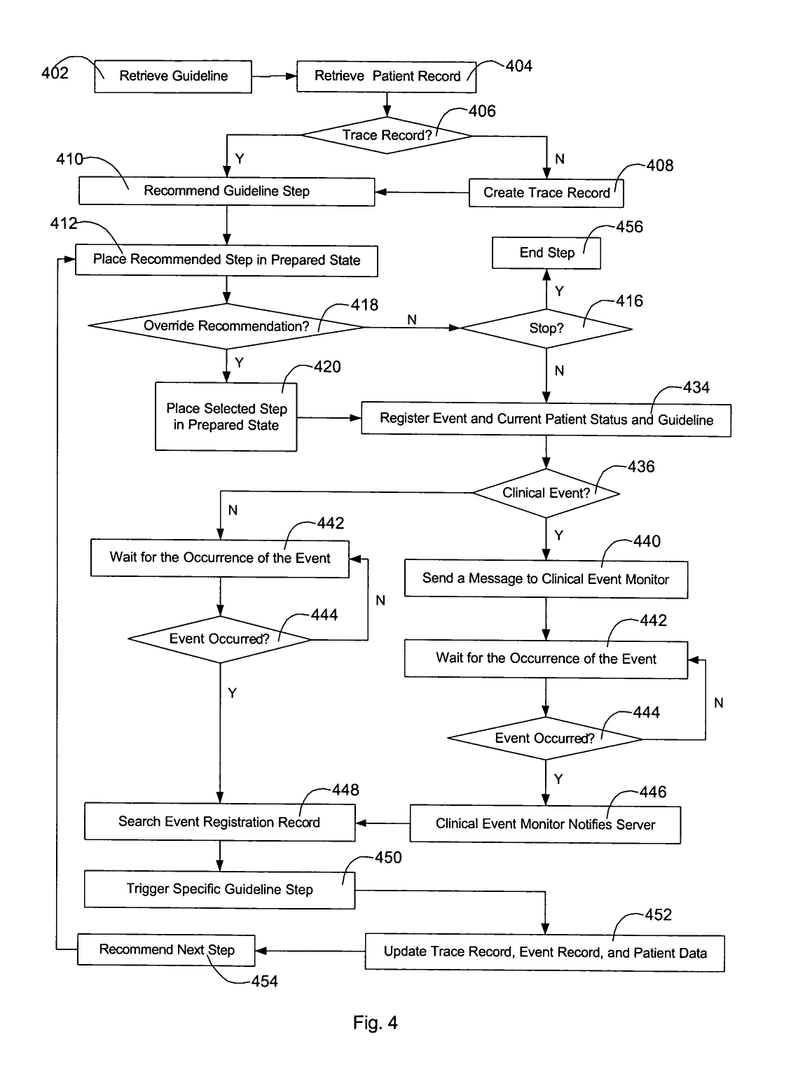

Referring to FIG. 4, the method for executing a guideline instance may begin by a user or the system selecting a guideline, and the system correspondingly retrieving the guideline for execution, step 402. Patient information may then be retrieved, e.g., from the patient, from a clinical data repository, or a combination thereof, step 404. If the particular guideline is being executed for the particular patient for the first time, and, consequently, a trace record is not available for the particular guideline and patient, step 406, a trace record may be created, step 408, which may be used to track the execution history of the guideline instance. The system may then recommend a guideline step, step 410, based on the patient data and trace record. The recommendation may be a step in a set of steps defined in the guideline in accordance with the particular guideline representation model within which the guideline is encoded, such as the first step, where the guideline is executed anew. The recommendation may also be a subsequent step in the set of steps defined in the guideline, where the guideline execution is being resumed. In any event, the step may be put into a prepared state, which may be confirmed or overridden by a user, either directly or indirectly, through a clinical application or applications.

In one embodiment, the step includes a triggering event or condition, and is recommended and/or placed into a prepared state by registering that event, along with the current patient and guideline, in an internal event registration record, step 434. If the registered event is a clinical event, step 436, the GLEE server may send a message to the clinical event monitor, step 440, for event registration, and may then wait for the occurrence of the registered event to trigger a guideline step for execution, step 442. Once a clinical event occurs, step 444, the clinical event monitor may send a message to the GLEE server to notify the triggering of the event, step 446. The GLEE server may then search the event registration record, step 448, to find the corresponding patient, guideline, and guideline step that are waiting for the event. Consequently, the specific guideline step is triggered to start its execution, e.g., the next recommendation, or to place the step in a prepared state, step 450. The internal event registration record may then be adjusted to reflect the triggering of the registered event, and the GLEE server may then notify specific GLEE clients that have registered for this event and do relevant processing for task scheduling and execution as described previously, including updating the trace records.

As noted above, the user or system may confirm the recommended step, stop the step, step 416, or override the recommended step, step 418. Step confirmation may be direct insofar as the user may directly, with a user interface, select to confirm a step, or indirectly, with a signal or message from the clinical applications, e.g., the events monitor, indicating that the step was executed by the clinician. If, at step 418, the user decides to override the recommendation and, e.g., select another step, the selected step is placed in a prepared state, step 420.

A guideline representation model, such as the GLIF3 model, comprises the particular types of tasks, as well as the handling of the representation elements that are used to support the scheduling of the clinical tasks. In the GLIF3 guideline representation model, the elements that are used to represent the different types of clinical tasks include action step, decision step, and patient state step. Execution of these tasks is, in fact, a simulation process within which GLEE provides particular types of computational support to serve the needs of its user in patient care.

The action step in the GLIF3 model is used to represent specific actions that should be performed in guideline application. These actions could be, by way of example, a medical intervention, collection of patient data, value assignment to a clinical variable, or definition of a subguideline. When an action step is started, its triggering events slot is checked first. If any triggering events are defined, GLEE registers these events with the clinical event monitor institution, and puts the step on hold to wait for the triggering of the events. Once the registered events occur, the execution of the action step is triggered. GLEE may then scan all of the tasks defined within the step, and start processing based on the type of the tasks. Specifically, GLEE may send a message to notify the local clinical information system, if the task defined in the action step is a medically-oriented action; GLEE updates its internal data assignment record if the task is an assignment action; GLEE communicates with the clinical data repository at the local institution to retrieve specific patient data, and updates the internal data assignment record if the task is a get data action; and GLEE starts the execution of a subguideline if the task is a subguideline action. Once it has finished the processing of the tasks, GLEE may obtain the subsequent step of the action step through its next step slot. This subsequent step is then scheduled to be executable and its execution state is changed to prepared. Meanwhile, the execution trace is updated to record that the action step is finished, and the subsequent step is activated.

The decision step in the GLIF3 model is used to represent the process of medical decision making when applying a guideline to a specific patient. It can be further classified into a case step, which represents a decision-making process that can be implemented by GLEE automatically, and a choice step, which represents a decision-making process that needs inputs from a user. Similar to the execution of an action step, when a decision step is started, GLEE may check its definition of triggering events, and perform relevant tasks, such as event registration and triggering notification. During the execution, GLEE handles case step and choice step differently. For a case step, GLEE scans its options, and evaluates the criterion of the case condition in each of the options, until the criterion of an option can be satisfied, leading to the selection of that option as the decision result. For a choice step, GLEE presents the options of the step to a user at the client side, and waits for the user's decision on the selection of the options. Once an option is selected in the decision-making process, the subsequent step corresponding to that option is obtained. GLEE may then schedule the subsequent step to be executable, and update the relevant trace record.

The patient state step in the GLIF3 model is used as a label to specify a patient's clinical or management state in a particular context of a guideline's application. The criterion encoded in the patient state description slot of a patient state step is used to define a patient's status as represented by the step. This information may be compared to a patient's actual state during guideline application by GLEE or the user who may make the final decision on whether the observed patient data match the criterion defined in the patient state step. If so, the patient state is validated, and the subsequent step is scheduled.

In the GLIF3 guideline representation model, the elements that are used to represent the different types of scheduling tasks include branch step, synchronization step, and subguideline. These tasks constitute GLEE's computational support to workflow management, so that coordination of specific tasks can be implemented during guideline application.

The branch step in the GLIF3 model is used to represent a diverging point in a guideline's algorithm, so that concurrent tasks, and tasks with undefined order, can be represented. The branch step itself does not have any internal tasks that need to be performed. Its uniqueness is in its chaining with subsequent steps. The major difference between a branch step and other types of steps is that a branch step has multiple subsequent steps, while other types have only one. Consequently, after the execution of a branch step, GLEE may schedule all of the subsequent steps encoded in its branches slot to be in the prepared state. Thus, after a branch step is finished, there are multiple active steps that become executable.

The synchronization step in the GLIF3 model is used to represent a converging point in a guideline's algorithm, so that concurrent tasks can be coordinated during a guideline's application. When a synchronization step is executed, its continuation criterion is evaluated. During this evaluation, GLEE checks the execution history, as recorded in the execution traces. If the continuation criterion is not satisfied, the synchronization step will wait until the completion of other steps eventually leads to the fulfillment of the continuation criterion.

In the GLIF3 model, subguidelines are used to provide different views into the clinical care process. A subguideline is encoded either as a subguideline action in the task of an action step, or as a guideline in the decision detail of a decision step. When a step with a defined subguideline is started, the user of GLEE can choose to go to the lower level of the guideline hierarchy to execute the subguideline, or to skip the subguideline to keep the execution at the current level of the guideline hierarchy, if the goal of the subguideline has already been achieved. Once a user decides to execute the subguideline, the first step of the subguideline is scheduled to be executable, leading to the initialization of that subguideline's execution. This process is recorded as an expanding step chaining in the trace records. During the whole execution process of the subguideline, the step of the upper level guideline, within which the subguideline is defined, may remain in the started state. After the execution of an ending step, beyond which no subsequent step is defined, execution of the subguideline is finished, leading to the return of the control of the task scheduling back to the upper level guideline. This process is recorded as a collapsing step chaining in the trace records. The execution process for the specific clinical tasks and scheduling tasks in the GLIF3 guideline representation model is summarized in Table F.

TABLE F

| Task | Execution Process |
|---|---|
| action step | register events; process specific actions (clinical |
| | action notification, data retrieval, data |
| | assignment); schedule next step |
| decision step | register events; select option through evaluation |
| | of decision criteria or by user decision; schedule |
| | next step |
| patient state step | present patient status; schedule next step |
| branch step | schedule multiple subsequent steps |
| synchronization step | evaluate continuation criterion; schedule next step |
| subguideline | enter into subguideline through expanding step |
| | chaining; return to upper level guideline through |
| | collapsing step chaining |

Access to patient data is a critical task in guideline execution. A standard data-encoding system, plus a generic patient data model for patient data, will enable the references to patient data in an encoded guideline, such as in a specification of decision criteria, without the need to know the implementation details. In recent years, several controlled medical terminologies, such as SNOMED and READ, have been developed as standards for patient data encoding. The particular standard definition of patient data at a local institution may be mapped to an implementation-specific data schema for access to the local electronic medical records. During guideline execution, patient data access may be accomplished through a standard interface to the clinical data repository 206 at a local institution, with the identification of the terminology, the concept in the terminology that is used to represent the data, the patient data model, and the specific data-model class as the parameters in the communication. Accordingly, using these parameters and the mapping between this definition of patient data and the schema of the clinical data repository at a local institution, the patient data used by GLEE can then be retrieved from the local clinical data repository.

Registration of clinical events and notification of clinical actions in GLEE are implemented using a similar approach to patient data retrieval. Specifically, clinical events may be encoded using a specific controlled medical terminology. Registration of clinical events may be accomplished through a standard interface between the GLEE server and the clinical event monitor, with the identification of the terminology and the concept in that terminology corresponding to the event as parameters in the communication. Representation of a clinical action also uses a specific controlled medical terminology and a particular data model. Notification of clinical actions may be accomplished through a standard interface between GLEE server and the electronic medical records at a local institution, with the identification of the terminology, the concept in that terminology that corresponds to the clinical action, the data model, and the data-model class as the parameters in the communication.

An expression language is an important component of a guideline representation model. In GLIF3, the expression language is used to encode decision criteria and patient states. As an expression language is closely related to the data model that presupposes how the variables in the expression can be referenced, standardization of expression language partially relies on the standardization of patient data model. GLEE may be adopted to accept the GEL expression language, or any other suitable expression language. An execution language parser may generally be implemented as a separate package in GLEE, so that the parser can be replaced by, or complemented with, parsers for other expression languages.

The scheduling constraint specification language may be used in GLIF3 to encode the continuation criterion for a synchronization step. As this language is used only for specification of coordination among particular steps during guideline execution, its syntax is relatively simple when compared to the expression language that is used to encode criteria for medical decision making. Specifically, names of particular guideline steps may be used as identifiers in the continuation criterion, to represent the requirement on the completion of a synchronization step. These name identifiers can be combined together, using logical operators. In addition, a special expression is provided to represent the case when completion of a specific number of preceding steps is required for the continuation of a synchronization step.

In one embodiment, GLEE can be used to execute a guideline encoded in the GLIF3 format. For example, in a guideline for the DTP series of the childhood immunization guideline published by CDC, 4 doses of the DTP vaccine are recommended to children. Specifically, dose 1 of the DTP vaccine is recommended for children who are at least 6 weeks old; dose 2 is recommended for children who have been given the 1st dose for at least 6 weeks; dose 3 is recommended for children who have been given the 2nd dose for at least 6 weeks; and dose 4 is recommended for children who are at least 12 months old and have been given the 3rd dose for at least 6 months.

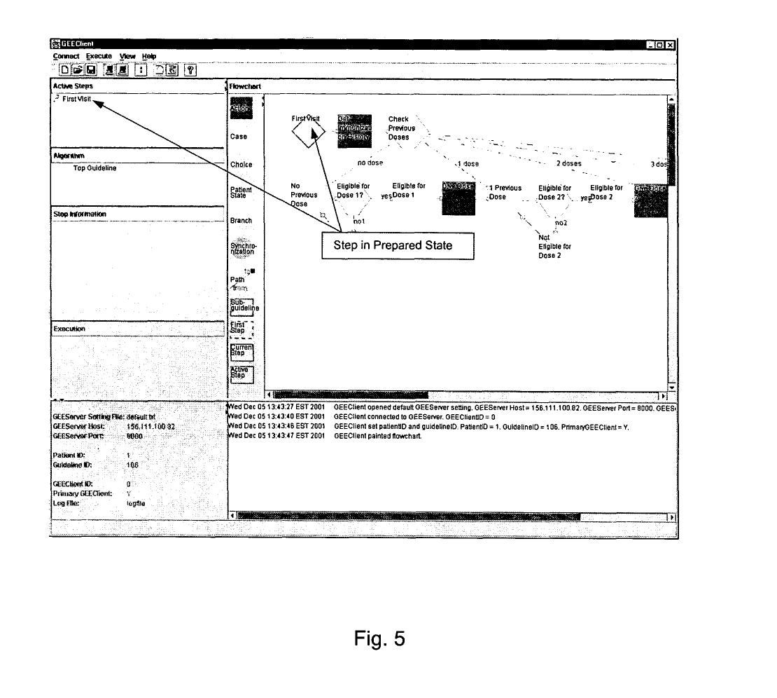

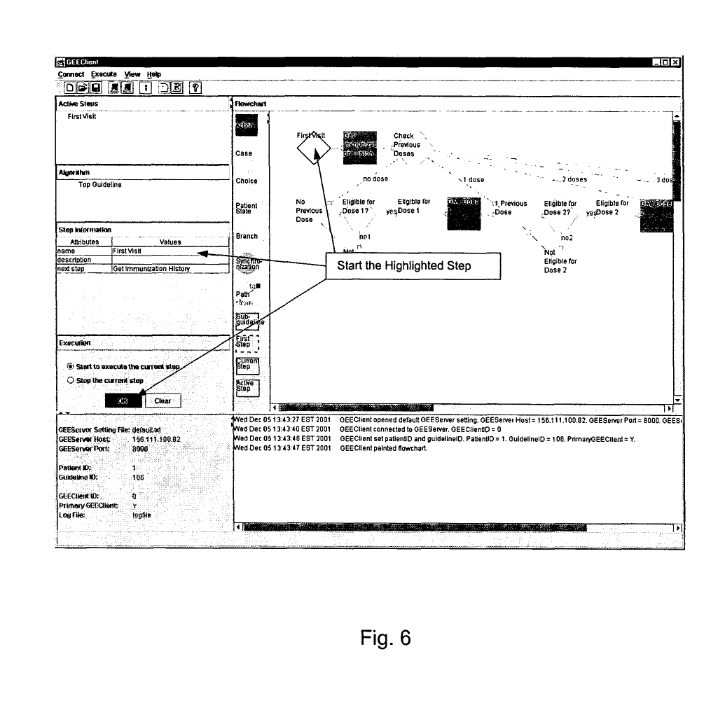

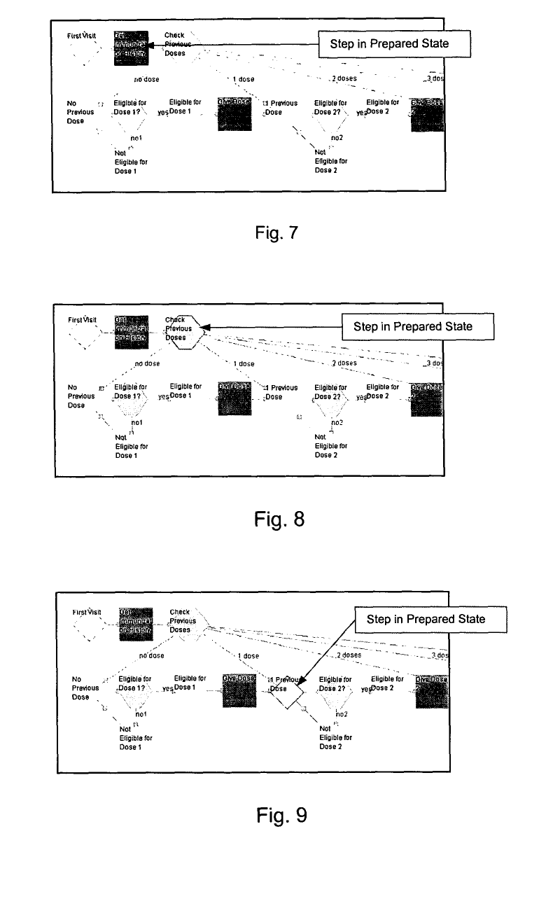

In a hypothetical patient case, a patient was born on May 23, 2001, and received the 1st dose of the DTP vaccine on Jul. 27, 2001, and the 2nd dose of the DTP vaccine on Sep. 28, 2001. However, only the dose given on Jul. 27, 2001 was recorded in the clinical data repository. Referring to FIG. 5, the standalone user interface may be used to apply the guideline to the patient. On Dec. 5, 2001, the GLEE system may be invoked to apply the DTP immunization guideline to the patient for the first time during a visit by the patient. As no execution trace was recorded before this visit, GLEE may start the execution from the first step of the guideline. Thus, the First Visit patient state step may be put into the prepared state, and scheduled to execute. The recommendation of the First Visit patient state step may be accepted, which means the user may select actually to start the First Visit patient state, as shown in FIG. 6. This, in turn, may lead to the scheduling of the Get Immunization History action step to be executable, as shown in FIG. 7.

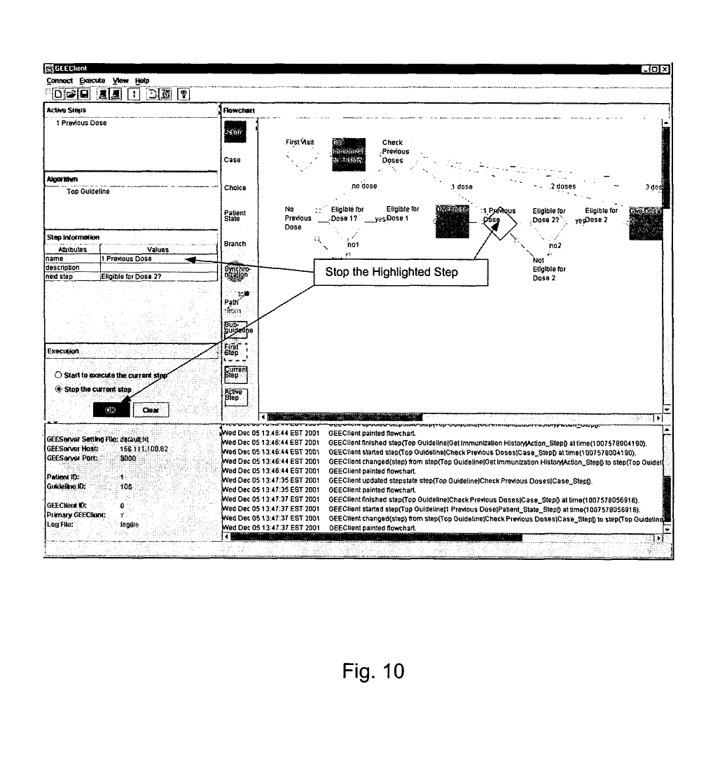

Once the immunization history is retrieved from the clinical data repository, the Check Previous Doses decision step may be scheduled, as shown in FIG. 8. As there was only one DTP vaccine dose recorded in the clinical data repository, GLEE may conclude that the patient was in the state 1 Previous Dose, as shown in FIG. 9. As the patient had actually received 2 doses of the DTP vaccine, the recommendation generated by the system, which may be based solely on the data in the clinical data repository at that moment, may be denied by the clinicians, which means the user may select to stop the 1 Previous Dose patient state step, as shown in FIG. 10.

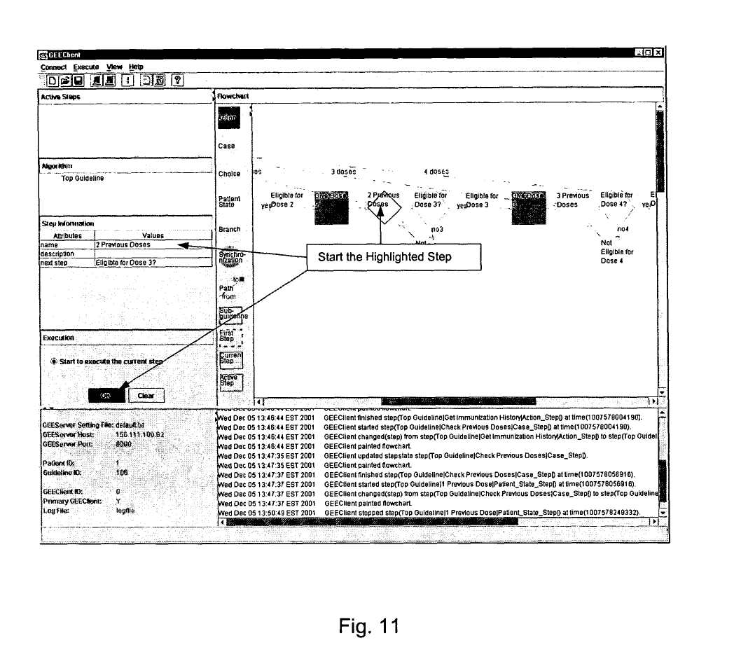

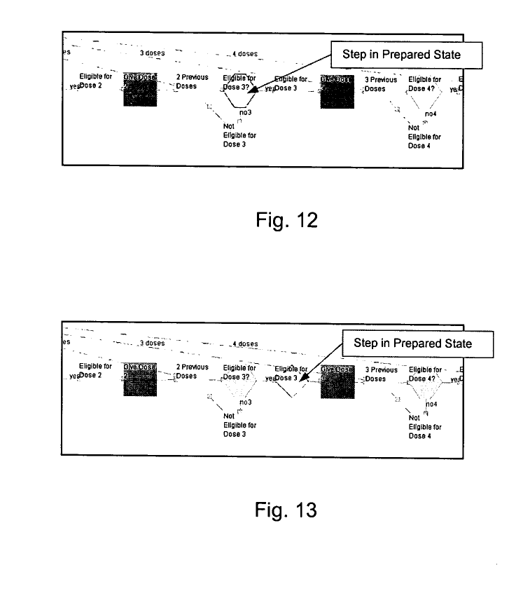

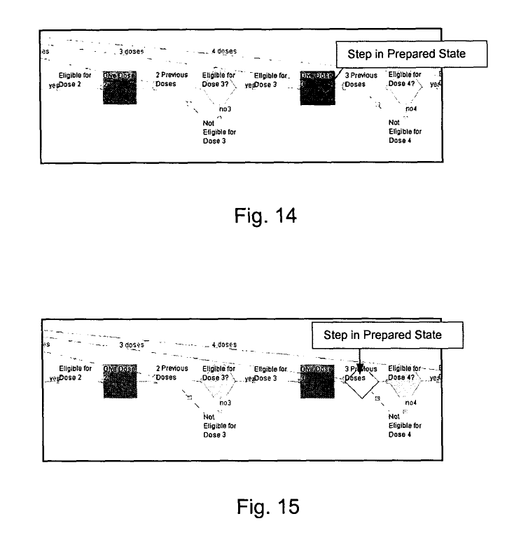

The dose given on Sep. 28, 2001 may be entered into the clinical data repository, and the guideline started again from the 2 Previous Doses patient state step, as shown in FIG. 11. The Eligible for Dose 3? decision step may then be scheduled and executed, as shown in FIG. 12, which may lead to a conclusion that the patient was eligible for dose 3, as shown in FIG. 13. Consequently, the Give Dose 3 action step may be scheduled and executed, as shown in FIG. 14, and a DTP dose given to the patient on that day. The patient state may then enter into the 3 Previous Doses state, as shown in FIG. 15, and the application of the guideline may be stopped at that step for the visit on Dec. 5, 2001.

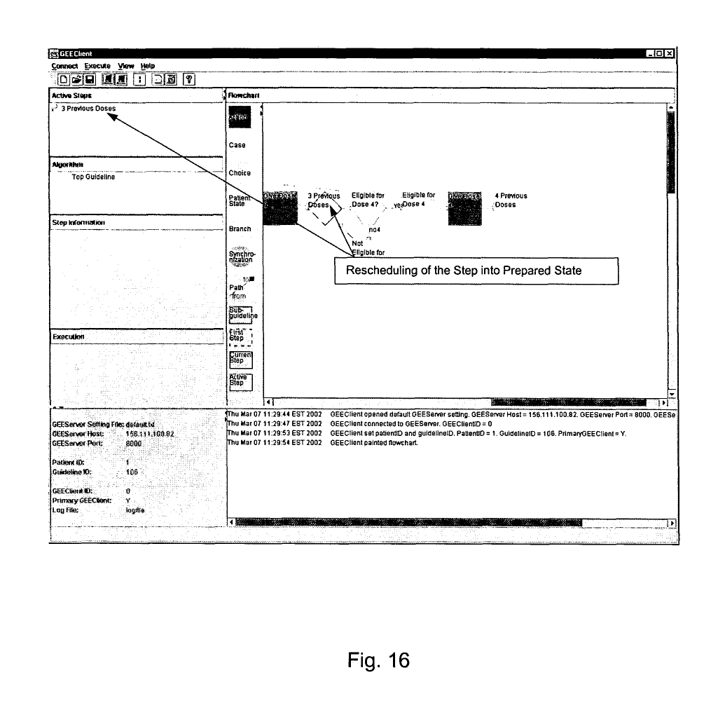

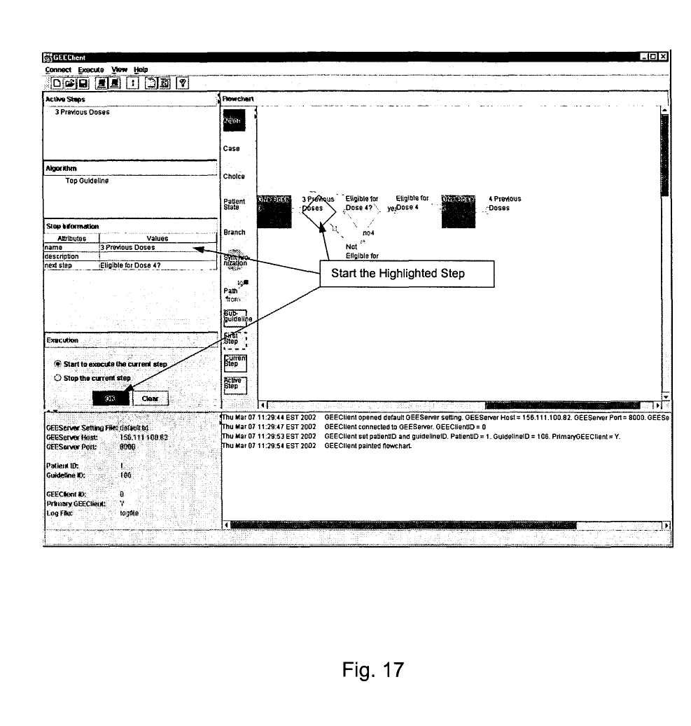

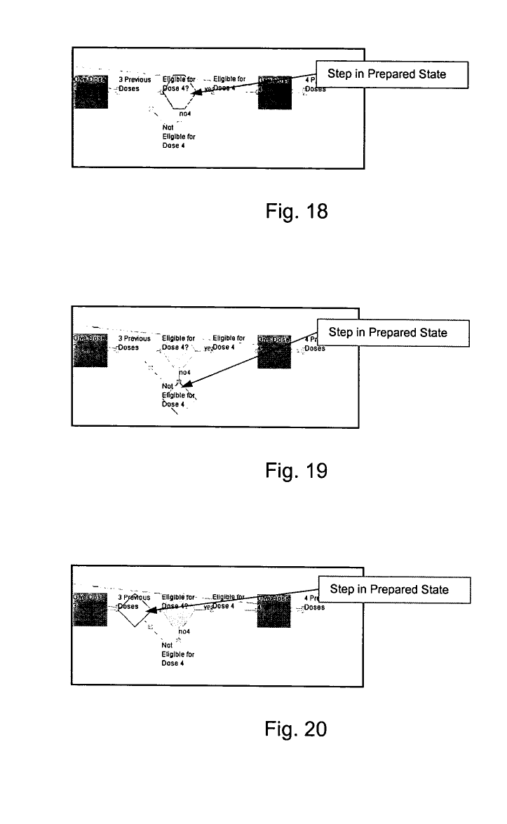

On Mar. 7, 2002, the DTP immunization guideline may be invoked again when the patient makes another visit. This time, GLEE may first retrieve the execution trace. Based on the application of the DTP immunization guideline to the same patient in the previous invocation, the execution may start from the 3 Previous Doses patient state step, which was scheduled last time but was not actually executed, as shown in FIG. 16. This task schedule may be confirmed by the clinician, as shown in FIG. 17. After execution of the step, the Eligible for Dose 4? decision step may be scheduled, as shown in FIG. 18. If based on the decision criterion, the patient may not be eligible for dose 4 at that moment, and, thus, may be put into the Not Eligible for Dose 4 patient state, as shown in FIG. 19. As the last step scheduled during this visit, the patient state may be reset to the 3 Previous Doses patient state step, as shown in FIG. 20.

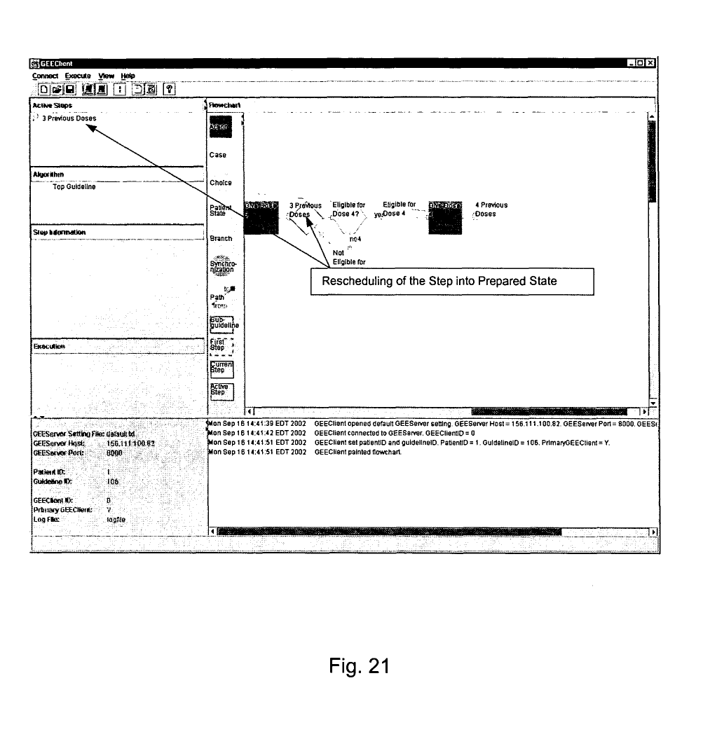

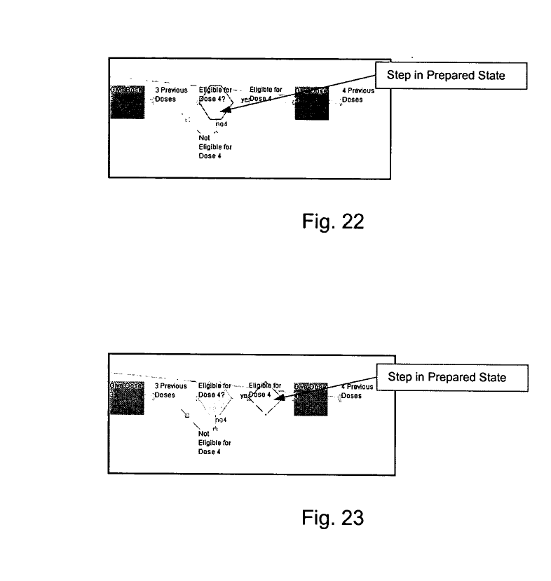

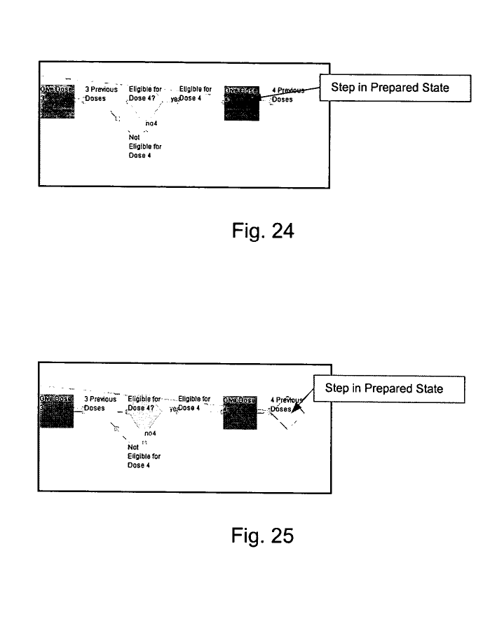

On Sep. 16, 2002, the DTP immunization guideline may be invoked for the 3rd time, when the patient makes another visit. Again, GLEE may retrieve the execution trace. Based on the application of the DTP immunization guideline to the same patient in the previous invocation, the execution may start from the 3 Previous Doses patient state step, which was scheduled at the last visit but had not been actually executed, as shown in FIG. 21. This task schedule may be confirmed by the clinician, and the subsequent Eligible for Dose 4? decision step may be scheduled, as shown in FIG. 22. According to decision criterion, the patient may be eligible for dose 4 at this time, and, thus, put into the Eligible for Dose 4 patient state, as shown in FIG. 23. The Give Dose 4 action step may then be scheduled as the subsequent executable step, as shown in FIG. 24, and the 4th DTP dose may be given to the patient, leading to the change of the patient state to 4 Previous Doses, as shown in FIG. 25. The application of the DTP guideline to the patient may then be finished at that point.

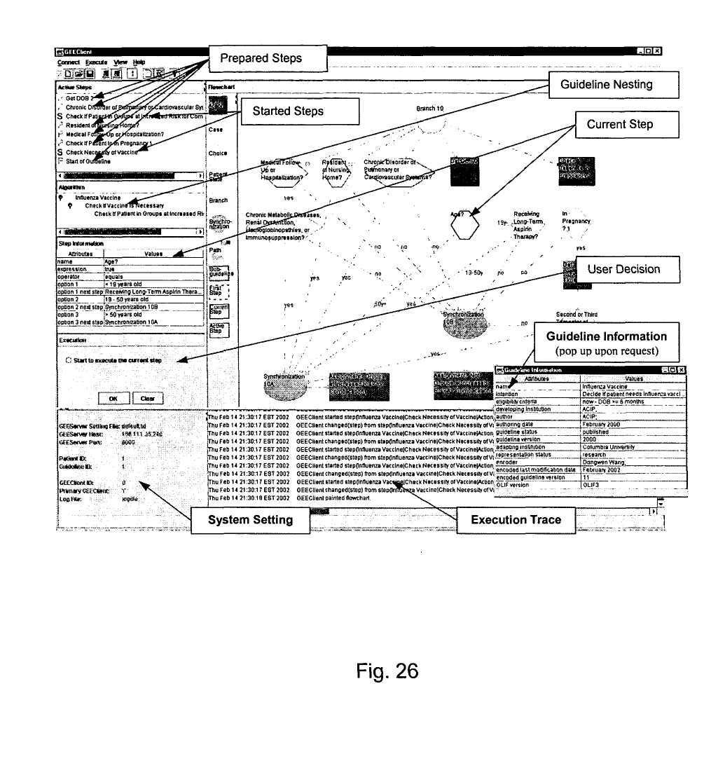

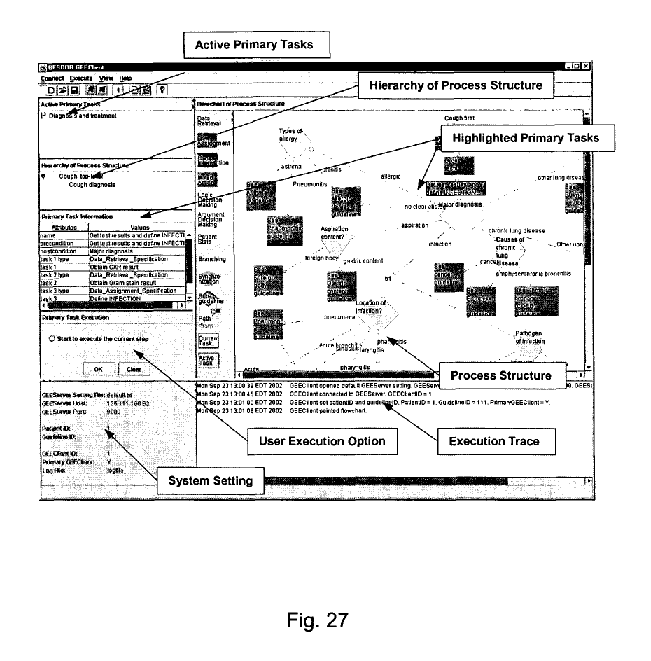

A guideline may include a plurality of hierarchically arranged subtasks, and a number of steps in the guideline may be executed, as shown in FIG. 26 and FIG. 27. The standalone user interface may present the process structure of a practice guideline, as well as the active steps at a specific moment when that guideline is being applied to a patient. It can also be used to check the detailed information regarding a guideline. A user can interact with GLEE using this client-side standalone user interface, to decide whether to start, continue, or stop the execution of a specific guideline step, and can also find the documentation about the guideline, such as the references to the original published guideline and maintenance information about the encoding of the guideline.

Although the foregoing example discusses, in connection with GLEE's standalone user interface, users' selection and acceptance of each guideline step for execution, integrating GLEE with a clinical information system or event monitor allows a number of the steps, such as the acceptance of the system's recommendations steps, to be selected automatically. Thus, clinician users may not need to interact with the guideline implementation system for each task; instead, the interaction may be limited to specific circumstances, e.g., when a drug-drug interaction may happen, and an alert is generated.

### GETO

In one aspect of the present invention, a generalized representation model is provided that is based on the observed commonalities between particular guideline models, including those described herein. The common tasks, or generalized guideline execution tasks, extracted from the specific guideline representation models may be used to support a generalized representation model, for use, e.g., by a general or generic guideline execution system. For instance, the consistent structure between the practice models may be used to define the generalized guideline execution tasks in a generic guideline representation model or guideline execution task ontology (“GETO”), in accordance with the present invention. Accordingly, a generalized guideline execution task comprises: (1) a set of input elements; (2) a set of output elements; (3) a set of subtasks embedded within a task; and (4) a set of execution constraints.

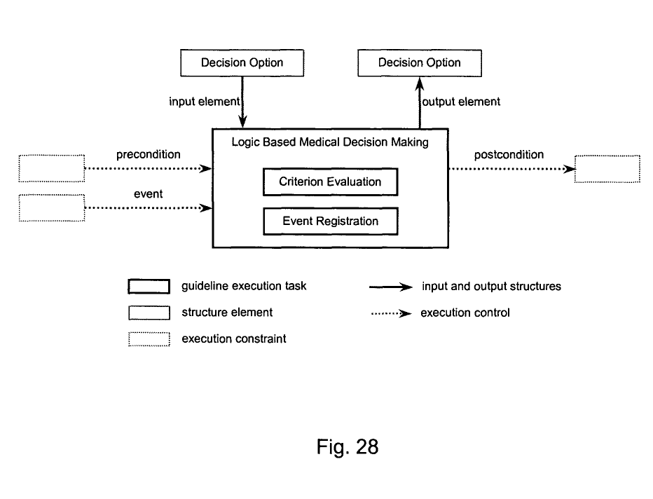

The input elements and the output elements describe the static structure of a generalized guideline execution task. The input elements of a generalized guideline execution task define the participants for that task, and constitute the context in which that guideline execution task can be applied. The output elements of a generalized guideline execution task define the execution effects of that task. These output elements constitute the execution results of a guideline execution task. For example, referring to FIG. 28, in the logic-based medical-decision-making task, the input elements may be a set of decision options, which specify the possible options that participate in the decision-making process, while the output elements may be a subset of the input decision options that specify the selection result. In the execution of a particular guideline, a task is instantiated, with specific values as its input elements and output elements. For example, in an instance of the logic-based medical-decision-making task to examine a patient's management status for a DTP immunization guideline, the input element is a set of decision options, each of which corresponds to a possible management status of a patient in that context, including Patient without Previous Dose of the DTP Vaccine, Patient with 1 Previous Dose of the DTP Vaccine, Patient with 2 Previous Doses of the DTP Vaccine, Patient with 3 Previous Doses of the DTP Vaccine, and Patient with 4 Previous Doses of the DTP Vaccine. If, after the execution of this task, the patient is determined to be in the Patient with 2 Previous Doses of the DTP Vaccine status, the decision option corresponding to that status will be selected as the output element.

The subtasks define the relationships between the current guideline execution task and other tasks. The subtasks of a generalized guideline execution task specify the internal guideline execution tasks that are embedded within the current task. The subtasks define the structural relationships between the current guideline execution task and other tasks. With reference to FIG. 28, in a logic-based medical-decision-making task, two subtasks (criterion evaluation and event registration, for instance) may be defined to describe the internal process of that decision-making process. When executing the instance of the logic-based medical-decision-making task that is used to examine a patient's management status during the application of the DTP immunization guideline, for example, the event registration task may be performed first, followed by the criterion evaluation task. The decision criterion for each of the input decision options may then be evaluated, leading to selection of the decision option, within which the decision criterion can be satisfied, as the output element.

If a guideline execution task comprises other tasks, the execution task should be decomposed until each of its subtasks becomes an atomic task that can be performed directly. For subtasks that are primary tasks of a guideline, the execution order of these subtasks is defined by the execution constraints of the subtasks. For subtasks that are auxiliary tasks, the execution order of these subtasks is defined for implementation by a generic guideline execution engine. Once a guideline execution task is decomposed to atomic tasks, the atomic tasks can be performed directly, as their executions are computation tasks that are solely based on the definition of the input and output elements.

The execution constraints generally provide the dynamic associations among the primary guideline execution tasks during guideline application. The execution constraints are used to define the process relations among primary guideline execution tasks, which can be classified into preconditions, postconditions, and events. Preconditions are used to define the conditions that should be satisfied before a primary task can be scheduled for execution. Postconditions are used to define the conditions that must be held after completion of a primary task. Events are used to define the triggers for the execution of a primary task. The execution constraints specify how primary tasks can be chained together during a guideline execution process. Execution constraints are usually embedded within the specifications of the representation elements that are used to define certain guideline execution tasks. When creating the semantic links between the particular guideline representation model and the GETO, specifications of these representation elements should be classified into the structural specifications that define the static structure of the element, and the constraint specifications that define the dynamic associations among guideline tasks. The structural and constraint specifications may then be mapped separately to the structure elements and the execution constraints of specific guideline execution tasks in the GETO.

If a guideline execution task is supported in a particular guideline representation model, the structural elements of that task will have been defined in that model as certain representation elements, even though the guideline execution tasks may have only been assumed implicitly. To create semantic links between the elements in a specific guideline representation model and the generalized guideline execution tasks in the GETO, the structural elements in the guideline representation model should be mapped to the input elements and output elements of corresponding generalized guideline execution tasks in the GETO.

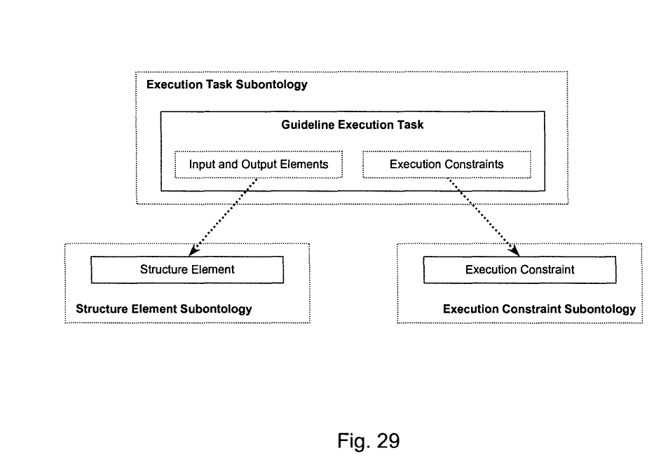

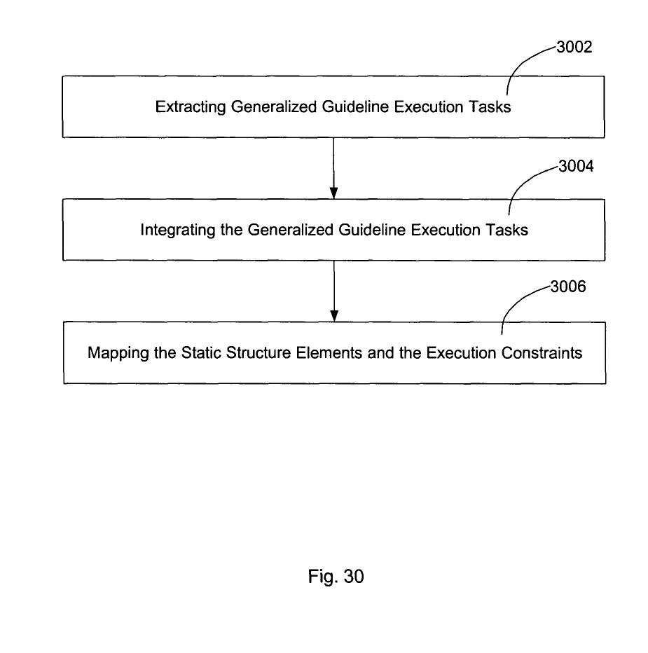

The core components of the GETO are the generalized guideline execution tasks. However, since generalized execution tasks contain other components, such as those used for the representation of the structure elements of an execution task and the execution constraints among different tasks, the GETO may be structured as three subontologies: the execution task subontology, the structure element subontology, and the execution constraint subontology. Entities in the execution task subontology, which are the generalized guideline execution tasks, make reference to the entities in the structure element subontology and the entities in the execution constraint subontology, which are separately the static structural elements of a guideline execution task and the preconditions, postconditions, and triggering events of a primary guideline execution task. The relationship among the guideline execution tasks, the structure elements, and the execution constraints, according to one embodiment of the present invention, is shown in FIG. 29.

To create semantic links between a representation element in a specific guideline representation model and a particular guideline execution task in the GETO, the mapping relationship between specific components of that representation element, and the structure elements of the guideline execution task, must be established. In addition, the mapping relationship between the components of that representation element that are used for task scheduling purposes, and the execution constraints of the guideline execution task, should also be specified. By creating these links between the representation elements of a guideline representation model and specific guideline execution tasks in the GETO, the structure elements and the execution constraints of a generalized guideline execution task can be regenerated for a generic guideline execution engine; thus, the generalized guideline execution task can be used to drive the execution of guidelines that are encoded in different formats.

Generalized guideline execution tasks can be obtained by analyzing the existing guideline representation models; however, in order to provide generalized guideline execution tasks in a computer-interpretable format, it is necessary to ascertain how the elements corresponding to the generic guideline execution tasks are structured in their original representation. The following steps may be used to extract the guideline execution tasks from a specific guideline representation model, and to integrate them as generalized guideline execution tasks into the GETO:

(1) Abstract the process structure and the primary tasks of the guideline representation model, preferably first. This includes analysis of the representation elements that are used to represent the process structure and the primary tasks in the original guideline representation model, as well as the relationships among these elements. In most cases, the primary tasks are abstracted directly from a specific guideline representation model, as they are.

(2) Specify the auxiliary tasks embedded within the primary tasks. In most cases, the auxiliary tasks are the common computation tasks across different guideline representation models.

(3) Extract the structural elements that are used to represent the participants of specific guideline execution tasks, including the structure elements that are direct participants of these tasks, and those elements that are referenced by these direct participating structural elements. In many cases, the structure elements are common across different guideline representation models.

(4) Define the execution constraints corresponding to the representation elements in the original guideline representation model that are used to represent task scheduling. While the participating structural elements of a guideline execution task, and the elements that are used to specify task scheduling, may be mixed together in the original guideline representation model, they need to be separated when they are defined in the GETO.

The following principles may be used to integrate the generalized guideline execution tasks, extracted from different guideline representation models, into the GETO:

(1) Represent the generalized guideline execution tasks as specific classes, arranged in a hierarchy to form the execution task subontology. Definition of these classes can start from the process structure and the primary guideline execution tasks. The auxiliary tasks may then be included to fill up the subtask definitions of the primary tasks. Slots that are used to define the participating structure elements and the execution constraints may then be preset. The definition of the slots may be completed after the specification of the participating structure elements and the execution constraints, as described below in (2) and (3).

(2) Represent the structure elements as specific classes, arranged in a hierarchy to form the structure element subontology. Definitions of these classes can start from those that are used to represent the guideline, the process structure, and the primary tasks. Other structure elements that are referenced by these basic structure elements may then be defined, and slots for the structure elements may be specified to define the references to other classes in the structure element subontology.

(3) Represent the execution constraints as specific classes. These classes correspond to the process structure and the primary tasks. Each of the execution constraint classes contains at least one slot that is used to specify the constraints. These classes may then be arranged as a hierarchy, with a structure similar to that of execution tasks that are used to represent the process structure and the primary tasks in the execution task subontology.

(4) Definition of the classes and the slots in the GETO can be started from a specific guideline representation model by creating corresponding classes and slots for the representation elements or primitives in that model. The classes and slots that correspond to the representation elements of other guideline representation models can then be included, step by step. If a class, with its specific knowledge roles, has already been defined in an existing class of the GETO, a new class will not need to be included. Otherwise, the class should be included as a new class in the GETO. This could be the case when the newly included class is a completely new class, such that its slots have not been defined in any of the existing classes in the GETO, or the case when only part of the slots of the newly included class have been defined in the existing classes. This newly included class is then arranged in an appropriate position in the class hierarchy of the GETO. In the event that the definition of the newly included class has partial semantic overlap with other classes, the definition may be kept as it is, if this class is used to represent the structure element of a primary task, so as to facilitate task scheduling and to simplify the mapping from a specific guideline representation model to the GETO. Additionally, the class may be split into multiple classes if the newly included class is not used to represent the structure element of a primary task, with each class created by the split becoming either an existing class or a completely new class, to pursue maximum reuse of the existing classes. GETO is a mixture of aggregation and integration of the execution tasks from different guideline representation models. The classes in the GETO with partial overlap in their semantic definitions may also be analyzed and restructured so that the GETO will consist only of classes without any overlap in their semantic definitions.

To construct the GETO, the generalized guideline execution tasks extracted from the GLIF3 guideline representation model, for example, and the classes that are used to represent the process structure and the primary tasks, are identified. The process structure and primary task classes in the GLIF3 model include the algorithm class; the guideline step class and its subclasses, such as the action step class; the decision step class; the case step class; the choice step class; the patient state step class; the branch step class; and the synchronization step class. Accordingly, the execution tasks in the GETO that correspond to these GLIF3 classes include the guideline primary task scheduling class; the primary task execution class and its subclasses, such as the branching execution class; the synchronization execution class; the subguideline execution class; the mixed clinical action execution class; the logic-based medical-decision-making execution class; the argument-based medical-decision-making execution class; and the patient state verification execution class. Here, the subguideline task is represented by several classes in the GLIF3 model, such as the action step class, the case step class, and the choice step class, with specific restrictions on their uses for this purpose, e.g., they are encoded as a subguideline action instance in the task slot of an action step, or as a guideline instance in the decision detail slot of a decision step. However, these implicitly represented tasks have common semantics when they are used in these different cases. Thus, a single subguideline execution class may be used to represent this task in the GETO. For each of these guideline execution task classes, the slots that are used to represent the participating structure elements, the subtasks, and the execution constraints may then be defined.

The classes that are used to represent the auxiliary tasks may then be specified, and encoded as the subtasks to support the execution of the primary tasks, including the criterion or scheduling constraint evaluation class, the synchronization continuation criterion evaluation class, the event registration class, the event triggering class, the data retrieval reflection class, the data assignment reflection class, and the clinical intervention reflection class. The classes for the structure element subontology, based on their references by the guideline execution tasks, may then be defined. These definitions include specification of the guideline class, the process structure class, the primary task definition class and its subclasses, the clinical action specification class and its subclasses, the data definition class and its subclasses, the decision option class and its subclasses, the expression class and its subclasses, the event definition class, the didactic material list class, the didactic material class and its subclasses, the maintenance information class, and the synchronization continuation criterion class. Finally, the classes for the execution constraint subontology may be defined. For this purpose, the classes representing the execution constraints for each of the primary tasks, including their preconditions, postconditions, and triggering events, may be specified. These classes in the execution task subontology, the structure element subontology, and the execution constraint subontology constitute the overall structure of the GETO.

Additional guideline execution tasks may be extracted from the other guideline representation models, including the PROforma model, which is similar to the GLIF3 model. By way of example, the classes that are used to represent the process structure and the primary tasks in the PROforma model include the guideline class, the plan class, the task class, the component class, the plan component class, the enquiry class, the enquiry component class, the action class, the action component class, the decision class, and the decision component class.

In addition to the guideline execution tasks that may be extracted from the GLIF3 model, or from the PROforma model, several new tasks may be integrated into the GETO, including the data retrieval execution class and the clinical intervention execution class. The slots for each of these newly included classes may be specified, and their participating structure elements, subtasks, and execution constraints may be defined. Accordingly, the structure element classes and the execution constraint classes that are related to the data retrieval task and the clinical intervention task may then be added into the GETO. Finally, the classes that are used to represent the execution constraints on the completion and the abortion of a process structure, such as the guideline primary task scheduling constraint end class and the guideline primary task scheduling event constraint abort class, may also be included in the GETO.

As noted above, there are many guideline execution tasks that are common across different guideline representation models. Consequently, GLIF3 and PROforma share part of their primary tasks, such as the subguideline task and the argument-based medical-decision-making task. Thus, these tasks can be used to drive the execution of guidelines that are encoded in either the GLIF3 format or the PROforma format. The guideline execution tasks that are encoded implicitly within the enquiry class and the action class of the PROforma model have semantic overlap with the guideline execution tasks that are encoded implicitly within the action step class of the GLIF3 model. Accordingly, several different guideline execution tasks, corresponding to each of these cases, may be defined, even though they have partial semantic overlap. The participating structure elements and the execution constraints for these execution tasks may be handled in a similar manner. Finally, GETO classes that correspond to elements of the PROforma model with unique features, such as those that are used to define the completion and the abortion criterion of a process structure, may be specified to support execution of the guidelines that are encoded in the PROforma format.

When arranging the GETO classes to formulate the GETO structure, additional classes may be inserted at specific positions of the class hierarchy. These classes may be used to: (1) generalize the extracted guideline execution tasks, as well as their participating structure elements and execution constraints; and (2) create intermediate classes in the GETO class hierarchy, to clarify the conceptualization of the generalized guideline execution tasks, the participating structure elements, and the execution constraints. For example, definition of the patient state verification event constraint precondition class may be a generalization of the event constraints that were previously defined for other types of primary tasks, even though, at that moment, this class had no corresponding classes in either the GLIF3 model or the PROforma model; definition of the clinical task execution class, on the other hand, may be used solely for clarification of the conceptualization. These classes, which may be inserted as intermediate classes for the purpose of clarifying conceptualization, may be defined as abstract classes. The GETO classes, and the corresponding GLIF3 classes and PROforma classes from which these GETO classes may be extracted and integrated, are summarized in Tables G-I. Table G lists classes in the execution task subontology of the GETO, and the corresponding classes in GLIF3 and PROforma from which these GETO classes may be extracted. Table H lists the classes in the structure element subontology of the GETO, and the corresponding classes in GLIF3 and PROforma from which these GETO classes may be extracted. Table I lists the classes in the execution constraint subontology that may be included in the GETO, and the corresponding classes in GLIF3 and PROforma from which these GETO classes may be extracted.

TABLE G

| GETO Class | GLIF3 Class | PROforma Class |
|---|---|---|
| guideline execution task | | |
| guideline primary task | algorithm | guideline, plan |
| scheduling | | |
| primary task execution | guideline step | task, component |
| scheduling task execution | | |
| branching execution | branch step | |
| synchronization execution | synchronization step | |
| subguideline execution | action step, choice | plan, plan |
| | step, case step, | component |
| | decision step | |
| clinical task execution | | |
| clinical action execution | | |
| data collection execution | | |
| data retrieval execution | | enquiry, enquiry |
| | | component |
| data assignment execution | | |
| clinical intervention | | action, action |
| execution | | component |
| mixed clinical action | action step | |
| execution | | |
| medical decision making | decision step | |
| execution | | |
| logic based medical | case step | |
| decision making execution | | |
| argument based medical | choice step | decision, decision |
| decision making execution | | component |
| patient state verification | patient state | |
| execution | step | |
| auxiliary task execution | | |
| criterion or | | |
| scheduling constraint | | |
| evaluation | | |
| synchronization continuation | | |
| criterion evaluation | | |
| event registration | | |
| event triggering | | |
| clinical action reflection | | |
| data collection reflection | | |
| data retrieval reflection | | |
| data assignment reflection | | |
| clinical intervention | | |
| reflection | | |

TABLE H

| GETO Class | GLIF3 Class | PROforma Class |
|---|---|---|
| guideline structure | | |
| guideline | guideline | guideline |
| process structure | algorithm | guideline, plan |
| primary task definition | guideline step | task, component |
| scheduling taskdefinition | | |
| branching | branch step | |
| synchronization | synchronization | |
| | step | |
| subguideline | action step, | plan, plan |
| | choice step, | component |
| | case step, | |
| | decision step | |
| clinical task definition | | |
| clinical action | | |
| data collection | | |
| data retrieval | | enquiry, enquiry |
| | | component |
| data assignment | | |
| clinical intervention | | action, action |
| | | component |
| mixed clinical action | action step | |
| medical decision making | decision step | |
| logic based medical | case step | |
| decision making | | |
| argument based medical | choice step | decision, decision |
| decision making | | component |
| patient state verification | patient state step | |
| clinical action specification | action specification | |
| data collection specification | | |
| data retrieval specification | get data action | source |
| data assignment specification | assignment action | |
| clinical intervention | medically oriented | action |
| specification | action specification | description |
| data definition | data item | data |
| literal data definition | literal data item | action |
| | | description |
| variable data definition | variable data item | data |
| decision option | decision option | |
| logic based decision option | decision option | |
| argument based decision | decision option | candidate |
| option | | |
| expression | guideline expression | |
| criterion | criterion, three | proforma |
| | valued criterion | condition |
| didactic material list | supplemental | |
| | material list | |
| didactic material | supplemental material | |
| HTML didactic material | material URL | |
| text didactic material | text material | |
| maintenance information | maintenance info | guideline |
| event definition | event | proforma |
| | | functor term |
| synchronization | logical expression | |
| continuation criterion | of guideline step | |

TABLE I

| | | PROforma |
|---|---|---|
| GETO Class | GLIF3 Class | Class |
| constraint | | |
| scheduling constraint | | |
| guideline primary task | | |
| scheduling scheduling | | |
| constraint | | |
| guideline primary task | algorithm | |
| scheduling scheduling | | |
| constraint start | | |
| guideline primary task | | plan |
| scheduling scheduling | | |
| constraint end | | |
| primary task scheduling | | |
| constraint | | |
| scheduling task scheduling | | |
| constraint | | |
| branching scheduling constraint | branch step | |
| precondition | | |
| branching scheduling constraint | branch step | |
| postcondition | | |
| synchronization scheduling | synchronization step | |
| constraint precondition | | |
| synchronization scheduling | synchronization step | |
| constraint postcondition | | |
| subguideline scheduling | action step, choice step, | plan |
| constraint precondition | case step, decision step | component |
| subguideline scheduling | action step, choice step, | plan |
| constraint | case step, decision step | component |
| clinical task scheduling | | |
| constraint | | |
| clinical action scheduling | | |
| constraint | | |
| data collection scheduling | | |
| constraint | | |
| data retrieval scheduling | | enquiry |
| constraint precondition | | component |
| data retrieval scheduling | | enquiry |
| constraint postcondition | | component |
| data assignment scheduling | | |
| constraint precondition | | |
| data assignment scheduling | | |
| constraint postcondition | | |
| clinical intervention scheduling | | action |
| | | component |
| constraint precondition | | |
| clinical intervention scheduling | | action |
| constraint postcondition | | component |
| mixed clinical action scheduling | action step | |
| constraint precondition | | |
| mixed clinical action scheduling | action step | |
| constraint postcondition | | |
| medical decision making | | |
| scheduling constraint | | |
| logic based medical decision | case step | |
| making scheduling constraint | | |
| precondition | | |
| logic based medical decision | case step | |
| making scheduling constraint | | |
| postcondition | | |
| argument based medical | choice step | decision |
| decision making | | component |
| scheduling constraint | | |
| precondition | | |
| argument based medical | choice step | decision |
| decision making | | component |
| scheduling constraint | | |
| postcondition | | |
| patient state verification | patient state step | |
| scheduling constraint | | |
| precondition | | |
| patient state verification | patient state step | |
| scheduling constraint | | |
| postcondition | | |
| event constraint | | |
| guideline primary task | | |
| scheduling event constraint | | |
| guideline primary task | | plan |
| scheduling event constraint | | |
| abort | | |
| primary task event constraint | | |
| scheduling task event constraint | | |
| branching event constraint | | |
| precondition | | |
| synchronization event constraint | | |
| precondition | | |

Although the GETO is described herein in relation to the GLIF3 and Proforma models, it is understood that other guideline representation models, including evolved models of existing formats, may be extracted and integrated into the GETO according to the guiding principles disclosed herein, and, therefore, are not limited thereto. The following principles may be used to maintain the GETO, in order to accommodate additional and evolved guideline models:

(1) task permanence—the classes in the GETO representing the guideline execution tasks, the structure elements, and the execution constraints may be kept permanent, so that backward compatibility may be accomplished when GETO is used to drive guideline execution;

(2) maximum reuse of existing tasks —the inclusion of a new guideline execution task should first consider the reuse of existing tasks, so that redundancy in the GETO can be minimized; and

(3) permission of partial semantic overlap—the primary guideline execution tasks extracted from different guideline representation models may have partial common semantics, and these guideline execution tasks may be defined to facilitate the semantic mapping from a specific guideline representation model to the GETO.

Task permanence will enable the GETO to continue to support the execution of guidelines that are encoded in an older version of a guideline representation model (backward compatibility), which is an added benefit that may be used by the guideline execution engine using the GETO model. Maximum reuse of the existing guideline execution tasks will facilitate the extraction and integration of the generalized guideline execution tasks that are common across different guideline representation models. In the long term, this approach may lead to the development of a standard guideline representation model containing all of the features of the existing models.

Because the GETO is primarily used to create the semantic links between the representation elements in specific guideline representation models and the generalized guideline execution tasks in the GETO, so that these generalized guideline execution tasks can be used to drive the execution of guidelines encoded in different formats, successful creation of the mapping relationship between a specific guideline representation model and the GETO has become a critical step in this process. For this reason, partial semantic overlap, when specifying the primary guideline execution tasks to facilitate the development of the mapping relationship between a particular guideline representation model and the GETO, may be permitted. At the level of the primary task that constitutes the basic unit of a guideline model's process structure, the current GETO is, to a large extent, an aggregated guideline execution task ontology, instead of a truly integrated one.

### GETO MAPPING

As described herein, the elements in a specific guideline representation model may be mapped to their corresponding guideline execution tasks in the GETO, such that these mapping relations can be used by a generic guideline execution engine, including one for use in the GESDOR guideline execution model. The mapping relationship creates the semantic links between a specific guideline representation model and the GETO. The guideline representation models noted herein and the GETO are generally represented as ontologies. Thus, the mapping relationship between a specific guideline representation model and the GETO is a mapping between two ontologies. Mapping from a guideline representation model to the GETO will generally be asymmetric. In addition, it is a mapping between two models that is used to derive the mapping between instances, so that the participating structural elements and the execution constraints of specific guideline execution tasks can be regenerated to execute guidelines that are encoded in specific formats.

In contrast to the mapping between two symmetric ontologies, such as two different versions of a controlled medical terminology, the mapping between a specific guideline representation model and the GETO is asymmetric. Specifically, the mapping relationship between a particular guideline representation model and the GETO is used to regenerate certain guideline execution tasks, at the GETO side, from particular instances of the representation elements at the guideline representation model side. The guideline execution tasks can then be used to drive the execution of guidelines that are encoded in a specific format. Thus, the mapping is a one-direction mapping, starting from the guideline representation model side and ending at the GETO side. As the generalized guideline execution tasks in the GETO are extracted and integrated from multiple guideline representation models, it is possible that some elements in the GETO may not have corresponding elements in a specific guideline representation model.

The mapping between a specific guideline representation model and the GETO may be used as a set of rules in a generic guideline execution model, such as the GESDOR model, to regenerate the structure elements and the execution constraints of certain guideline execution tasks from the instances of the representation elements in the original guideline representation model. The primary concern in developing this mapping relationship is not only the creation of the semantic links between the two models, but also the translation of the instances from the guideline representation model side to the GETO side. This means that a consistent approach to the translation of these instances needs to be developed when creating the semantic mapping between a guideline model and the GETO.

Guideline elements, represented as specific classes in an ontology, are defined by their slots. Thus, mapping of the elements from two different guideline ontologies needs to handle two layers in the mapping, i.e., class mapping and slot mapping.

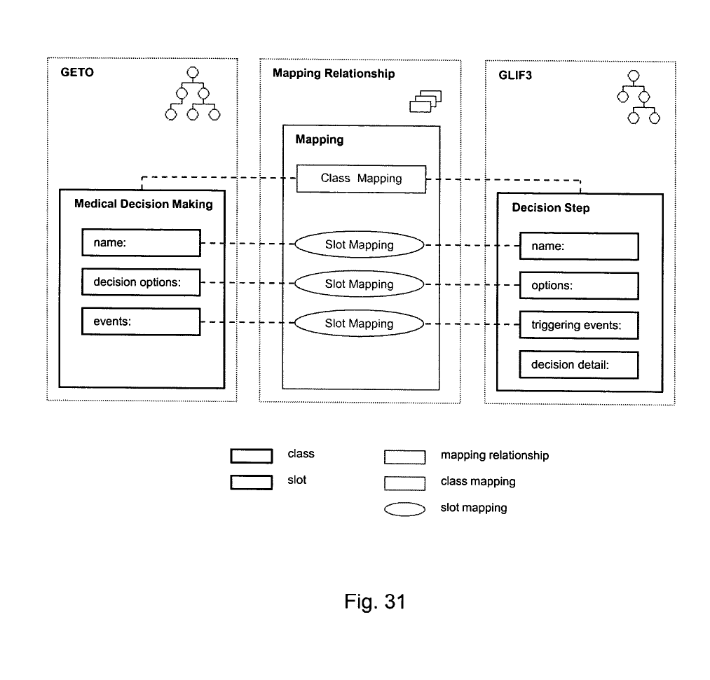

Class mapping defines the mapping relationship between corresponding elements in two or more ontologies, which creates an association between these elements at the class level, with all the slots defined within them. Slot mapping, on the other hand, defines the association between corresponding slots within the context of a specific class mapping. For example, the decision step class in the GLIF3 model can be mapped to the medical decision-making class in the GETO. Within this class mapping between decision step and medical decision making, several slot mappings have been defined. The name slot of the decision step class may be mapped to the name slot of the medical decision-making class, the options slot of the decision step class may be mapped to the decision options slot of the medical decision-making class, and the triggering events slot of the decision step class may be mapped to the events slot of the medical decision-making class, as shown in FIG. 31. Class mapping and slot mapping constitute the foundation of the mapping between a guideline representation model and the GETO, and may be used to define other concepts, such as the anchoring class pairs in the mapping.

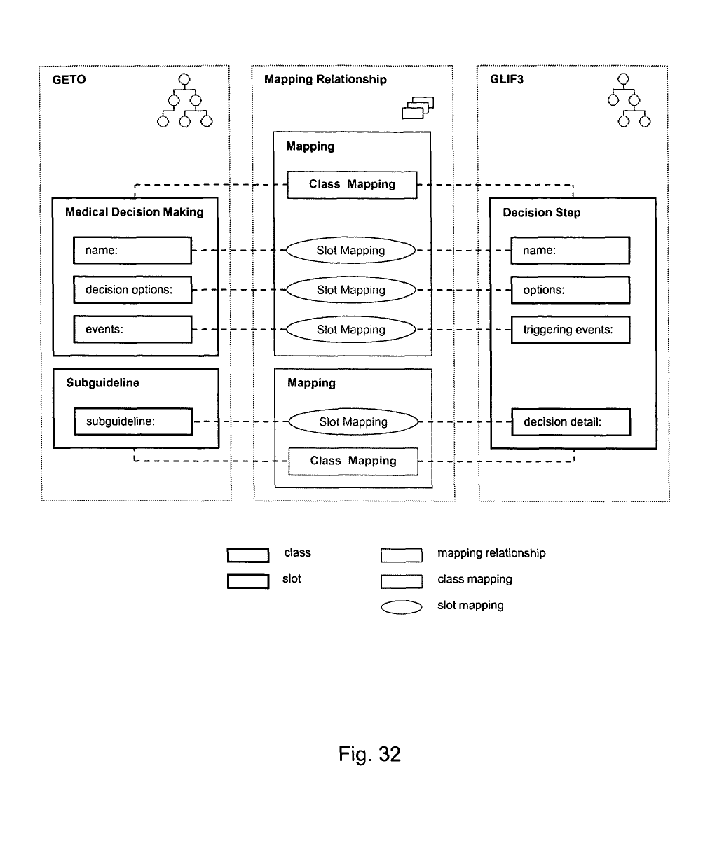

If an element in a guideline representation model matches an element in the GETO, the elements should have exactly the same semantics. As the semantics of an element, represented as a class in an ontological model, are defined by the slots of that class, an exact match between two classes may be achieved only when all of their slots are exactly matched. However, exact match rarely exists; instead, a match usually refers to the existence of corresponding elements in different ontologies with partially-matched semantics. For example, in the mapping relationship shown in FIG. 31, the decision step class in the GLIF3 model and the medical decision-making class in the GETO have only partially-matched semantics, which apply only when they define the possible options of a medical decision-making task and the triggering events of that task. Although there are several matched slots between these two classes, the decision detail slot of the decision step class, which is used to encode a possible subguideline, does not have a matched slot in the medical decision-making class. Therefore, a mapping may be considered more a set of slot mappings within the context of two partially-matched classes, than a direct and exact match of two classes. It is possible that, for the same class, there exist multiple mapping relationships defined for different sets of its slots, with each set specifying a specific pair of mapping classes. For the example shown in FIG. 32, the subguideline class is another element in the GETO to which the decision step class in the GLIF3 model is conditionally mapped, where the decision detail slot of the decision step class is mapped to the subguideline slot of the subguideline class. Thus, the decision step class in the GLIF3 model is mapped to at least two classes in the GETO—the medical decision-making class and the subguideline class—as shown in FIG. 32, i.e, the decision step class in the GLIF3 model has multiple matched classes in the GETO.

In the mapping between a guideline representation model and the GETO, it is important to find the pairs of classes in these two or more ontologies that have significant similarity in their semantics. Once these pairs of classes are selected, they can be used as anchoring points to map the ontologies and to define other class mappings. The pairs of classes with significant similarity in their semantics are called anchoring classes. As the guideline execution tasks are usually assumed implicitly by a guideline representation model, it is possible that a GETO class representing a generalized guideline execution task may not have a corresponding class in a guideline representation model, even though that task is supported by the model. This is especially true for the auxiliary tasks, which are almost certain to be assumed only implicitly by a guideline representation model. Consequently, in most instances, only the classes in the structure element subontology and the classes in the execution constraint subontology of the GETO can be selected as the GETO side anchoring class. Additionally, since the classes in the guideline execution task subontology may, in certain instances, be used as internal entities in the GETO, to link the classes in the structure element subontology and the classes in the execution constraint subontology, the classes in the guideline execution task subontology should not be used in the mapping. However, the instances of the guideline execution task classes need to be created in the regeneration of the structure elements and the execution constraints, when translating guidelines that are encoded in a specific format.

If GETO does not support the guideline tasks that are associated with that specific element, and, consequently, a particular element in a guideline representation cannot be mapped successfully to the elements of the GETO, the GETO may be extended to support the execution of guidelines that are encoded in that format. Existence of the anchoring class pairs, however, does not necessarily mean that the process to find the anchoring class pairs is self-evident. Instead, selection of these anchoring class pairs requires in-depth understanding of both the guideline representation model in the mapping and the GETO. In other words, the development of the GETO is an evolving process.

As the GETO contains the generalized guideline execution tasks that are extracted from specific guideline representation models, for any class in a guideline representation model there is at least one corresponding class in the GETO. These two classes are assigned as a pair of anchoring classes, when creating the mapping relationship between a specific guideline representation model and the GETO. Existence of the anchoring class pairs, however, does not necessarily mean that the process to find the anchoring class pairs is self-evident. Instead, selection of these anchoring class pairs requires an in-depth understanding of both the guideline representation model in the mapping and the GETO.

In order to be chosen as an anchoring class pair, the two classes that are selected separately from a guideline representation model and the GETO should have significant similarity in their semantics. This similarity may be unconditional, or, in the context of a generic definition of the guideline execution tasks in the GETO, the mapping between a class in a guideline representation model and a class in the GETO may be provisional. Usually, provisional similarity is the case when a class in a guideline representation model is mapped to multiple classes in the GETO, or vice versa. For example, the subguideline class in the GETO can be mapped from four classes in the GLIF3 model, with specific conditions that should be held for the validity of each of the mappings. For the subguideline class in the GETO to be mapped from the case step class in the GLIF3 model, an instance of the case step class in the GLIF3 model should have a definition of its decision detail slot, which, in turn, should be an instance of the guideline class in GLIF3. (This is the way a subguideline is defined within a case step in the GLIF3 model.) The conditional mappings between the subguideline class in the GETO and other classes in the GLIF3 model are defined similarly.

Another example, with the mapping condition defined in an opposite direction, is shown in FIG. 32, where the decision step class in the GLIF3 model is mapped to two classes in the GETO, with the mapping between the decision step class in the GLIF3 model and the medical decision-making class in the GETO applying only when the decision detail slot of the decision step class is in two categories, the unconditional class mapping and the conditional class mapping, according to whether or not specific conditions must be held for the validity of the mapping. In one embodiment, to specify the conditions for a conditional class mapping, a formal mapping condition specification language is provided. In addition to its use to define the conditions for class mappings, this mapping condition specification language can also be used to define the conditions for slot mappings.

Once two classes are selected as a pair of anchoring classes, and the possible conditions for the class mapping are specified, their mapping at the slot level should then be defined. Considering that the mapping between the GETO and a guideline representation model is an asymmetric mapping, with the GETO as the primary ontology to which the guideline representation model should be mapped, the definition of slot mapping between two anchoring classes should align with the slots of the GETO side anchoring class. In other words, the slot mappings that should be defined within a specific pair of anchoring classes are only those for the slots of the GETO side class. In the example shown in FIG. 31, once the medical decision-making class of the GETO and the decision step class of the GLIF3 model are selected as a pair of anchoring classes, the slot mappings that should be defined within this pair of anchoring classes include only the mapping between the name slot of the medical decision-making class and the name slot of the decision step class, the mapping between the decision options slot of the medical decision-making class and the options slot of the decision step class, and the mapping between the events slot of the medical decision-making class and the triggering events slot of the decision step class. Once the slot mappings for all of the slots of the GETO side anchoring class have been specified, the definition for slot mapping within that pair of anchoring classes is finished. In the previous example, the slot mappings for the decision detail slot of the decision step class, at the GLIF3 side, should be defined within another pair of anchoring classes.

The ideal case in the mapping between two anchoring classes is an exact match. The exact match between two classes and the associated concepts includes the definition of exactly-matched classes, exactly-matched slots, matched slot types, and matched cardinalities. The ontology model used in these definitions is based on the knowledge model of Protégé-2000; nevertheless, in general, these definitions can also apply to other ontology models.

Matched Cardinalities

In a specific ontology model, the cardinality of slot S1, CD1, and the cardinality of slot S2, CD2, are matched cardinalities, if:

(1) the maximum possible value of CD1 is equal to the maximum possible value of CD2; and

(2) the minimum possible value of CD1 is equal to the minimum possible value of CD2.

The cardinality of a slot in the Protégé-2000 knowledge model is defined by the maximum-cardinality facet and the minimum-cardinality facet—the maximum possible value and the minimum possible value of the cardinality, correspondingly. The user interface of the Protégé-2000 tool only distinguishes between a single cardinality and a multiple cardinality. Formally, a single cardinality means the value of the maximum-cardinality facet is equal to one, and a multiple cardinality means the value of the maximum-cardinality is an integer greater than one. Accordingly, a slot with a single cardinality can have a matching cardinality only with a slot with a single cardinality; a slot with a multiple cardinality can have a matching cardinality only with a slot with a multiple cardinality.

Matched Slot Types

In a specific ontology model, the slot type of slot S1 in class C1, ST1, and the slot type of slot S2 in class C2, ST2, are matched slot types, if:

(1) both ST1 and ST2 are of primitive slot type, i.e., string, boolean, integer, or float, and ST1 is equal to ST2;

(2) both ST1 and ST2 are symbol, and the set of the allowed values of S1 is equal to the set of the allowed values of S2; or

(3) both ST1 and ST2 are instance, and

(a) for each of the allowed classes of S1, AC1i (i=1, 2, . . . , k1; k1 is the number of the allowed classes of S1), there is at least one allowed class of S2 that is exactly matched to AC1i; and

(b) for each of the allowed classes of S2, AC2j (j=1, 2, . . . , k2; k2 is the number of the allowed classes of S2), there is at least one allowed class of S1 that is exactly matched to AC2j.

The slot type of a slot in the Protégé-2000 knowledge model is defined by the value-type facet, with possible values of string, boolean, integer, float, symbol, instance, or class.

Exactly-Matched Slots

In a specific ontology model, two slots, S1 and S2, are exactly-matched slots, if:

(1) the slot type of S1, ST1, and the slot type of S2, ST2, are matched slot types; and

(2) the cardinality of S1, CD1, and the cardinality of S2, CD2, are matched cardinalities.

If two slots are exactly -matched slots, they are deemed to be exactly matched to each other.

Exactly-Matched Classes

In a specific ontology model, two classes C1 and C2 are exactly matched classes, if-.

(1) the number of slots in C1, n1, is equal to the number of slots in C2, n2;

(2) for each slot S1i (i=1, 2, . . . , n1; n1 is the number of slots in C1) in C1, there is one and only one slot in C2 that is exactly matched to S1i; and

(3) for each slot 52j (j=1, 2, . . . , n2; n2 is the number of slots in C2) in C2, there is one and only one slot in C1 that is exactly matched to S2j.

Similarly, if two classes are exactly-matching classes, they are deemed to be exactly matched to each other. From the definition above, it is obvious that the slots of two exactly-matched classes have a one-to-one relationship.

As exact match of two anchoring classes rarely exists in the real world, a variety of mapping techniques, such as references, transformations, and conditions, are used in the mapping process, either individually or jointly.

Slot mapping between two anchoring classes can be classified using three dimensions, i.e., reference (direct slot mapping and referenced slot mapping), transformation (preserved slot mapping and transformed slot mapping), and condition (unconditional slot mapping and conditional slot mapping). A slot of the GETO side anchoring class may not need to be mapped from the guideline representation model side. This type of slot is called a predefined slot. As a special case of the preserved slot mapping, reflective slot mapping may be used when a slot of the GETO side anchoring class is directly mapped from the guideline model side anchoring class itself, instead of a slot of the guideline model side anchoring class.

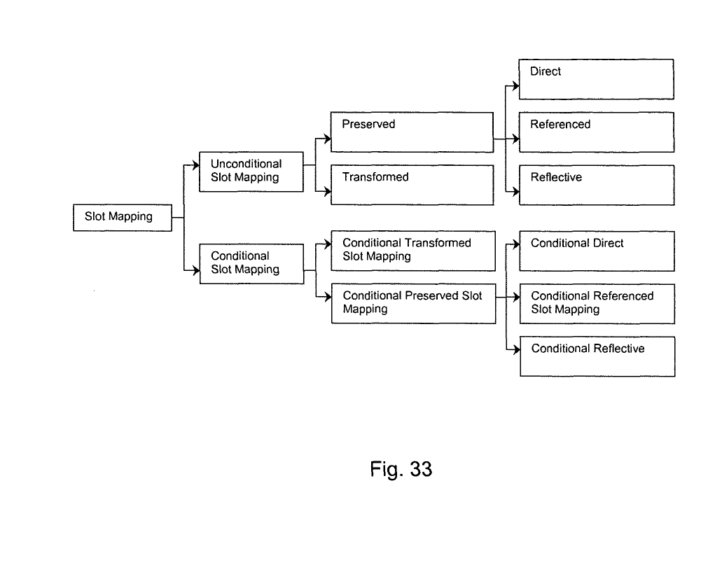

The hierarchy of slot mapping may be a hierarchy as shown in FIG. 33. As each unconditional type of slot mapping has its conditional counterpart, only the features of the unconditional types are discussed. All of the discussions directed to an unconditional type of slot mapping also apply to its conditional counterpart. A simple scenario in the development of the slot mappings between two anchoring classes is the direct slot mapping between a slot of the GETO side anchoring class and a slot of the guideline model side anchoring class.

Compatible Cardinalities

In a pair of anchoring classes that consists of the GETO side class CGETO and the guideline representation model side class CGRM, the cardinality of slot SGETO in class CGETO, CDGETO, and the cardinality of slot SGRM in class CGRM, CDGRM, are compatible cardinalities, if:

(1) the maximum possible value of CDGETO is greater than or equal to the maximum possible value of CDGRM; and, (2) the minimum possible value of CDGETO is less than or equal to the minimum possible value of CDGRM.

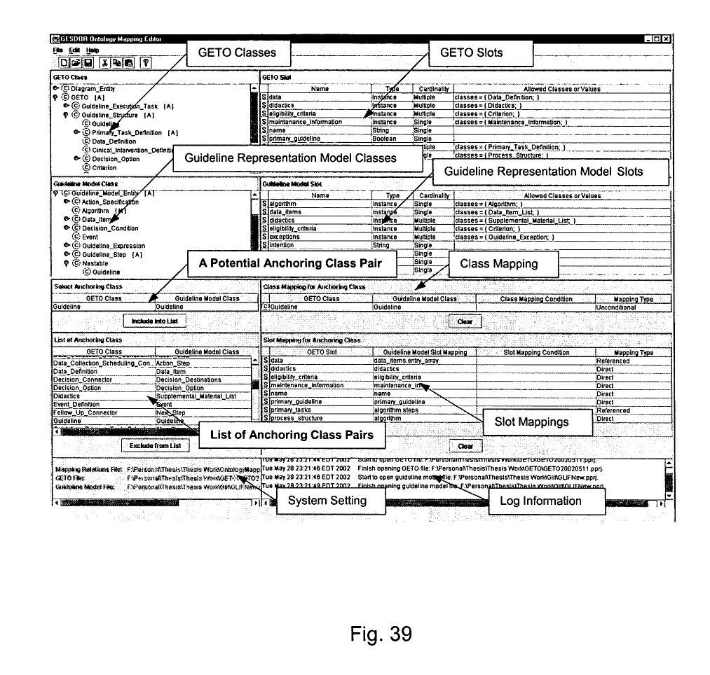

In the user interface of the Guideline Execution by Semantic Decomposition of Representation (“GESDOR”) Ontology Mapping Editor, as shown in FIG. 39, a slot at the GETO side with a single cardinality can have a compatible cardinality only with a slot at the guideline representation model side with a single cardinality; a slot at the GETO side with a multiple cardinality can have a compatible cardinality with a slot at the guideline representation model side with either a single cardinality or a multiple cardinality. The definition of compatible cardinalities can be generalized, so that it can be applied to referenced slot mapping.

Compatible Slot Types

In a pair of anchoring classes that consists of the GETO side class CGETO and the guideline representation model side class CGRM, the slot type of slot SGETO in class CGETO, STGETO, and the slot type of slot SGRM in class CGRM, STGRM, are compatible slot types, if:

(1) both STGETO and STGRM are primitive slot types, i.e., string, boolean, integer, or float, and STGETO is equal to STGRM;

(2) both STGETO and STGRM are symbol, and

(a) for each of the allowed values of SGETO, A VGETOi (i=1, 2, . . . , lGETO; lGETO is the number of the allowed values of SGETO), there is at least one allowed value of SGRM, A VGRMi, wherein A VGETOj is a renaming of AVGRMi; and

(b) for each of the allowed values of SGRM, A VGRMj (j=1, 2, . . . , lGRM; lGRM is the number of the allowed values of SGRM), there is at least one allowed value of SGETO, A VGETOj, wherein A VGETOj is a renaming of A VGRMj; or

(3) both STGETO and STGRO are instance, and

(b) for each of the allowed classes of SGETO, ACGETOi (i=1, 2, . . . , kGETO; kGETO is the number of the allowed classes of SGETO), there is at least one allowed class of SGRM, ACGRMi, wherein ACGETOi and ACGRMi is a pair of anchoring classes; and

(c) for each of the allowed classes of SGRM, ACGRMj (j=1, 2, . . . , kGRM; kGRM is the number of the allowed classes of SGRM), there is at least one allowed class of SGETO, ACGETOj, wherein ACGRMj and ACGETOj is a pair of anchoring classes.

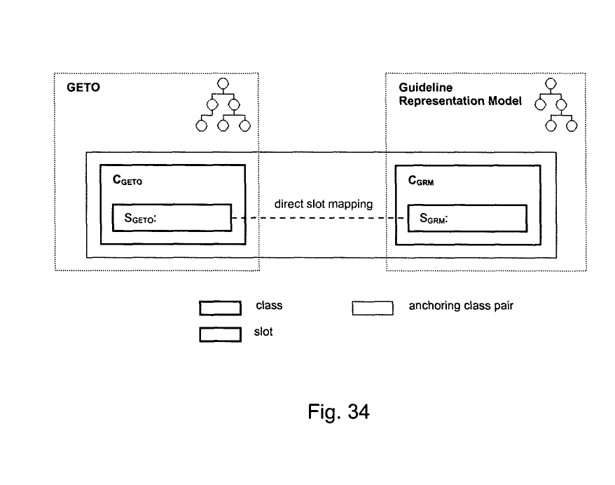

The compatible slot types are recursively defined through anchoring class pairs when both slot types are instance. Based on the previous definitions of compatible cardinalities and compatible slot types, a formal definition of direct slot mapping is provided below. A graphical explanation of direct slot mapping is shown in FIG. 34.

Direct Slot Mapping

In a pair of anchoring classes that consists of the GETO side class CGETO and the guideline representation model side class CGRM, the slot mapping between slot SGETO in class CGETO and slot SGRM in class CGRM is a direct slot mapping, if:

(1) SGETO and SGRM have significant similarity in semantics;

(2) the slot type of SGETO, STGETO, and the slot type of SGRM, STGRM, are compatible slot types; and

(3) the cardinality of SGETO, CDGETO, and the cardinality of SGRM, CDGRM, are compatible cardinalities.

The judgment of significant similarity in semantics between two slots may be subject to the decision of the medical informatician or knowledge engineer who develops the mapping relationship between a guideline representation model and the GETO. The requirements on slot type compatibility and cardinality compatibility in the definition may be used by a generic guideline execution engine to facilitate the translation of the instances from the guideline representation model side to the GETO side. To formally represent the slot mapping, the present invention provides a slot mapping specification language.

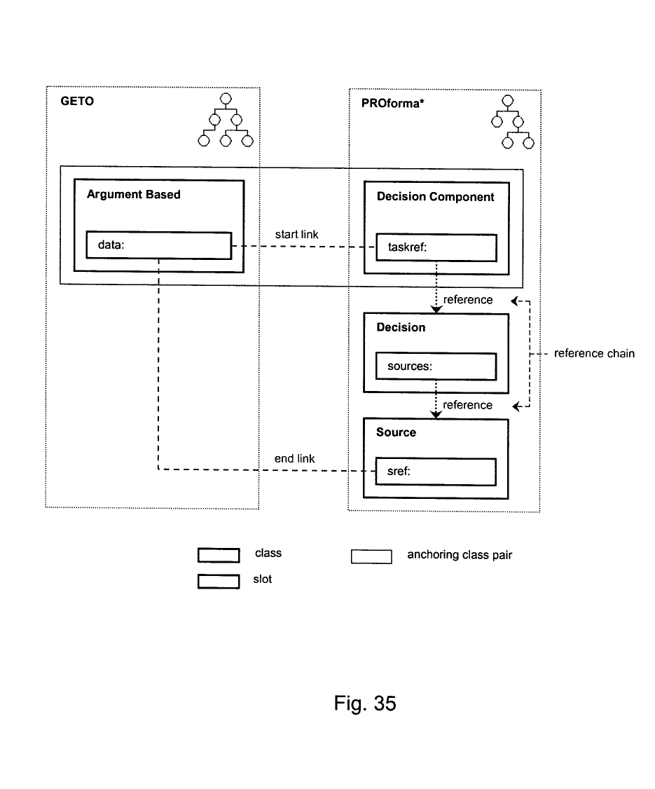

It is possible that there are some slots of the GETO side anchoring class such that no slot of the guideline model side anchoring class can be directly mapped. In order to obtain semantic match, mapping of these slots of the GETO side anchoring class needs to reference the slots of other classes at the guideline model side, through specific slots of the current anchoring class at the guideline model side. This type of slot mapping is a referenced slot mapping. For example, the argument based medical decision-making class of the GETO and the decision component class of the PROforma model form a pair of anchoring classes. Within this pair of anchoring classes, the data slot of the argument based medical decision-making class at the GETO side does not have a directly mapping slot in the decision component class at the PROforma side. Instead, this data slot of the argument based medical decision-making class should be mapped from the sref slot of the source class in the PROforma model. This slot mapping starts from the taskref slot of the decision component class in the PROforma model. The taskref slot of the decision component class makes a reference to the decision class in the PROforma model, which, in turn, makes a reference through its sources slot to the source class in the PROforma model, as shown in FIG. 35. It is important to note that this type of slot mapping is defined within the current pair of anchoring classes, although its definition involves other classes in the guideline representation model.

The referenced slot mapping shown in FIG. 35 has two levels of references, involving two extra classes (the decision class and the source class) beyond the anchoring class at the guideline representation model side. In general, a referenced slot mapping may have multiple levels of references, in which case the mapping of the slot in the anchoring class at the GETO side is through a series of references to the classes at the guideline representation model side that forms a reference chain. The reference chain starts from a specific slot of the current anchoring class at the guideline representation model side and ends at the destination slot in another class at the guideline representation model side. The destination slot, along with the reference chain that starts from a specific slot of the current anchoring class at the guideline representation model side, constitutes the context that is used by a medical informatician or knowledge engineer to judge the semantic similarity in the slot mapping.

The definition for generalized compatible cardinalities generalizes the compatible cardinalities defined above, so that it can be applied to referenced slot mapping.

Generalized Compatible Cardinalities

In a pair of anchoring classes that consists of the GETO side class CGETO and the guideline representation model side class CGRM, if there exists a set {{CGRM, C1, C2, . . . , Cm}, {SGRM, S1, S2, . . . , Sm}, {CDGRM, CD1, CD2, . . . , CDm}} (m is a positive integer), so that

(1) CGRM, C1, C2, . . . , and Cm are guideline representation model side classes;

(2) SGRM is a slot of CGRM, S1 is a slot of C1, S2 is a slot of C2, . . . , and Sm is a slot of Cm;

(3) CDGRM is the cardinality of SGRM, CD1 is the cardinality of S1, CD2 is the cardinality of S2, . . . , and CDm is the cardinality of Sm; and

(4) the slot type of SGRM is instance, and C1 is an allowed class of SGRM; the slot type of S1 is instance, and C2 is an allowed class of S1; the slot type of S2 is instance, and C3 is an allowed class of S2; . . . ; the slot type of Sm−1 is instance, and Cm is an allowed class of Sm−1; the cardinality of slot SGETO, CDGETO, and the cardinality of slot Sm, CDm, are generalized compatible cardinalities through the reference chain represented by the list ((CGRM, C1, C2, . . . , Cm), (SGRM, S1, S2, . . . , Sm)) if there is none or only one of the cardinalities among CDGRM, CD1, CD2, . . . , and CDm, CDi (i=GRM, 1, 2, . . . m), so that the maximum possible value of CDi is greater than 1, and (1) the maximum possible value of CDGETO is greater than or equal to the maximum possible value of CDi; and (2) the minimum possible value of CDGETO is less than or equal to the minimum possible value of CDi.

Referenced Slot Mapping

In a pair of anchoring classes that consists of the GETO side class CGETO and the guideline representation model side class CGRM, if there exists a set {{CGRM, C1, C2, . . . , Cm}, {SGRM, S1, S2, . . . , Sm}} (m is a positive integer), so that:

(1) CGRM, C1, C2, . . . , and Cm are guideline representation model side classes;

(2) SGRM is a slot of CGRM, S1 is a slot of C1, S2 is a slot of C2, . . . , and Sm is a slot of Cm; and

(3) the slot type of SGRM is instance, and C1 is an allowed class of SGRM; the slot type of S1 is instance, and C2 is an allowed class of S1; the slot type of S2 is instance, and C3 is an allowed class of S2; . . . ; the slot type of Sm−1 is instance, and Cm is an allowed class of Sm−1;

the slot mapping between slot SGETO in CGETO and slot Sm in Cm is a referenced slot mapping through the reference chain represented by the list ((CGRM, C1, C2, . . . , Cm), (SGRM, S1, S2, . . . , Sm)), if:

(1) SGETO and Sm have significant similarity in semantics, considering that Sm is referenced by SGRM through the reference chain represented by the list ((CGRM, C1, C2, . . . , Cm), (SGRM, S1, S2, . . . , Sm));

(2) the slot type of SGETO, STGETO, and the slot type of Sm, STm, are compatible slot types; and

(3) the cardinality of SGETO, CDGETO, and the cardinality of Sm, CDm, are generalized compatible cardinalities through the reference chain represented by the list ((CGRM, C1, C2, . . . , Cm), (SGRM, S1, S2, . . . , Sm)).

The requirements on slot type compatibility and generalized cardinality compatibility in the definition may generally be used by the generic guideline execution engine to facilitate the translation of instances from the guideline representation model side to the GETO side.

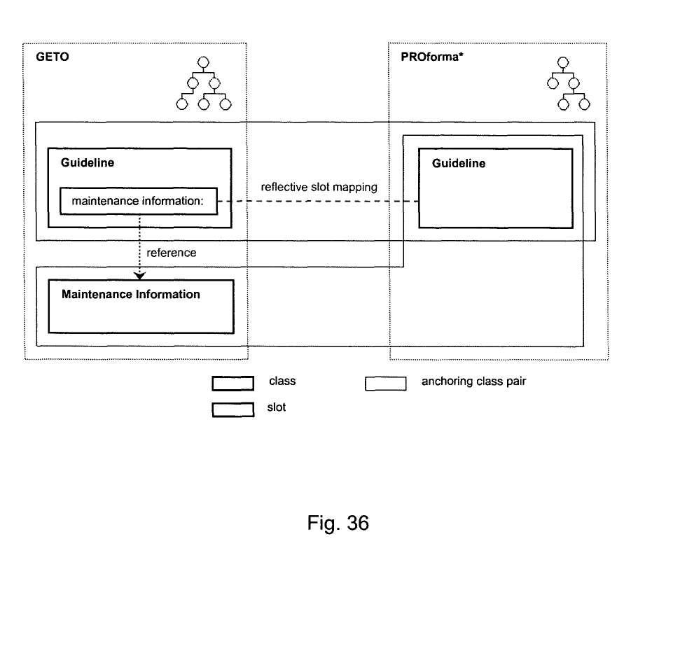

In some cases, a slot of the anchoring class at the GETO side should not be mapped from any slot of the anchoring class at the guideline representation model side. Instead, it should be directly mapped from the anchoring class itself at the guideline representation model side. Usually, this is the case when two classes at the GETO side, with one referenced by the other, need to be mapped from the same class at the guideline representation model side. This type of slot mapping is a reflective slot mapping. For example, when creating the mapping between the GETO and the PROforma model, both the guideline class and the maintenance information class of the GETO should be mapped from the guideline class of PROforma. At the GETO side, the maintenance information class is referenced by the guideline class through its maintenance information slot. When mapping the guideline class of the GETO from the guideline class of PROforma, the maintenance information slot of the guideline class at the GETO side could not be mapped from the PROforma side using a direct slot mapping or a referenced slot mapping. This slot should be directly mapped from the current anchoring class at the PROforma side, i.e., the guideline class of the PROforma model, to achieve semantic match, as shown in FIG. 36. During guideline execution, when this reflective slot mapping is processed by the generic guideline execution engine, the associated anchoring between the maintenance information class of the GETO and the guideline class of PROforma is automatically searched and processed to do the translation.

Reflective Slot Mapping

In a pair of anchoring classes that consists of the GETO side class CGETO and the guideline representation model side class CGRM, if there exists a set {CGETO, C1, SGETO}, so that

(1) CGETO and C1 are GETO side classes;

(2) SGETO is a slot of CGETO; and

(3) the slot type of SGETO is instance, and C1 is an allowed class of SGETO; the slot mapping between slot SGETO in class CGETO and class CGRM is a reflective slot mapping, if

(1) SGETO and CGRM have significant similarity in semantics, considering that C1 is referenced by SGETO; and

(2) C1 and CGRM is a pair of anchoring classes.

The requirement of anchoring classes may be used by the generic guideline execution engine to facilitate the translation of instances from the guideline representation model side to the GETO side.

A slot of the GETO side anchoring class can be mapped from the guideline representation model side through a direct slot mapping, a referenced slot mapping, or a reflective slot mapping, wherein the slot value of the anchoring class at the guideline representation model side is used directly in the generic guideline execution model to regenerate the structure elements and the execution constraints at the GETO side. Because the slot value does not need to be transformed in this process, this type of slot mapping is called a preserved slot mapping.

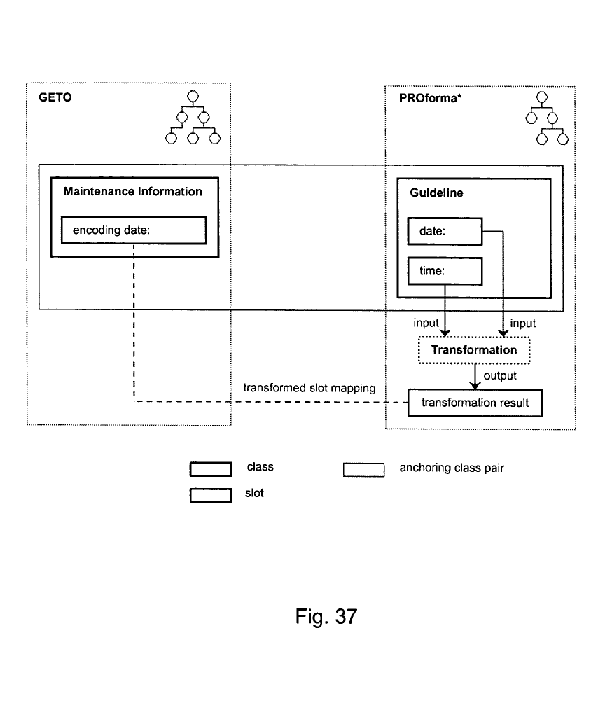

In some cases, the slot value of the anchoring class at the guideline representation model side needs to be transformed before it can be mapped to the slot of the anchoring class at the GETO side. This usually happens when a slot of the anchoring class at the GETO side needs to be linked from multiple slots of the anchoring class at the guideline representation model side to achieve semantic match. For example, when mapping the maintenance information class in the GETO, from the guideline class in the PROforma model, the encoding date slot of the maintenance information class is semantically associated with both the date slot and the time slot of the guideline class. In other words, the encoding date slot of the maintenance information class in the GETO is used to encode the information that is encoded in both the date slot and the time slot of the guideline class in PROforma. This slot mapping could not be created using a direct slot mapping, a referenced slot mapping, or a reflective slot mapping. In order to create this type of semantics link, the present invention provides a slot transformation to convert the slot values of the anchoring class at the guideline representation model side so that the semantics of the transformed slot, which can be considered as a dangling slot (not affiliated with any class), match the semantics of the slot of the anchoring class at the GETO side, as shown in FIG. 37.

Referring to FIG. 37, a slot transformation concat is used in the transformed slot mapping. This slot transformation takes multiple input elements with the string slot type, and generates the concatenation of these input elements as the output element of the transformation. This concat slot transformation, as well as several other slot transformations, such as combineAnd and combineOr, are defined in the slot mapping specification language.

Slot Transformation

In a specific ontology model, a slot transformation on class C is a function with n (n is a positive integer) input elements, I1, I2, . . . , In, an output element, O, and a transformation function transformation, so that

(1) for each Ii (i=1, 2, . . . , n), slot type STi and cardinality CDi are predefined, so that

(a) Ii can be considered as a dangling slot with slot type STi, cardinality CDi, and slot value set SVSi that consists of elements

with constant slot values; (in this instance, STᵢ can only be string, boolean, integer, float, or symbol so that the slot values can be constants);

(b) Ii is the output element of another slot transformation with slot type STi, cardinality CDi, and slot value set SVSi;

(c) Ii is a slot of C with slot type STi, cardinality CDi, and slot value set SVSi; or

(d) there exists a set {{C, C1, C2, . . . , Cm−1, Cm}, {S, S1, S2, . . . , Sm−1, Ii}} (m is a positive integer), so that

(i) C, C1, C2, . . . , Cm−1, and Cm are classes;

(ii) S is a slot of C, S1 is a slot of C1, S2 is a slot of C2, . . . , Sm−1 is a slot of Cm−1, and Ii is a slot of Cm with slot type STi, cardinality CDi, and slot value set SVSi; and

(iii) the slot type of S is instance, and C1 is an allowed class of S; the slot type of S1 is instance, and C2 is an allowed class of S1; the slot type of S2 is instance, and C3 is an allowed class of S2; . . . ; the slot type of Sm−1 is instance, and Cm is an allowed class of Sm−1;

(2) O can be considered as a dangling slot with slot type STo, cardinality CDo, and slot value set SVSo; and

(3) transformation takes SVS1, SVS2, . . . , and SVSn as input elements and SVSo as output element; SVSo is solely decided by SVS1, SVS2, . . . , and SVSn through transformation.

In (3) each of the input elements and the output element of transformation is a set of slot values. Although in the ontology model no specific order is defined on the slot value elements of a particular slot value set, a transformation function may require a definition of this order to facilitate the transformation.

Transformed Slot Mapping

In a pair of anchoring classes that consists of the GETO side class CGETO and the guideline representation model side class CGRM, if there exists a slot transformation on CGRM with an output element O, the slot mapping between slot SGETO in class CGETO and O is a transformed slot mapping, if:

(1) SGETO and O, when considering that O is the output element of the slot transformation on CGRM, have significant similarities in semantics;

(2) the slot type of SGETO, STGETO, and the slot type of O, STo, are compatible slot types; and

(3) the cardinality of SGETO, CDGETO, and the cardinality of O, CDo, are compatible cardinalities.

Slot mappings may be unconditional and may also require specific conditions to be held, as in the case of class mappings. This usually happens when multiple slots of the anchoring class at the GETO side could be mapped from the same slot at the guideline representation model side. In other words, when the slots of the GETO side anchoring class have finer definitions than the slots of the guideline model side anchoring class, the mapping between a slot at the GETO side and a slot at the guideline representation model side needs to specify the conditions that must be met in order for the mapping to be valid. For example, in the mapping between the guideline class in the GETO and the guideline class of PROforma, both the data slot and the primary task slot of the guideline class in the GETO could be mapped from the task or data slot of the guideline class in PROforma. The former slot mapping applies only when the allowed class of the task or data slot is the data class in PROforma, while the latter slot mapping applies only when the allowed class of the task or data slot is the task class in PROforma.

In some cases, a slot of the anchoring class at the GETO side may not need to be mapped from the guideline representation model side. The value of this slot is not related to the guideline representation model side. Usually, this is a slot that takes a constant value, or a slot that is used for internal reference at the GETO side. Although it is not mapped from the guideline representation model side, this type of slot needs to be recorded to provide a hint to the generic guideline execution engine so that it can be processed appropriately. Thus, this type of slot is represented as a predefined slot in the mapping relationship between a guideline representation model and the GETO. When this type of slot mapping is processed by the generic guideline execution engine, it needs to be handled in a special way, instead of being used as a regular slot mapping that acts as a bridge between an anchoring class pair.

Formal Language for Specification of Mapping Condition and Slot Mapping

To facilitate the definition of the mapping between two anchoring classes, this invention provides two formal languages, i.e., a mapping condition specification language that is used to specify the conditions for class mapping and slot mapping, and a slot mapping specification language that is used to specify slot mapping.

The syntax of the mapping condition specification language is similar to that of the JAVA™ programming language on specification of expression. An example use of this mapping condition specification language to define conditions for class mapping is in the anchoring class pair that consists of the logic based decision option class at the GETO side and the decision option class at the GLIF3 side, where the condition for class mapping is specified as: getClassName (condition_value)=“Case_Condition”. This definition of class mapping conditions means that the value of the condition value slot of the decision option instance at the GLIF3 side must be an instance of the case condition class in order for the class mapping to be valid.

The major operations, functions, and expressions supported by the mapping condition specification language include: (1) logic operation and (&&), or (||), and not (!); (2) comparison operation equal (=) and not equal (!=); (3) function getClassName; (4) specification of slot name; and (5) reserved words such as false, true, null, and SELF.

The syntax of the slot mapping specification language is similar to that of the JAVA™ programming language on reference to an object's attributes. For example, when mapping the logic based decision option class in the GETO from the decision option class in GLIF3, the slot mapping for the criterion slot of the logic based decision option class is defined as: condition_value.case_value. This definition means that in this referenced slot mapping the criterion slot of the logic based decision option class at the GETO side is mapped from the case value slot of the decision condition class at the GLIF3 side through reference by the condition value slot of the decision option class. The major functions and expressions supported by the slot mapping specification language include: (1) function combineAnd, combineOr, and concat; (2) specification of slot name; and (3) reserved word SELF.

Anchoring Class Pair

An anchoring class pair in the mapping between the GETO and a guideline representation model is a set {CGETO, CGRM, CMT, CMC, {SM1, SM2, . . . , SMn}} (n is the number of slots in CGETO) where

(1) CGETO is a class in the GETO;

(2) CGRM is a class in the guideline representation model;

(3) CGETO, CGRM, CMT, and CMC define the class mapping between CGETO and CGRM, so that

(a) CMT is the type of class mapping between CGETO and CGRM, which can take the value unconditional class mapping, or conditional class mapping; and

(b) CMC is the condition of the class mapping between CGETO and CGRM, encoded using the mapping condition specification language; and

(4) the set {SM1, SM2, . . . , SMn} defines the slot mappings between CGETO and CGRM, where each SMi (i=1, 2, . . . , n) is a set {Si, SMSi, SMTi, SMCi} so that

(a) Si is the ith slot of CGETO;

(b) SMSi is the specification of slot mapping at the guideline representation model side that corresponds to Si, encoded using the slot mapping specification language;

(c) SMTi is the type of the slot mapping SMi, which can take the value predefined slot, direct slot mapping, referenced slot mapping, reflective slot mapping, transformed slot mapping, or conditional slot mapping; and

(d) SMCi is the condition of the slot mapping SMi, encoded using the mapping condition specification language.

As required by some types of slot mapping, the decision to take a specific pair of classes as an anchoring class pair may lead to subsequent decisions to take other pairs of classes as anchoring class pairs. The hierarchy of classes is another factor that should be considered when creating the mapping relationship.

The mapping relationship between a guideline representation model and the GETO is generally developed to create the semantic links between the elements in a specific guideline representation model and the generalized guideline execution tasks in the GETO. These mapping relationships are used by the generic guideline execution engine to drive the execution of guidelines that are encoded in specific formats. The mapping relationship between a specific guideline representation model and the GETO is represented by a set of anchoring class pairs.

The mapping relationship between a guideline representation model and the GETO may be a set {GRM, GETO, AnchoringClassPairs} where

(1) GRM is the guideline representation model in the mapping;

(2) GETO is the generalized guideline execution task ontology in the mapping; and

(3) AnchoringClassPairs is a set of anchoring class pairs, each of which consists of a class in GRM and a class in GETO.

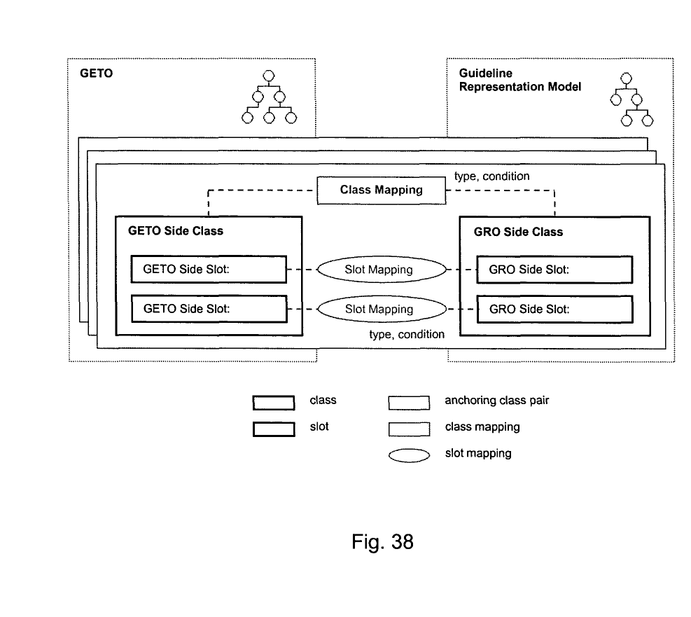

A pair of anchoring classes generally consists of (1) the GETO side class, (2) the guideline representation model side class, (3) the type of class mapping between the two anchoring classes, (4) the conditions for the class mapping between the two anchoring classes, encoded in the mapping condition specification language, and (5) a set of slot mappings defined within that pair of anchoring classes. In addition, a specific slot mapping consists of (1) the GETO side slot, (2) the guideline representation model side slot mapping specification, encoded in the slot mapping specification language, (3) the type of the slot mapping, and (4) the conditions for the slot mapping, encoded in the mapping condition specification language. Thus, the mapping relationship between a guideline representation model and the GETO has a nesting structure, as shown in FIG. 38. Currently, these mapping relationships between specific guideline representation models and the GETO are implemented as XML files.

GESDOR Ontology Mapping Editor

One aspect of the present invention provides a GESDOR Ontology Mapping Editor to facilitate the development and maintenance of the mapping relationship between a guideline representation model and the GETO. This editor can be used as a tool in the development and maintenance of the mapping relationship, which can be further used in the GESDOR generic guideline execution model, described in detail below, to drive the execution of guidelines that are encoded in specific formats. The GESDOR Ontology Mapping Editor may be implemented using the JAVA™ or any other suitable programming language.

The GESDOR Ontology Mapping Editor may provide functionality with respect to: (1) retrieval and presentation of ontology elements, including classes, slots, and facet information, such as slot name, slot type, cardinality, allowed classes, and allowed values, from the GETO and a specific guideline representation model; (2) presentation of the class structure of the GETO and the guideline representation model; (3) support to the development of mapping relationships, such as definition of class mapping, specification of slot mapping, description of mapping conditions, and selection of mapping type; and (4) exporting the mapping relationships as files, such as XML files, and importing these files for modifications. As the GESDOR Ontology Mapping Editor needs to know the internal structure of the GETO and a specific guideline representation model, its implementation relies on the representation of the GETO and the guideline representation model in the mapping. In one embodiment, the GETO and the guideline representation model are developed using the Protégé-2000 knowledge acquisition tool. Using the application programming interfaces of Protégé-2000, the GESDOR Ontology Mapping Editor can retrieve the internal structure of the GETO and a specific guideline representation model, which are represented and stored as Protégé-2000 projects. Screenshots of the GESDOR Ontology Mapping Editor is shown in FIGS. 38 and 39.

The GESDOR Ontology Mapping Editor may be used to create a mapping relationship between a specific guideline representation model and the GETO, by selecting the project file of the guideline representation model and the GETO. The GESDOR Ontology Mapping Editor then loads these two files and presents their class structures, as shown in the upper-left portion of the screen in FIG. 39. By selecting a specific class in the guideline representation model or the GETO class structure, information about the slots of that class is presented. If a user selects a class from the GETO class structure and a class from the guideline representation model class structure, the two highlighted classes are shown as a potential pair of anchoring classes. The user can then select to include the potential pair of anchoring classes into the list of anchoring class pairs. To define the mapping information for a specific pair of anchoring classes, a user can highlight that pair of anchoring classes from the list of anchoring class pairs. The class mapping and slot mappings for that pair of anchoring classes, such as the type of class mapping, conditions for class mapping, slot mappings, type of slot mapping, and conditions for slot mapping, can then be specified. After the definition of the class mapping and slot mapping has been finished for all the anchoring class pairs, the mapping relationship may be saved as an XML file.

Formal definition of class mapping and slot mapping provides a framework within which a medical informatician or knowledge engineer can work to develop the mapping relationship between a guideline representation model and the GETO. This framework defines what can be done when developing the mapping relationship. What should be done during this process is subject to the judgment of the medical informatician or the knowledge engineer who develops the mapping relationship between a guideline representation model and the GETO. Specifically, decisions need to be made regarding selection of anchoring class pairs, choosing of mapping types, specification of mapping conditions, and definition of slot mappings.

The present invention provides some generic guiding principles for the development of the mapping relationship between a guideline representation model and the GETO. Specifically, the following guiding principles may be used to select two classes as a pair of anchoring classes:

(1) Start from the classes in the structure element subontology of the GETO, using a top-down approach. Usually, this means that the guideline class and the process structure class in the GETO should be selected as the first two GETO side anchoring classes, and their guideline representation model side counterparts, which are the elements that are used to represent the whole guideline and the overall structure of guideline execution in the guideline represent model, need to be searched. Once such classes have been identified, these pairs of anchoring classes can then be used as the original anchoring points in the mapping between the GETO and the guideline representation model. These original anchoring class pairs further lead to the selection of other pairs of anchoring classes, based on the requirement for slot type compatibility by specific types of slot mapping, as described in (5) below.

(2) At the next level, the mapping of the primary task structures can be considered. This includes the mapping of the GETO side classes such as the clinical action class and its subclasses, the medical decision making class and its subclasses, the patient state verification class, the branching class, the synchronization class, and the subguideline class. It is important to note that not all of these classes can be mapped from a specific guideline representation model. Nevertheless, at least some of these primary tasks should have been defined and supported by a guideline representation model. Thus, development of these mappings between the primary task structures at the GETO side and their corresponding elements at the guideline representation model side will have created a basic structure for the mapping relationship between a guideline representation model and the GETO.

(3) Based on the references by the guideline class, the process structure class, and the primary task structure classes, other classes in the structure element subontology are then selected as the anchoring classes at the GETO side. Their corresponding classes at the guideline representation model side are searched. Usually, these are the classes that are referenced by the classes representing the whole guideline, the overall guideline execution process, and the specific primary tasks in the guideline representation model, as described in (1) and (2).

(4) Based on the references by the process structure class and the primary task structure classes, the classes in the execution constraint subontology of the GETO are then selected as the anchoring classes at the GETO side. Their corresponding classes at the guideline representation model side are then searched. This usually needs the decomposition of the classes that are used to represent the process structure and the primary tasks in the guideline representation model, so that the components of these classes that are used to represent the dynamic execution constraints can be figured out. These components are then mapped to their GETO side counterparts.

(5) The requirement for slot type compatibility by specific types of slot mapping can be used as a hint to select pairs of anchoring classes. For example, when mapping the guideline class in the GETO from the guideline class in the GLIF3 model, once the slot mapping between the process structure slot of the guideline class at the GETO side and the algorithm slot of the guideline class at the GLIF3 side has been decided, the allowed class of the process structure slot, which is the process structure class in the GETO, and the allowed class of the algorithm slot, which is the algorithm class in the GLIF3 model, need to be selected as a pair of anchoring classes. These hints can be used in the subsequent mappings between the GETO side classes and the guideline representation model side classes, until all of the relevant classes in the guideline representation model have been mapped to the GETO side.

(6) If one of the two anchoring classes in an anchoring class pair has subclasses, the class mapping between each of these subclasses and the class at the other side can be considered. If both anchoring classes in an anchoring class pair have subclasses, the class mapping between each of the subclasses at the guideline representation model side, and a specific subclass at the GETO side, can be considered. In these cases, the superclasses are usually abstract classes; thus, the mapping between the superclasses are used only for conceptualization of the semantic mapping, instead of being used actually for translation of instances from the guideline representation model side to the GETO side.

The following guiding principles may be used to decide whether a class mapping should be created as a conditional class mapping:

(1) If there are multiple GETO side classes that are mapped from the same guideline representation model side class, a conditional class mapping should be considered. Usually this means the GESDOR guideline execution engine needs to decide for which GETO side class an instance should be regenerated from an instance of the guideline representation model side class.

(2) If there are multiple guideline representation model side classes that are mapped to the same GETO side class, it is possible that specific conditions must be held for the validity of a particular class mapping. Usually this means multiple guideline representation model side classes contain a common task, structure, or constraint that is modeled at the GETO side. Because this common task, structure, or constraint is defined in different context (the different classes) of the guideline representation model, specific conditions must be met before it can be applied in a particular context.

The following guiding principles may be used to decide the type of a slot mapping:

(1) If there are multiple guideline representation model side classes on a reference chain, and each of these classes has partially-matched semantics corresponding to the same class at the GETO side, referenced slot mapping should be considered when creating the mapping relationship between the GETO side class and the guideline representation model side class at the start of the reference chain.

(2) If there are two GETO side classes, one referenced by the other, and each of the classes has partially-matching semantics corresponding to the same class at the guideline representation model side, reflective slot mapping should be considered when creating the mapping relationship between the guideline representation model side class and the GETO side class that makes a reference to another class at the GETO side.

(3) If the slot value of the GETO side anchoring class is supposed to be independent of the guideline representation model side, a predefined slot mapping should be considered. Usually, this is the case when the slot at the GETO side has a constant value, or is solely used in the GETO for internal reference.

The following guiding principles may be used to decide whether a slot mapping should be created as a conditional slot mapping:

(1) Consider a conditional slot mapping if there are multiple slots at the GETO side that are mapped from the same slot at the guideline representation model side in a specific pair of anchoring classes. This usually means the GETO side anchoring class has finer slot definition than does the guideline representation model side anchoring class; thus, conditions need to be defined to direct the translation of the instances from the guideline representation model side to the GETO side.

The following guiding principles may be used to decide whether the mapping relationship between a guideline representation model and the GETO has been completely developed:

(1) Each concrete class at the guideline representation model side, except those that are not relevant to guideline execution, should have been mapped to the GETO side at least once.

(2) For each class that is an anchoring class at the GETO side, all of the slots, except those that are only used for internal reference purposes, or those that have constant values, should have been mapped from the guideline representation model side.

(3) There is no violation of the requirements on slot type compatibility and cardinality compatibility.

(4) If an abstract class at the GETO side is mapped from a class at the guideline representation model side, there is at least one concrete subclass of the abstract class at the GETO side that has been mapped from either the class at the guideline representation model side or a concrete subclass of that class.

Development of the mapping relationship between the GLIF3 guideline representation model and the GETO may start from the guideline class in the GETO, which corresponds to the guideline class in the GLIF3 model. The process structure class in the GETO is then mapped from the algorithm class in GLIF3, based on their semantic similarities. These two anchoring class pairs are then used as two initial pairs of anchoring points that lead to the search of other anchoring class pairs. The structure element components of the classes that may then be used to represent the primary tasks in GLIF3, which are the subclasses of the guideline step class (such as the action step class, the case step class, the choice step class, the patient state step class, the branch step class, and the synchronization step class), are then mapped to their corresponding classes in the structure element subontology of the GETO. These mappings are further used to direct the mapping between other structure element classes. For example, in the anchoring class pair that consists of the medical decision-making class at the GETO side, and the decision step class at the GLIF3 side, the decision options slot of the medical decision-making class at the GETO side is directly mapped from the options slot of the decision step class at the GLIF3 side. This, in turn, implies, based on the requirement of slot type compatibility, that the decision option class, which is the allowed class of the decision options slot of the medical decision-making class at the GETO side, should be mapped from the decision option class in the GLIF3, which is the allowed class of the options slot of the decision step class at the GLIF3 side. Similarly, other classes of the GLIF3 model can be mapped to the GETO side. Finally, the components of the primary task classes, used to represent the execution constraints of the primary tasks in GLIF3, may be identified, and the mapping between these components and the classes in the execution constraint subontology of the GETO may be created.

In the GLIF3 guideline representation model, 36 out of the 42 total classes may be mapped to specific classes in the GETO, either as an anchoring class at the GLIF3 side or with at least one of its slots referenced in a slot mapping. The 6 remaining classes may be abstract classes that are used only for conceptualization purposes. Because these abstract classes have no instances, they are not involved in the translation process of the generic guideline execution model. 120 out of the 127 total slots in the 36 mapped classes may be mapped to specific slots of the GETO side classes. Among the 7 remaining slots, four slots are name slots that are used only for internal reference purposes, and three encode language slots that are irrelevant to mapping. In general, all classes and slots that are involved in the translation of the instances from the GLIF3 side to the GETO side have been successfully mapped.

Development of the mapping relationship between the PROforma guideline representation model and the GETO may start from the guideline class in the GETO, which corresponds to the guideline class in the PROforma model. The process structure class in the GETO may then be selected to be mapped from both the plan class and the guideline class in the PROforma model, as the guideline class is modeled as a subclass of the plan class in PROforma. The structure element components of the classes that may then be used to represent the primary tasks in PROforma, which are the subclasses of the task class and the subclasses of the component class (such as the decision class, the decision component class, the action class, the action component class, the enquiry class, the enquiry component class, the plan class, and the plan component class), are then mapped to their corresponding classes in the structure element subontology of the GETO. These mappings are further used to direct the mapping between other structure element classes. Finally, the components of the primary task classes, that are used to represent the execution constraints of the primary tasks in PROforma, are identified, and the mapping between these components and the classes in the execution constraint subontology of the GETO are created.

In the PROforma guideline representation model, 21 out of the 22 total classes may be mapped to specific classes in the GETO, either as an anchoring class at the PROforma side or with at least one of its slots referenced in a slot mapping. The one remaining class is an abstract class, that is used only for conceptualization purposes. Because this abstract class has no instances, it is not involved in the translation process of the GESDOR guideline execution model. 80 out of the 88 total slots in the 21 mapped classes may be mapped to specific slots of the GETO side classes. Among the eight remaining slots, four slots are inherited from superclasses, and created only for nominal purposes; the other four slots are slots of abstract classes, where their mapping to the GETO side has been defined in the subclasses.

### GESDOR

Once the GETO, e.g., the generic guideline representation model, has been developed and the mapping relationship between a specific guideline representation model and the GETO has been created, and saved in a computer-readable format, the generalized guideline execution tasks defined in the GETO can be used to drive execution of guidelines encoded in the format of the specific guideline representation model. In one aspect of the present invention, a generic guideline execution engine is provided which operates on the general principle presented herein of Guideline Execution by Semantic Decomposition of Representation (“GESDOR”). Accordingly, a generic guideline execution engine, e.g., the GESDOR engine, may be driven by the GESDOR generic guideline execution model or simply the GESDOR model, as described herein. The GESDOR model provides guideline execution based on generalized guideline execution tasks, such as those provided by, or in connection with, the GETO, the semantic links between a guideline representation model and the GETO, and a generic task-scheduling model that harmonizes the task-scheduling model of the existing guideline representations. The GESDOR model or engine may be applied to execute guidelines coded in formats based on multiple guideline representation models, for guideline execution; thus, it supports guideline sharing at the execution level, even if guidelines are encoded in different formats.

The GESDOR engine, as described herein, shares many of the components and functionalities of the GLEE engine. For instance, the GESDOR engine may be integrated with a healthcare institution's clinical information system as middleware, to provide services such as clinical decision support and quality assurance, or it may be a component of an executable program providing the functionality described herein. GESDOR further supports the execution of the guidelines that are encoded in the format of a plurality of guideline representation models, which generally include any guideline representation model that may be mapped to a generic representation model, such as the GETO.

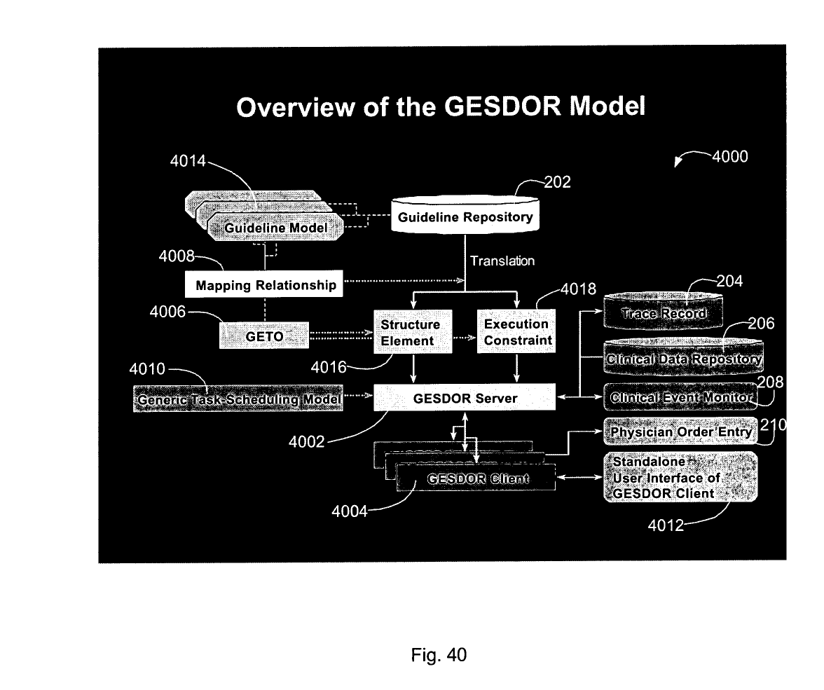

Referring to FIG. 40, the GESDOR engine 4000, in one embodiment, comprises at least one or a plurality of software components that, when executed, provide the functionality of the engine. The GESDOR engine 4000, for instance, may include a GESDOR server 4002 and at least one GESDOR client 4004. In this instance, the GESDOR engine interfaces with the hosting environment of a local institution. As with GLEE, GESDOR 4000 may include standard interfaces that, e.g., interface with a local medical record system back-end 102, to access the clinical data repository 206 and the clinical event monitor 208, as well as the clinical applications, such a physician order entry system 210, at the front-end 104. The GESDOR server 4002 and the GESDOR clients 4004 correspondingly provide some or all of the functionality of the GLEE server and the GLEE clients, as described above. The GESDOR system architecture generally drives guideline execution in the GESDOR model with a plurality of three components, i.e., a generalized representation model (e.g., the GETO 4006), the mapping relationships between specific guideline representation models and the GETO 4008, and/or a generic task-scheduling model 4010.

The GESDOR engine, as well as GLEE, may be implemented using the JAVA programming language, or any other programming languages. Alternatively, the execution model may be implemented in hardware, or the implementation may include parts implemented in software and other parts implemented in hardware.

The GESDOR engine may also track and store execution traces, e.g., in an independent trace record system at the server side or locally, to allow the flexibility disclosed above in connection with the GLEE. The GESDOR engine may load a specific guideline from the guideline repository, which may contain guidelines encoded in a variety and/or a plurality of guideline representation model formats. The engine may also translate the representation elements of particular guidelines into the structure elements and the execution constraints of specific guideline execution tasks defined in the GETO, based on the mapping relationship between the GETO and the guideline representation model with which the guideline is encoded. A generic task-scheduling model may then used by the engine to schedule specific tasks that are executable. Depending on the type of task, specific subtasks may be invoked. The GESDOR guideline execution engine further supports the user-controlled task-scheduling model, as previously described in connection with GLEE, and a batch execution mode may be provided to support the application of a specific guideline to multiple patients.

In one embodiment of the present invention, guideline execution is driven by translating the representation elements of a guideline, in their original encoding formats, to the structure elements and the execution constraints of the generalized guideline execution tasks defined in the GETO, so that a particular guideline is encoded in a particular format. The translation process is driven by the mapping relationship between the GETO and the particular guideline representation model in which a guideline is originally represented. Once this translation is complete, the resulting structure elements and execution constraints can then be used by the GESDOR engine to execute the guideline. In at least one embodiment, the GESDOR engine further executes the guideline with a generic task-scheduling model that harmonizes the different approaches to guideline task scheduling in the existing guideline representation models.

As noted herein, translation from the representation elements of a specific guideline representation model to the generalized guideline execution tasks in the GETO may be used in the GESDOR model to execute a guideline encoded in one of a plurality of guideline representation formats. The translation may be viewed as a regeneration of the instances from the guideline representation model side to the GETO side, based on the mapping relationship between the guideline representation model and the GETO.

The mapping relationship between a guideline representation model and the GETO defines class mapping and associated slot mappings between the classes in the guideline representation model and the classes in the structure element subontology or the execution constraint subontology of the GETO. The mapping definitions are used as a set of rules in GESDOR's translation process to regenerate the structure elements and execution constraints from the original encoding of a guideline. These structure elements and execution constraints may then be organized together to create specific guideline execution tasks, which are used to execute the guideline execution.

Regeneration of structure elements and execution constraints may start from the instances at the guideline representation model side. Specifically, in one embodiment, for each guideline model side class, the anchoring class pairs of the mapping relationship between that guideline representation model and the GETO is searched, so that all of the class mappings related to the current guideline model side class are found out. In addition, the instances of the guideline model side class are translated to the instances of the GETO side class, based on the conditions of the class mapping, definition of slot mappings, and conditions of slot mapping.

If a class mapping is a conditional class mapping, its mapping conditions should be checked. For each instance that can satisfy the mapping conditions, an instance of the GETO side class is created. As described herein, if a guideline model side class is mapped to multiple classes at the GETO side, usually specific conditions must be held for each of these class mappings. In this case, the instances of the guideline model side class can be translated into instances of different classes at the GETO side, depending on which conditions of the class mappings can be satisfied for a specific instance.

Once an instance is created at the GETO side, the value of its each slot needs to be decided. This process depends on: (1) whether the slot mapping is a conditional slot mapping; (2) how the slot mapping is defined; and (3) whether other instances that are used as the value of the current guideline model side slot have already been translated to the GETO side. Similar to class mapping, the conditions for slot mapping must hold for a specific guideline model side instance, so that the slot value of that instance can be translated through the slot mapping specification. Depending on the slot mapping type, the specification of the slot mapping may be parsed, and the slot values of the GETO side instance may then be regenerated.

In a direct slot mapping, if the slot type of a GETO side slot is string, boolean, integer, or float, the guideline model side slot may have a similar slot type. In this case, the value of the GETO side slot may be directly assigned as the value of the guideline model slot. If the guideline model side slot has multiple values, all of these values may be assigned to the GETO side slot, and should satisfy the slot mapping conditions.

If the slot type of the GETO side slot is symbol, the slot type of the guideline model side slot may also be symbol. In addition, the allowed values of the GETO side slot may be renamed to the allowed values of the guideline model slot. In this case, the value of the GETO side slot may be directly assigned as the renamed value of the guideline model slot. If the guideline model side slot has multiple values, the renaming of all of these values may be assigned to the GETO side slot, as long as they satisfy the slot mapping conditions.

If the slot type of the GETO side slot is instance, the slot type of the guideline model side slot may also be instance. In addition, the allowed classes of the GETO side slot, and the allowed classes of the guideline model slot, should be pairs of anchoring classes. In this case, if the instance or instances that is/are referenced by the current guideline model side slot have already been translated to the GETO side, the corresponding GETO side instance or instances after the translation can be directly assigned as the value of the current GETO side slot. Otherwise, a set of placeholder instances may be assigned as the value of the current GETO side slot, and the information about each of these placeholder instances, such as the GETO side instance and slot to which it is referenced and the guideline model side instance from which it is mapped, may be recorded in a list of placeholder instances. At the end of the translation process, when all guideline model side instances have been translated to the GETO side, this list of placeholder instances may then be scanned to copy the relevant information to specific slots at the GETO side.

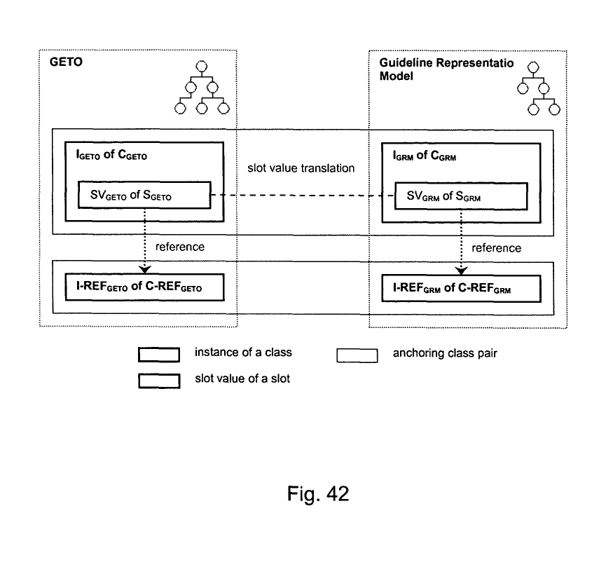

FIG. 42 depicts one embodiment of slot value translation when the type is instance. Class C_{GETO} and class C_{GRM} are two anchoring classes. Slot S_{GETO} of C_{GETO} and slot S_{GRM} of C_{GRM} are two slots with instance slot type that are directly mapped. The allowed class of S_{GETO} is C-REF_{GETO}, and the allowed class of S_{GRM} is C-REF_{GRM}. When translating instance I_{GRM} of C_{GRM} to instance I_{GETO} of C_{GETO}, the slot value of S_{GETO}, SV_{GETO} in I_{GETO} is the instance I-REF_{GETO} of C-REF_{GETO}. Here, class C-REF_{GETO} and class C-REF_{GRM} are two anchoring classes, instance I-REF_{GPM} of C-EF_{GPM} is the slot value of S_{GRM}, SV_{GRM} X208 in I_{GRM}, and I-REF_{GETO} is the translation of I-REF_{GRM}.

If the guideline model side slot has multiple values, the translation of all of these values may be assigned to the GETO side slot, as long as they satisfy the slot mapping condition. In other embodiments, slots may have other types, and may store values other than those listed above.

The slot value translation for referenced slot mapping is similar to direct slot mapping, when slot type is instance, and may have several levels of reference at the guideline model side. If the cardinality of the GETO side slot has a maximum possible value of 1, the cardinality of each of the guideline model side slots on the reference chain should also have a maximum possible value of 1. In one embodiment, assignment of the value of the GETO side slot is based on the value of the guideline model side slot at the end of the reference chain.

If the cardinality of the GETO side slot has a maximum possible value greater than 1, in certain embodiments there will be only one slot on the reference chain at the guideline model side with a cardinality that could have a maximum possible value greater than 1. In one embodiment, the slot at the guideline model side with a maximum possible value of its cardinality greater than 1 may act as a splitting point, where the instance reference chain diverges into several reference chains. The slot values of the instances at the end of each instance reference chain are then translated to the GETO side.

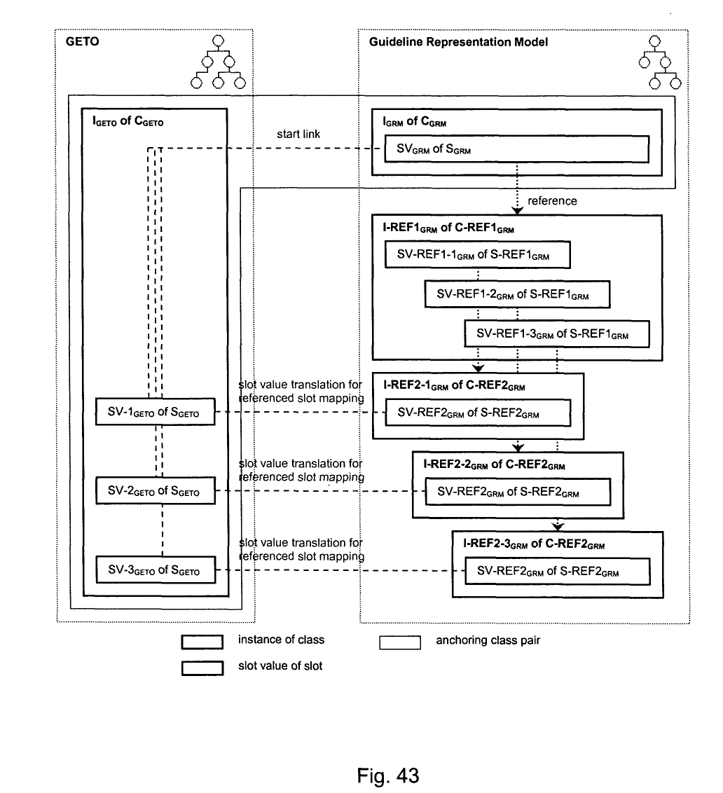

FIG. 43 depicts one embodiment of slot value translation for referenced slot mapping when the cardinality of the GETO side slot has a maximum possible value greater than 1. Class C_{GETO} and class C_{GRM} are two anchoring classes. The mapping for slot S_{GETO} of GETO, which has a cardinality with a maximum possible value greater than 1, is a referenced slot mapping, through the reference chain starting from slot S_{GRM} of C_{GRM} and ending at slot S-REF2_{GRM} of C-REF2_{GRM} at the guideline model side. When translating instance I_{GRM} of C_{GRM} to instance I_{GETO} of C_{GETO}, the slot S-REF1_{GRM} of class C-REF1_{GRM}, which is the slot on the reference chain with a cardinality having a maximum possible value greater than 1, acts as a splitting point of the instance reference chain. The slot values of the instances at the end of each instance reference chain (i.e., slot value SVREF2_{GRM} of slot S-REF2_{GRM} in instance I-REF2-1_{GRM}, instance I-REF2-1_{GRM}, and instance I-REF2-1_{GRM}), are then translated to the GETO side.

In a reflective slot mapping, the GETO side slot may make a reference to another class at the GETO side, which may be mapped from the current guideline model side class in a different anchoring class pair. During the translation, the value of the GETO side slot is, thus, directly assigned as the instance that is the translation of the current guideline model side instance under a different class mapping.

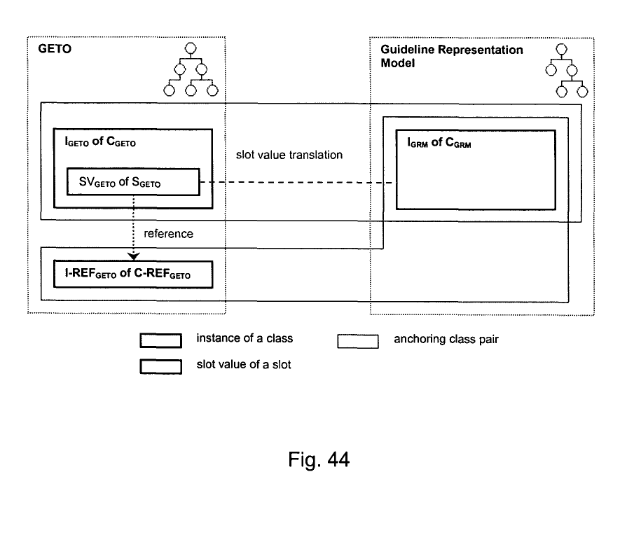

FIG. 44 depicts one embodiment of slot value translation for reflective slot mapping. Class C_{GETO} and class C_{GRM} are two anchoring classes. In this class mapping, the slot mapping for slot S_{GETO} of class C_{GETO} is a reflective slot mapping. Class C-REF_{GETO} and class C_{GRM} are two other anchoring classes, and instance I-REF_{GETO} of C-REF_{GETO} is translated from instance I_{GRM} of C_{GRM} under that class mapping. In this case, the slot value of S_{GETO}, SV_{GETO} in instance I_{GETO} is exactly I-REF_{GETO}.

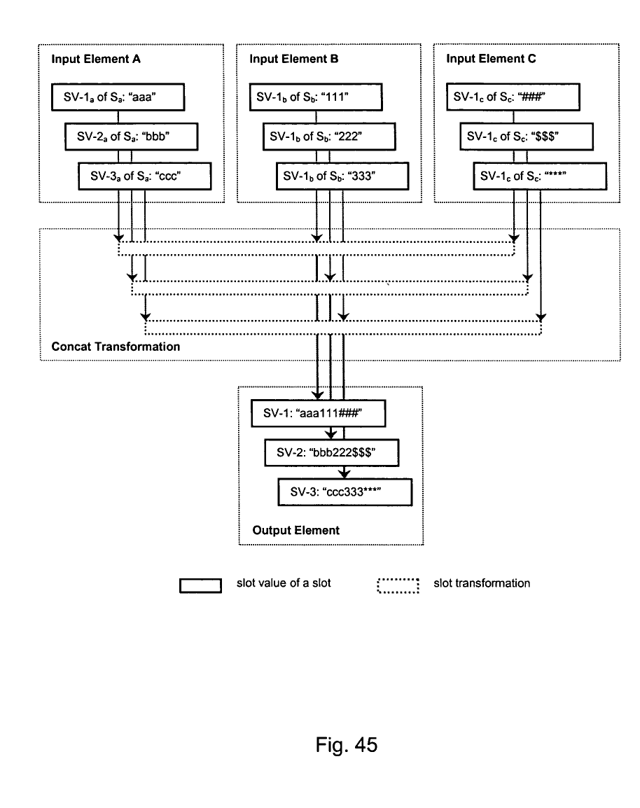

The slot value translation for transformed slot mapping may be decided by the definition of a specific transformation. For example, the concat transformation function may take multiple string type input elements, and concatenate them together to generate a string type output element. The requirement for the cardinalities of the input elements and the output element may also be defined by the concat function. Specifically, the cardinality of each input element can take only two values, e.g., 1 or a predefined integer i that is greater than 1. At the same time, the cardinality of the output element may be defined as 1, if each of the input elements' cardinalities is 1; otherwise it is defined as i. Consequently, the string concatenation in the concat transformation is a process to concatenate each of the string values of the input elements, respectively, to obtain the corresponding string values of the output element. In other words, each value of every input element participates in the concatenation process respectively, as shown in FIG. 45 wherein three input elements, A, B, and C, each has three slot values that are translated.

A predefined slot at the GETO side may not be involved in the mapping from the guideline representation model side. In some embodiments, the value of such a slot is either a constant, or is used only for internal reference purposes. In both cases, the slot value can be directly used by the GESDOR guideline execution engine without the need of translation from the guideline model side.

Once the structure elements and the execution constraints are regenerated from the guideline model side, they are organized together to create the process structure and the primary tasks of a guideline. The process structure and primary tasks may then be used by the GESDOR guideline execution engine to drive the execution of a guideline.

As described herein, in some embodiments, the process structure of a guideline consists of the primary tasks in that guideline. Each of these primary tasks may consist of a set of input and output elements, a set of subtasks, and a set of execution constraints. The subtasks of a primary task have already been defined in the guideline execution tasks subontology of the GETO. The input elements, the output elements, and the execution constraints can be translated from the guideline representation model side, as described previously. To create the primary tasks or a process structure, all of the associated components of a specific primary task or a process structure are found and arranged.

In some embodiments, when creating a primary task at the GETO side, the relationship between the representation elements that correspond respectively to the structure elements and the execution constraints in the original guideline representation model may be used. Specifically, in one embodiment, the representation elements in the original guideline representation model that are used to represent the primary tasks may contain both the elements representing the structure elements and the elements representing the execution constraints. After these two parts have been translated to the GETO side separately, the guideline execution tasks that make reference to these structure elements and execution constraints can be created at the GETO side, based on the corresponding primary tasks in the original guideline representation model. During this process, the value of a specific slot (e.g., the name slot) of the instance that is used to represent a primary task at the guideline representation model side, and the value of a specific slot (e.g., the name slot) of the instances that are used to represent the structure elements and the execution constraints at the GETO side, may be used as the identification of a primary task. Thus, in some embodiments, each primary task instance at the guideline representation model side corresponds to a primary task instance at the GETO side with the same identification slot (e.g., the name slot) value. In this way, the primary tasks created at the GETO side can faithfully represent the semantics of their corresponding elements at the guideline representation model side.

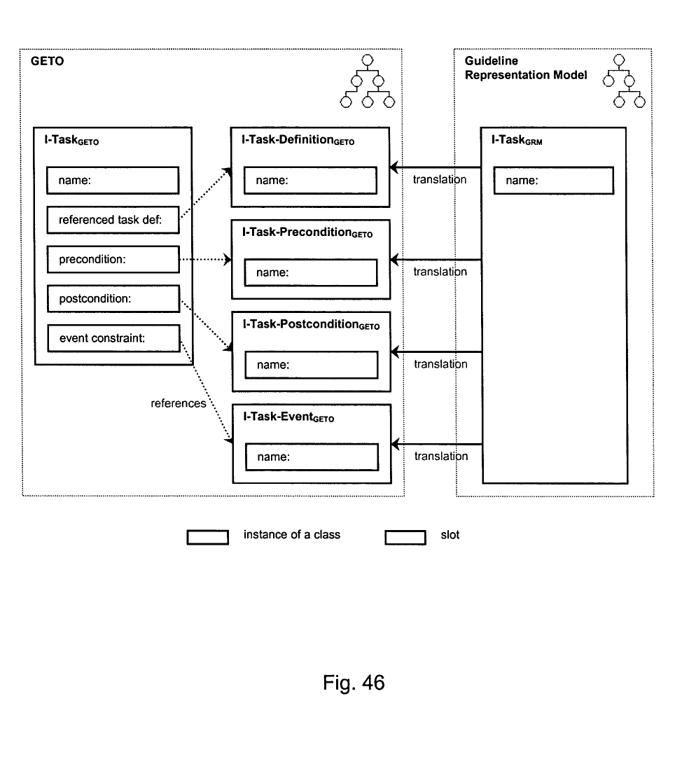

FIG. 46 depicts one embodiment for creating a primary task. An instance of a primary task at the guideline representation model side, I-Task_{GRM}, is usually translated into several instances at the GETO side, e.g., a structure element, I-Task-Definition_{GETO}, and several execution constraints, I-Task-Precondition_{GETO}, I-Task-Postcondition_{GETO}, and I-Task-Event_{GETO}. These structure elements and execution constraints are then assigned as the specific slot values of a newly-created primary task at the GETO side, I-Task_{GETO}. During this process, the name slot of these instances may be used as identification.

In some embodiments, the process structure of a guideline may be created at the GETO side in a similar manner. In one embodiment, once the structure element and the start, finish, and abort criteria of a process structure have been translated to the GETO side, a new process structure instance may be instantiated to reference these structure elements, and the start, finish, and abort criteria, using the value of a specific slot (e.g., the name slot) of the guideline model side process structure instance as identification. These structure elements, and the start, finish, and abort criteria, are then used to control the task scheduling in the process structure, which are described below.

In the GESDOR model, scheduling of the primary tasks may be based on the execution constraints. These execution constraints define the scheduling relationship among the primary tasks in the process structure of a guideline. As described herein, a guideline representation model may take different approaches to task scheduling. For example, the guidelines may use a task-based chaining model, property-based chaining model, or event-driven execution model. Once the execution constraints have been translated to the GETO side, a generic task-scheduling model may harmonize these different approaches, so that these execution constraints can be used to drive the execution of guidelines encoded in different formats using a consistent approach.

A scheduling constraint is a description of the execution schedule for the primary task of a guideline. It can be defined using different approaches, some of which are described herein. In one approach, the task-based chaining model, a preceding guideline execution task in the task schedule always knows the subsequent guideline execution tasks. Thus, the scheduling constraint is defined through the specification of the subsequent tasks in each primary task. In another approach, the property-based chaining model, the task chaining is specified through the value-assignment for specific logical variables, and the checking of the logical properties of a guideline execution system. Specifically, completion of a primary task leads to the assignment of specific values to particular logical variables of the guideline execution system; start of a primary task needs to check the logical properties of the system to ensure that a particular condition is satisfied before the primary task can be executed. As a result, the scheduling constraint in the property-based chaining model is defined through the precondition and postcondition of a task, which are used separately to specify the conditions that should be satisfied before a task can be executed, and the logic effects after a task is finished.

The specification of the subsequent tasks in the task-based chaining model can be considered as an assignment action after the completion of a task. Thus, it can be thought as a special type of postcondition. The preconditions and postconditions can be chained together to define the execution schedule, as in a property-based chaining model. The harmonization of the task-based chaining model and the property-based chaining model is described below.

In the event-driven execution model, the definition of the execution schedule may be based on the occurrence of triggering events for specific tasks. The event-driven execution model can be used together with the task-based chaining model or property-based chaining model, as in the GLIF3 guideline representation model and the PROforma guideline representation model. This implies that the event-driven execution model, itself, does not contradict with the other two task-scheduling models. It can be integrated within a generic task-scheduling model without any problem.

As described above, a property-based chaining model may be viewed as more generic than the task-based chaining model. Specification of the subsequent tasks in the task-based chaining model can be considered as a special type of postcondition. In some embodiments, in order to harmonize the task-based chaining model and the property-based chaining model within a generic task-scheduling model that is based on the chaining of generalized preconditions and postconditions, the generalized precondition of a primary task in the task-based chaining model should be defined. This definition of the generalized precondition can be based on the identifications of particular tasks.

Specifically, in some embodiments, in the task-based chaining model, after the execution of a primary task is completed, the subsequent tasks defined in the current task are automatically selected as the following task on the execution schedule. If the identifications of the subsequent tasks are used as the postcondition of the preceding task, the precondition of each of the subsequent tasks should be the identification of itself. Here, the task identification can be considered as a logical variable. Thus, after the preceding task is finished, each of the logical variables, represented by the identification of a specific subsequent task, is assigned as true. This further triggers the execution of the subsequent tasks, wherein the precondition of each, encoded as its own identification, is now satisfied. In some embodiments, implementation of the assignment of postcondition and the evaluation of precondition can follow the implementation for the execution of the synchronization step in GLIF3, where completion of the steps preceding a synchronization step is recorded, and used later to evaluate the synchronization continuation criteria of the synchronization step.

An important issue in the use of the generic task-scheduling model is how to “clear” the logical properties that have already been used for task scheduling, and are no longer relevant in the subsequent executions. For example, if task A is completed, its postcondition is assigned to be true; thus, a subsequent task B, the precondition of which happens to be the postcondition of task A, will be scheduled to execute. Once task B is finished, the system property which matches the precondition of task B (also the postcondition of task A) needs to be cleared; otherwise, the precondition of task B will always be satisfied, and task B will be scheduled repeatedly. It is important to note that, here, the clearance applies only to task B. In other words, each primary task needs only to clear the logical property that is specific to its precondition. One embodiment of the present invention keeps a record of execution properties for each primary task. After completion of a task, all of the execution properties of that task will be cleared. Using this approach, repetitive scheduling of the same task can be avoided.

The execution schedule of the primary task within the same process structure may be determined using the execution constraints of the primary tasks. In terms of the overall process structure, the start, finish, and abort criteria of a process structure may be used to specify when the execution of the guideline, or the subguideline with which the process structure is attached, should be started, finished, or aborted.

In a task-based chaining model, for example, a primary task may know the subsequent tasks. In this case, a task is invoked by its preceding task, except for the tasks that should be started at the beginning of a guideline. For the tasks that should be started at the beginning of a guideline or a subguideline, their invocation is determined using the start criteria of the process structure that is associated with the guideline or the subguideline. Contrastingly, for the task at the end of a task chain, no subsequent tasks may need to be defined. Thus, no definition of the subsequent tasks in a specific task can be considered as the default finish criteria for a process structure in a task-based chaining model, although here there is an implicit constraint on guideline encoding that requires all concurrent tasks to be coordinated before the finish of a guideline. This approach to the definition of the start and the finish criteria of process structure is used, for example, in the GLIF3 guideline representation model.

In another embodiment that uses a property-based chaining model, each task needs to evaluate its precondition to decide whether it can be started. For a task that is not at the start of a task chain, satisfaction of its precondition is an effect of the completion of the preceding tasks. For those tasks at the start of a task chain, if their preconditions are defined, these preconditions have to be chained with the start criteria of the current process structure, so that the tasks at the start of the task chain can be scheduled once the execution of the current guideline starts. No definition of the precondition for a specific task can be considered as a default start criteria of the current process structure, leading to that specific task being scheduled once the current guideline or subguideline is started. For those tasks at the end of a task chain, whether or not their postconditions will be used by other tasks as preconditions may be unknown. Thus, the finish criteria of a process structure must be explicitly defined, so that a guideline execution system will know that the completion of specific tasks will end the execution of the current guideline or subguideline. This approach to the definition of the start and the finish criteria of a process structure is used in the PROforma guideline representation model.

In one embodiment of the generic task-scheduling model, the approaches used by the task-based chaining model and the property-based chaining model are combined to define the start and the finish criteria of a process structure. Specifically, if the start criteria have been defined in a process structure, the primary tasks with matched preconditions will be scheduled once the current guideline or subguideline is started; otherwise, the primary tasks without precondition definitions will be scheduled. Similarly, if the finish criteria have been defined in a process structure, the primary tasks with matched postconditions will be considered as the ending tasks on the task chain to finish the execution of the current guideline or subguideline; otherwise, the primary tasks without postcondition definitions will be considered as the ending tasks.

Based on the preceding description, the definition of the start criteria can be considered as a special type of postcondition, so that it can be used to match the preconditions of the tasks at the start of a task chain. Additionally, the definition of the finish criteria can be considered as a special type of precondition, so that it can be used to match the postconditions of the tasks at the end of a task chain. Finally, definition of the abort criteria can be considered as a special type of triggering event, the occurrence of which will abort the execution of the current guideline or subguideline.

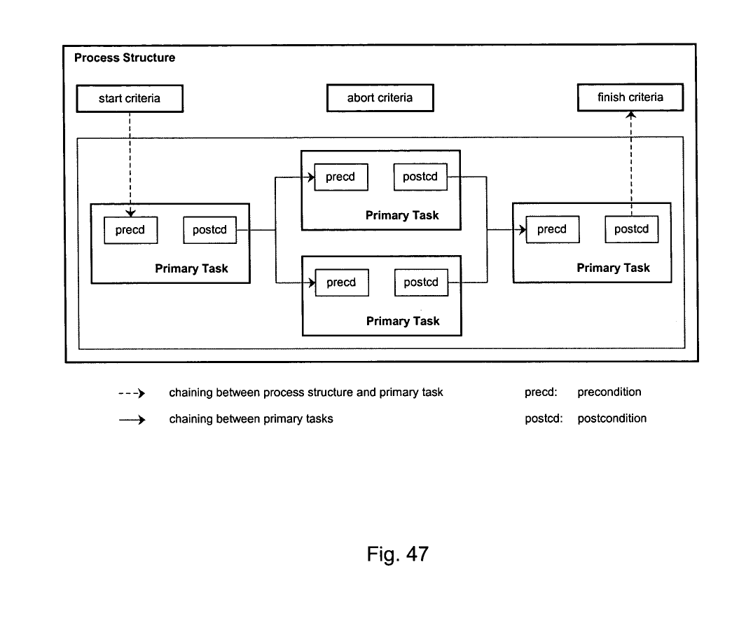

FIG. 47 depicts one embodiment of chaining of primary tasks and the start, finish, and abort criteria of a process structure. Preconditions (precd) and postconditions (postcd) are used to chain the primary tasks together in a process structure. Start criteria of a process structure are used to chain with the preconditions of the primary tasks at the start of a task chain. Finish criteria are used to chain with the postconditions of the primary tasks at the end of a task chain. Abort criteria are used to define the triggering events that lead to the abortion of the execution of the current guideline or subguideline.

In other embodiments, a generic task schedule model may be based on another type of execution model. In the other embodiments, the above-described execution models may be harmonized to integrate with the model used in the generic task schedule model.

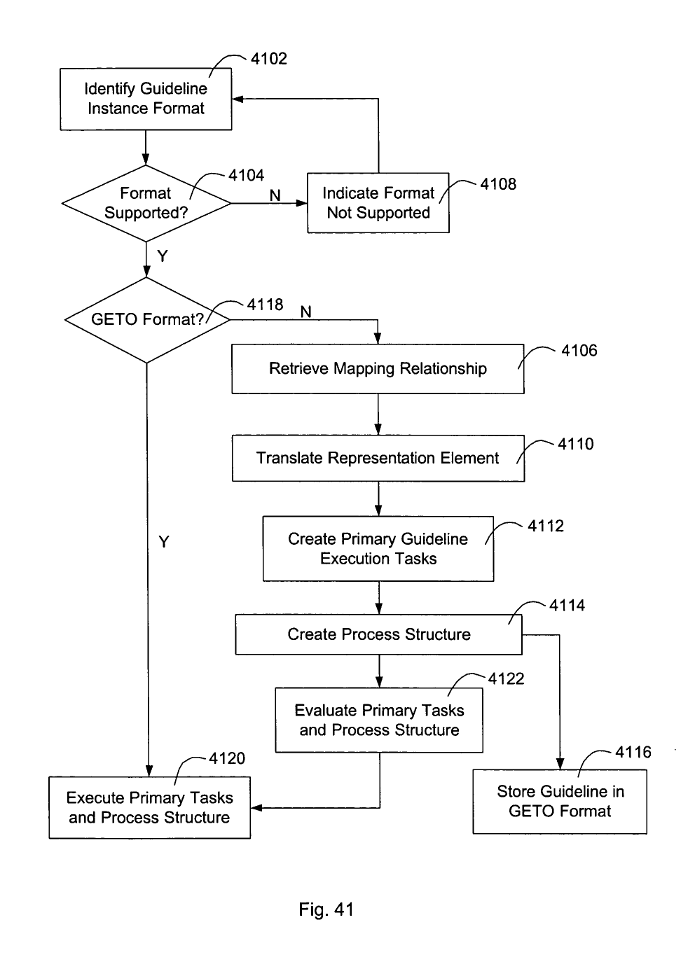

Referring to FIG. 41, the overall process of guideline execution in the GESDOR guideline execution model may generally include the identification of the guideline representation model with which a guideline is encoded, the translation of the instances from a specific guideline representation model to the GETO, the dynamic evaluation of the execution constraints during the guideline execution process, and the execution of the specific primary tasks.

The identification of the guideline representation model with which a guideline is encoded, step 4102, generally denotes determining whether the guideline representation model on which the encoded guideline is based is supported by GESDOR. If, at step 4104, the format is supported, the mapping relationship between that model and the GETO is retrieved, step 4106. The mapping relationship may then be used to translate the instances of the representation elements in that guideline model to the instances of the generalized guideline execution tasks in the GETO, step 4104. If the guideline representation model is not supported, an indication may be given, indicating this, step 4108.

In one embodiment, the representation elements of the guideline, encoded as instances of the original guideline representation model, are translated to instances of the structure elements and execution constraints of specific guideline execution tasks in the GETO, step 4110. During this process, definition of class mapping, class mapping conditions, slot mapping, and slot mapping conditions are used to direct the translation, as described previously. The instance of the structure elements and the execution constraints may then be arranged to create primary guideline execution tasks, step 4112, each of which has its own subtasks, input and output structure elements, and execution constraints. The primary tasks may also be grouped together to formulate the process structure of a guideline or a subguideline, step 4114.

The translation process can be implemented as an independent step that might not need to be performed each time. Once a guideline encoded in a specific format has been translated, and the instances of the generalized guideline execution tasks have been regenerated at the GETO side, these instances of the guideline execution tasks can be exported and stored in a transformed format, step 4116, e.g., a Protégé-2000 project file. At the time of execution, the instances of the guideline execution tasks stored in the transformed format are parsed, and then directly used to drive the execution of a guideline. Using this approach, a guideline encoded in a specific format needs to be translated only once. In subsequent invocations of the same guideline, the instances of the guideline execution tasks regenerated in the first time can be directly used for guideline execution, by determining if the guideline instance is in the transformed format, step 4118, and executing the guideline instance accordingly, step 4120.

Once the process structure and the primary tasks have been created at the GETO side, they can be used to the drive the execution of a guideline. Specifically, in this embodiment, the execution constraints, including the start, finish, and abort criteria of a process structure and the execution constraints of specific primary tasks, are evaluated during the execution process to schedule particular primary tasks for execution, step 4122. This process may start from the top-level process structure, which resides in the top-level guideline. Evaluation of the start criteria of the top-level process structure may be used in determining which primary tasks in that process structure can be scheduled for execution. These tasks are then executed, based on the detailed process for the execution of a specific primary task, as described below. Completion of the execution of a primary task leads to scheduling of its subsequent tasks, based on the chaining of the preconditions and postconditions.

Specifically, once the execution of a primary task is completed, the postcondition of that task is broadcast to all other primary tasks in that process structure. Each primary task that has received this broadcast message will update its own record of the execution properties, and decide whether it can be scheduled to be executed. For a subguideline task, its execution leads to the start of a lower-level guideline, the execution process of which is similar to the top-level guideline. As guidelines can be nested in multiple levels, this process is recursively defined. Once the task at the end of the task chain is finished, the finish criteria of the process structure are satisfied, leading to the completion of the guideline execution. For a subguideline, this leads to the focus of the execution being transferred back to the upper-level guideline. During the guideline execution process, specific events may occur to satisfy the abort criteria of a guideline, in which case the execution of the guideline at that level is immediately aborted, and the focus of the execution is transferred back to the upper-level guideline.

The execution of specific primary tasks depends on the type of task. This includes the handling of the clinical tasks, such as data collection, clinical intervention, mixed clinical action, medical decision making, and patient state verification, as well as the handling of the scheduling tasks, such as branching, synchronization, and subguideline. Each primary task may have its own subtasks, which are usually auxiliary tasks. Execution of a primary task is, in fact, a process recursively to decompose the guideline task and its subtasks, until they become atomic tasks that can be executed directly.

Data collection is a primary task that is used to obtain the clinical data relevant to guideline application. This could be a data retrieval task that is used to retrieve patient data from a local institution's clinical data repository, or a data assignment task that assigns a value to an internal variable, which is used later in the guideline application, e.g., from a user interface.

Defined within a data retrieval task, in some embodiments, are an event registration subtask and a set of data retrieval reflection subtasks. During the execution of a data retrieval task, the triggering events defined within that task are first registered. Once the registered events have been triggered, the data retrieval reflection tasks are invoked to retrieve specific patient data from the clinical data repository at a local institution. Here, the data retrieval reflection task may be an auxiliary task that defines the process to communicate with a local institution for data retrieval.

Defined within a data assignment task, in some embodiments, are an event registration subtask and a set of data assignment reflection subtasks. The event registration subtask may be, for example, the same task as the one in the data retrieval task. During the execution of a data assignment task, the triggering events are first registered. Once the registered events have been triggered, the data assignment reflection tasks may be invoked to define internal variables, and to assign specific expressions as the values of these variables. After the data assignment tasks have been finished, the defined variables may be used later in the encoding of decision-making criteria or patient state specification.

Clinical intervention is a primary task that may be used to recommend specific care to patients. Within this primary task, in some embodiments, an event registration subtask and a set of clinical intervention reflection subtasks may be defined. The primary difference between clinical intervention and data collection is that clinical intervention may have direct impact on a patient's clinical status, while data collection may only clarify a patient's clinical status by collecting the relevant clinical data without any actual treatment. During execution of a clinical intervention reflection subtask, a generic message may be sent to the hosting clinical information system. The hosting system may then decide how to use this message. At the same time, recommendation of specific care can be presented at the client side, which can be used by a clinician through his or her interaction with specific clinical applications.

A mixed clinical action primary task is an aggregation of data retrieval, data assignment, and clinical intervention, that is developed to match the semantics of the action step in GLIF3. In addition to the event registration subtask, a mixed clinical action task contains a set of clinical action reflection subtasks that may be data retrieval reflection, data assignment reflection, or clinical intervention reflection. Each of these subtasks may then be executed in turn.

Medical decision making is a primary task that may be used to assist the process of clinical decision. It can be classified into the logic-based medical decision-making task and the argument-based medical decision-making task, which correspond separately to a decision process that can be finished automatically by a guideline execution system and a decision process that needs inputs from a user.

A subtask in logic-based medical decision making is criterion evaluation, which may be used to decide whether a specific decision criterion can be satisfied. Within this criterion evaluation subtask, another auxiliary task, data retrieval reflection, may be used to obtain the patient data that are relevant to the decision making. After the retrieval of these patient data, and evaluation of the decision criteria, the decision option with decision criterion that can be satisfied will be selected as the decision result.

For an argument-based medical decision-making task, input decision options may be presented to a user, and the user can then decide which decision options should be finally selected. This selected decision option then leads the guideline execution to the different subsequent execution paths.

Patient state verification is a primary task that may be used to label a patient's clinical or management state in a particular context of a guideline's application. Its semantics can match the patient state step in GLIF3. During guideline execution, in some embodiments, handling of the patient state verification task may be similar to the handling of the patient state step in GLIF3, where the criterion that specifies a patient's clinical state is presented to a user, and the user then verifies whether the patient's actual clinical state at that moment matches with the patient state description.

Branching is a scheduling task that may be used to model a point with multiple subsequent tasks in the process structure of a guideline. There is no internal subtask within the branching task, except event registration.

Synchronization is another scheduling task that may be used to model a point with multiple preceding tasks in the process structure of a guideline. A subtask in synchronization is synchronization continuation criterion evaluation, which may be used to check whether the continuation criterion of that synchronization task can be satisfied. Fulfillment of this continuation criterion leads to the completion of the synchronization task, and the scheduling of the subsequent task.

Subguideline is another scheduling task that may be used to define guideline nesting. Specifically, in some embodiments, start of this task leads to the transfer of the execution focus to a lower-level guideline encoded in the task. The start criteria of the process structure of the lower-level guideline are evaluated, and the primary tasks of the lower-level guideline are scheduled to be executed. Once the finish criteria of the lower-level process structure are satisfied, the execution of the subguideline is finished. This, in turn, may lead to the focus of the execution being transferred back to the current level guideline.

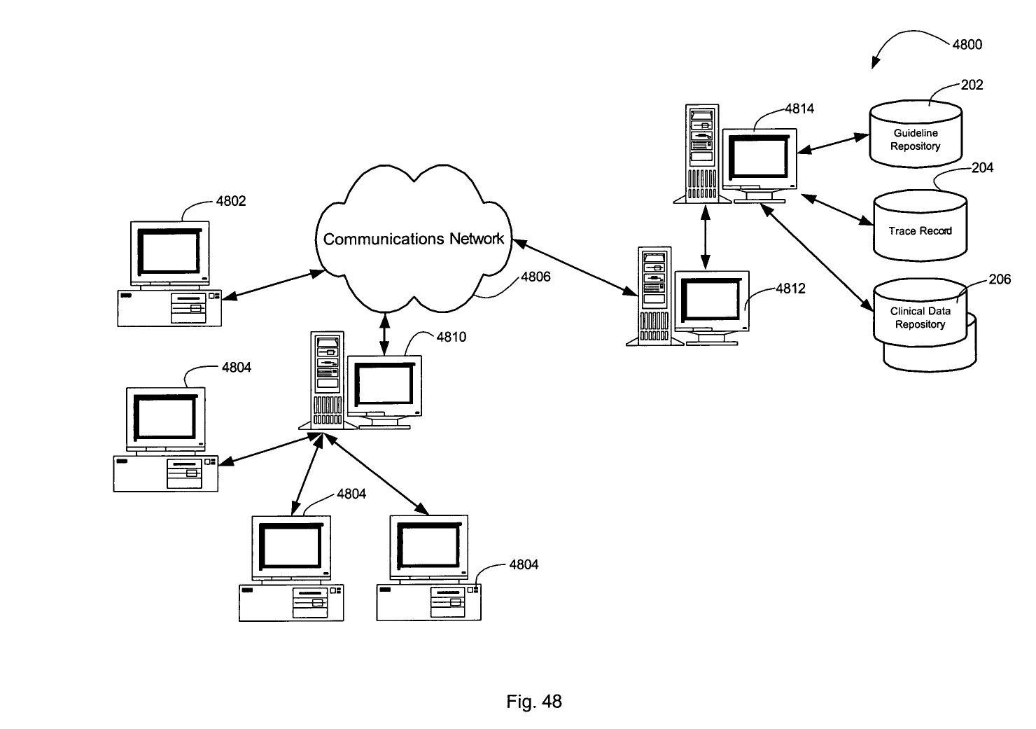

As noted above, the present invention may be adopted in a client-server environment, or may be adopted to provide the relevant functionality in a standalone unit. Accordingly, a computer system for use in the present invention includes at least one computing device that accesses one or more databases or repositories to prove the relevant functionality described herein. Referring to FIG. 48, in one embodiment, a system 4800 providing the relevant functionality described herein includes at least one client device 4802, connected over a communication network 4806 to at least one server computer, such as proxy server 4812, and/or an application server or servers 4814, having at least one database associated therewith, such as a guideline repository 202, a trace record repository 204, and/or a clinical data repository 206. The client devices 4804 may further be connected to the server 4812, 4814 through a proxy server 4810.

The communications network 4806 is any suitable communications link, such as a local area network (LAN), wide area network (WAN), the Internet, a wireless network, or any combinations thereof. A client device 4802, 4804 is generally a multipurpose computer having a processor and memory that is capable of communicating with the server computer 4812, and also capable of displaying information received therefrom. A client device may, therefore, be a personal computer (PC), a special purpose computer, a workstation, a wireless device, such as personal digital assistants (PDA), cellular phones, two-way pagers, etc.

The guideline repository 202 includes therein at least one guideline encoded in a format based on at least one of a plurality of guideline representation models, such as GLIF, PROforma, PRODIGY, Arden Syntax, DILEMMA, EON, Asbru, Guide, etc., or combinations or derivations thereof, including GLIF3. In one embodiment, the guideline repository includes therein guidelines encoded in a generalized guideline representation model format. The trace records repository 204 includes therein records including data or information regarding the execution of an instance of a guideline for a particular patient, such as the patient state, the execution state, etc. The clinical data repository 206 generally includes information for particular patients, such as the medical records, etc. The trace records may include therein patient information in common with the medical records, from which trace records of the data for execution of a guideline instance may be derived.

In one embodiment, the application server 4814 includes at least one software component, such as those described above, in connection with GLEE and GESDOR, to provide the functionality described herein.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A method for extracting generalized guideline execution tasks from a guideline representation model, comprising:
abstracting a process structure and primary tasks from the guideline representation model;
specifying auxiliary tasks embedded within the primary tasks;
extracting structural elements representing participants of guideline execution tasks, and elements referenced by the structural elements; and
defining execution constraints for use in task scheduling.

2. The method of claim 1, wherein the process structure and primary tasks are abstracted from the guideline representation model based on an analysis of representation elements that represent the process structure and the primary tasks in the guideline representation model, and the relationships among the representation elements.

3. The method of claim 1, wherein the primary tasks are abstracted directly from the guideline representation model.

4. The method of claim 1, wherein the structural elements representing participants of guideline execution tasks include structure elements that are direct participants of the guideline execution tasks.

5. The method of claim 1, wherein the execution constraints correspond to representation elements in the guideline representation model.

6. A method for integrating generalized guideline execution tasks into a generic guideline representation model, comprising:
extracting generalized guideline execution tasks from a guideline representation model;
representing the guideline execution tasks as execution task classes;
arranging the execution task classes in a hierarchy, to form an execution task subontology;
specifying basic structure elements of the guideline execution tasks;
representing the basic structure elements as structure element classes;
arranging the structure element classes in a hierarchy, to form a structure element subontology;
specifying execution constraints for use in task scheduling;
representing the execution constraints as execution constraint classes; and
arranging the execution constraint classes in a hierarchy, to form a structure element subontology.

7. The method of claim 6, further comprising the step of creating at least one slot in at least one of the execution task classes, the structure element classes, and the execution constraint classes.

8. The method of claim 7, wherein the execution task classes, structure element classes, and execution constraint classes, and their slots, correspond to representation elements or primitives in the guideline representation model.

9. The method of claim 6, wherein the generalized guideline execution tasks comprise a process structure and primary guideline execution tasks.

10. The method of claim 9, wherein the primary guideline execution tasks comprise auxiliary tasks.

11. The method of claim 6, further comprising the step of presetting slots in the execution task classes, to define participating structure elements and execution constraints.

12. The method of claim 6, wherein the basic structure elements comprise a guideline, a process structure, and primary tasks.

13. The method of claim 12, wherein the structure element classes comprise the basic structure elements and additional structure elements referenced by the basic structure elements.

14. The method of claim 13, further comprising the step of specifying slots in the structure element classes, to define references to other classes in the structure element subontology.

15. The method of claim 6, wherein each of the execution constraint classes contains at least one slot for use in specifying execution constraints.

16. The method of claim 6, further comprising the step of including additional classes and slots corresponding to representation elements in one or more additional guideline execution tasks.

17. A method for providing a generic guideline representation model for use by a guideline execution engine, the method comprising:
extracting generalized guideline execution tasks from a guideline representation model having representation elements; and
integrating the generalized guideline execution tasks to form a generic guideline representation model.

18. The method of claim 17, further comprising integrating representation elements not found in the guideline representation model into the generic representation model.

19. The method of claim 17, wherein the generalized guideline execution tasks are common to at least two guideline representation models.

20. The method of claim 17, wherein the generalized guideline execution tasks comprise at least one of: input elements, output elements, subtasks, and execution constraints.

21. The method of claim 20, wherein the input elements and output elements are static structure elements derived from the representation elements.

22. The method of claim 20, wherein the input elements define participants for a guideline execution task.

23. The method of claim 20, wherein the output elements comprise execution results.

24. The method of claim 20, wherein the subtasks define relationships between current guideline execution tasks and other tasks.

25. The method of claim 20, wherein, if the guideline execution task comprises subtasks, the method further comprises decomposing each of the subtasks to an atomic task that can be performed directly.

26. The method of claim 20, wherein the execution constraints provide dynamic association among primary guideline execution tasks.

27. The method of claim 26, wherein the primary guideline executions tasks comprise preconditions, postconditions, and events.

28. The method of claim 17, wherein the representation elements of the guideline representation model comprise structural specifications that define static structure elements and execution constraints.

29. The method of claim 28, further comprising mapping the static structure elements and the execution constraints to corresponding static structure elements and execution constraints of the generic guideline representation model, to provide a mapping relationship for use by a guideline execution engine.

30. A system for providing a generic guideline representation model for use by a guideline execution engine, the system comprising at least one computing device including software that, when executed, performs a method comprising:
extracting generalized guideline execution tasks from a guideline representation model having representation elements; and
integrating the generalized guideline execution tasks to form a generic guideline representation model.

31. The system of claim 30, wherein the method further comprises integrating representation elements not found in the guideline representation model into the generic representation model.

32. The system of claim 30, wherein the generalized guideline execution tasks are common to at least two guideline representation models.

33. The system of claim 30, wherein the generalized guideline execution tasks comprise at least one of: input elements, output elements, subtasks, and execution constraints.

34. The system of claim 33, wherein the input elements and output elements are static structure elements derived from the representation elements.

35. The system of claim 33, wherein the input elements define participants for a guideline execution task.

36. The system of claim 33, wherein the output elements comprise execution results.

37. The system of claim 33, wherein the subtasks define relationships between current guideline execution tasks and other tasks.

38. The system of claim 33, wherein, if the guideline execution task comprises subtasks, the method further comprises decomposing each of the subtasks to an atomic task that can be performed directly.

39. The system of claim 33, wherein the execution constraints provide dynamic association among primary guideline execution tasks.

40. The system of claim 33, wherein the primary guideline executions tasks comprise preconditions, postconditions, and events.

41. The system of claim 30, wherein the representation elements of the guideline representation model comprise structural specifications that define static structure elements and execution constraints.

42. The system of claim 41, wherein the method further comprises mapping the static structure elements and the execution constraints to corresponding static structure elements and execution constraints of the generic guideline representation model, to provide a mapping relationship for use by a guideline execution engine.

43. A computerized method for enabling a user to map between a guideline representation model and a generic guideline representation model, comprising:
presenting a user interface that allows a user to select a project file of the guideline representation model and a project file of the generalized representation model;
loading the selected files; and
presenting a user interface including therein class structures of the selected files and slots of the class structures, the user therewith capable of generate a mapping relationship.

44. The method of claim 43, wherein the user is capable of generating a mapping relationship by selecting a set of anchoring class pairs.

45. The method of claim 44, wherein each anchoring class pair comprises a class from the guideline representation model, a class from the generic guideline representation model, the user interface enabling a user to specify at least one of the type of class mapping, one or more conditions for class mapping, and a set of slot mapping.

46. The method of claim 43, further comprising saving the mapping relationship as an XML file.

47. A system for enabling a user to map between a guideline representation model and a generic guideline representation model, the system comprising at least one computing device including software that, when executed, performs a method comprising:
presenting a user interface that allows a user to select a project file of the guideline representation model and a project file of the generalized representation model;
loading the selected files; and
presenting a user interface including therein class structures of the selected files and slots of the class structures, the user therewith capable of generate a mapping relationship.

48. The system of claim 47, wherein the user is capable of generating a mapping relationship by selecting a set of anchoring class pairs.

49. The system of claim 48, wherein each anchoring class pair comprises a class from the guideline representation model, a class from the generic guideline representation model, the user interface enabling a user to specify at least one of the type of class mapping, one or more conditions for class mapping, and a set of slot mapping.

50. The system of claim 47, the method further comprising saving the mapping relationship as an XML file.
